(19) United States
(12) Patent Application Publication
(10) Pub. No.: US 2024/0365432 A1
(43) Pub. Date: Oct. 31, 2024

(54) METHOD OF GNB-DU APPARATUS, METHOD OF UE AND GNB-DU APPARATUS

(71) Applicant: NEC Corporation, Minato-ku, Tokyo (JP)

(72) Inventors: Toshiyuki TAMURA, Tokyo (JP); Iskren IANEV, Tokyo (JP); Kundan TIWARI, Tokyo (JP)

(73) Assignee: NEC Corporation, Minato-ku, Tokyo (JP)

(21) Appl. No.: 18/684,243

(22) PCT Filed: Jul. 27, 2022
(86) PCT No.: PCT/JP2022/028883

§ 371 Date: Feb. 16, 2024

(30) Foreign Application Priority Data
Aug. 28, 2021 (IN) 202111039051

(51) Int. Cl. H04W 76/30; H04W 76/19; H04W 76/20

(52) U.S. Cl. CPC H04W 76/30; H04W 76/19; H04W 76/20

(57) ABSTRACT

This disclosure proposes solutions for providing a resiliency of gNB-CU against possible node failures. The node failure includes unexpected system reset, system rebooting, system stall, system congestion and communication failure with neighboring nodes.

A method of a gNB Distributed Unit (gNB-DU) apparatus includes detecting failure of a gNB Centralized Unit User Plane (gNB-CU-UP) apparatus. The method includes sending a UE COTEXT RELEASE REQUEST message to a gNB Centralized Unit Control Plane (gNB-CU-CP) apparatus in a case of detecting the failure of the gNB-CU-UP apparatus. The UE COTEXT RELEASE REQUEST message includes information indicating detection of the failure of the gNB-CU-UP apparatus and information indicating that Radio Resource control (RRC) connection with a User Equipment (UE) needs to be re-established. The method includes receiving a UE CONTEXT RELEASE COMMAND message from the gNB-CU-CP apparatus. The method includes sending a RRC Release message to the UE.

### TECHNICAL FIELD

This present disclosure relates to a method of a gNB-DU apparatus, a method of a gNB-CU-CP apparatus, a method of an AMF apparatus, a method of a UE, a method of a first gNB-CU-UP apparatus, a method of a SMF apparatus, a gNB-DU apparatus, a gNB-CU-CP apparatus, an AMF apparatus, a UE, a first gNB-CU-UP apparatus and a SMF apparatus.

### BACKGROUND ART

The overall architecture for NG-RAN is shown in NPL 2. The NG-RAN includes a set of gNBs connected to the 5GC through the NG interface. A gNB may include a gNB-CU and one or more gNB-DU(s). A gNB-CU and a gNB-DU are connected via F1 interface. One gNB-DU is connected to only one gNB-CU.

### CITATION LIST

### Non Patent Literature

[NPL 1] 3GPP TR 21.905: “Vocabulary for 3GPP Specifications”. V17.0.0 (2020-07)
[NPL 2] 3GPP TS 38.401: “NG-RAN; Architecture description”. V16.6.0 (2021-07)
[NPL 3] 3GPP TSG RAN Rel-18 Workshop RWS-210327: “Motivation of Study on Inter-gNB Coordination” (2021-06)
[NPL 4] 3GPP TS 38.472: “NG-RAN; F1 signalling transport”. V16.1.0 (2020-09)
[NPL 5] IETF RFC 4960 (2007-09): “Stream Control Transmission Protocol”
[NPL 6] 3GPP TS 38.473: “NG-RAN; F1 application protocol (FIAP)”. V16.6.0 (2021-07)
[NPL 7] 3GPP TS 38.462: “NG-RAN; E1 signalling transport”. V16.1.0 (2020-09)
[NPL 8] 3GPP TS 38.463: “NG-RAN; F1 application protocol (F1AP)”. V16.6.0 (2021-07)
[NPL 9] 3GPP TS 38.412: “NG-RAN; NG signalling transport”. V16.1.0 (2020-09)
[NPL 10] 3GPP TS 38.413: “NG Application Protocol (NGAP)”. V16.6.0 (2021-07)
[NPL 11] 3GPP TS 38.422: “NG-RAN; Xn signalling transport”. V16.0.0 (2020-03)
[NPL 12] 3GPP TS 38.423: “Xn Application Protocol (XnAP)”. V16.6.0 (2021-07)
[NPL 13] 3GPP TS 23.501: “System architecture for the 5G System (5GS)”. V17.1.1 (2021-06)
[NPL 14] 3GPP TS 23.502: “Procedures for the 5G System (5GS)”. V17.1.0 (2021-06)
[NPL 15] 3GPP TS 38.474: “F1 data transport”. V16.1.0 (2021-01)
[NPL 16] 3GPP TS 29.281: “General Packet Radio System (GPRS) Tunnelling Protocol User Plane (GTPv1-U)”. V17.1.0 (2021-06)
[NPL 17] ETSI GS NFV-MAN 001 “Network Functions Virtualisation (NFV); Management and Orchestration”. V1.1.1 (2014-12)
[NPL 18] 3GPP TS 38.300: “NR; NR and NG-RAN Overall Description; Stage 2”. V16.6.0 (2021-06)
[NPL 19] IETF RFC 792 (1981-09): “INTERNET CONTROL MESSAGE PROTOCOL”

### SUMMARY OF INVENTION

### Technical Problem

According to NPL 2, a gNB-DU is connected to only one gNB-CU except RAN sharing scenario among different PLMNs. Similarly, a gNB-DU is connected to only one gNB-CU for user data handling per DRB (Data Radio Bearer).

With this architecture principle, all gNB-DUs enter out of service state in a case where the connected gNB-CU fails. This may lead to a major service disruption to all users who are under the gNB-DU coverages if the connected gNB-CU fails.

### Solution to Problem

In an aspect of the present disclosure, a method of a gNB Distributed Unit (gNB-DU) apparatus includes detecting failure of a gNB Centralized Unit User Plane (gNB-CU-UP) apparatus. The method includes sending a UE COTEXT RELEASE REQUEST message to a gNB Centralized Unit Control Plane (gNB-CU-CP) apparatus in a case of detecting the failure of the gNB-CU-UP apparatus. The UE COTEXT RELEASE REQUEST message includes information indicating detection of the failure of the gNB-CU-UP apparatus and information indicating that Radio Resource control (RRC) connection with a User Equipment (UE) needs to be re-established. The method includes receiving a UE CONTEXT RELEASE COMMAND message from the gNB-CU-CP apparatus. The method includes sending a RRC Release message to the UE.

In an aspect of the present disclosure, a method of a gNB Centralized Unit Control Plane (gNB-CU-CP) apparatus includes receiving a UE COTEXT RELEASE REQUEST message from a gNB Distributed Unit (gNB-DU) apparatus in a case where a gNB Centralized Unit User Plane (gNB-CU-UP) apparatus fails. The UE COTEXT RELEASE REQUEST message includes first information indicating detection of failure of the gNB-CU-UP apparatus and second information indicating that Radio Resource control (RRC) connection with a User Equipment (UE) needs to be re-established. The method includes sending a UE CONTEXT RELEASE REQUEST message to an Access and Mobility management Function (AMF) apparatus. The UE CONTEXT RELEASE REQUEST message includes the first information and the second information. The method includes receiving a first UE CONTEXT RELEASE COMMAND message from the AMF apparatus. The first UE CONTEXT RELEASE COMMAND message includes the first information and the second information. The method includes sending a second UE CONTEXT RELEASE COMMAND message to the gNB-DU apparatus. The second UE CONTEXT RELEASE COMMAND message includes the first information and the second information.

In an aspect of the present disclosure, a method of an Access and Mobility management Function (AMF) apparatus includes receiving a UE CONTEXT RELEASE REQUEST message from a gNB Centralized Unit Control Plane (gNB-CU-CP) apparatus in a case where a gNB Centralized Unit User Plane (gNB-CU-UP) apparatus fails. The UE CONTEXT RELEASE REQUEST message includes first information indicating detection of failure of the gNB-CU-UP apparatus and second information indicating that Radio Resource control (RRC) connection with a User Equipment (UE) needs to be re-established. The method includes sending a UE CONTEXT RELEASE COMMAND message to the gNB-CU-CP apparatus. The UE CONTEXT RELEASE COMMAND message includes the first information and the second information.

In an aspect of the present disclosure, a method of a User Equipment (UE) includes receiving a RRC Release message from a gNB Distributed Unit (gNB-DU) apparatus in a case where a gNB Centralized Unit User Plane (gNB-CU-UP) apparatus fails. The RRC Release message includes information indicating detection of failure of the gNB-CU-UP apparatus and information indicating that Radio Resource control (RRC) connection needs to be re-established. The method includes initiating a procedure to establish a Protocol Data Unit (PDU) session after receiving the RRC Release message.

In an aspect of the present disclosure, a method of a gNB Distributed Unit (gNB-DU) apparatus includes detecting failure of a first gNB Centralized Unit User Plane (gNB-CU-UP) apparatus. The method includes sending a UE CONTEXT MODIFICATION REQUIRED message to a gNB Centralized Unit Control Plane (gNB-CU-CP) apparatus in a case of detecting the failure of the first gNB-CU-UP apparatus. The UE CONTEXT MODIFICATION REQUIRED message includes first information indicating detection of the failure of the first gNB-CU-UP apparatus and second information indicating Data Radio Bearer (DRB) ID and third information indicating that F1-U connection for the DRB ID needs to be re-established. The method includes receiving a UE CONTEXT MODIFICATION REQUEST message from the gNB-CU-CP apparatus. The UE CONTEXT MODIFICATION REQUEST message includes the second information and fourth information. The fourth information indicates Tunnel Endpoint Identifier (TEID) and an Internet Protocol (IP) address of second gNB-CU-UP apparatus to which the gNB-DU sends an uplink packet.

In an aspect of the present disclosure, a method of a gNB Centralized Unit Control Plane (gNB-CU-CP) apparatus includes receiving a UE CONTEXT MODIFICATION REQUIRED message from a gNB Distributed Unit (gNB-DU) apparatus in a case where a first gNB Centralized Unit User Plane (gNB-CU-UP) apparatus fails. The UE CONTEXT MODIFICATION REQUIRED message includes first information indicating detection of failure of the first gNB-CU-UP apparatus and second information indicating Data Radio Bearer (DRB) ID and third information indicating that F1-U connection for the DRB ID needs to be re-established. The method includes sending a BEARER CONTEXT SETUP REQUEST message to a second gNB-CU-UP apparatus. The BEARER CONTEXT SETUP REQUEST message includes gNB-DU ID and fourth information. The fourth information indicates Tunnel Endpoint Identifier (TEID) and Internet Protocol (IP) address of the gNB-DU apparatus to which the second gNB-CU-UP apparatus sends a downlink packet. The method includes receiving a BEARER CONTEXT SETUP RESPONSE message from the second gNB-CU-UP apparatus. The BEARER CONTEXT SETUP RESPONSE message includes fifth information. The fifth information indicates TEID and an IP address of the second gNB-CU-UP apparatus to which the gNB-DU apparatus sends an uplink packet. The method includes sending a UE CONTEXT MODIFICATION REQUEST message to the gNB-DU apparatus. The UE CONTEXT MODIFICATION REQUEST message includes the second information and the fifth information.

In an aspect of the present disclosure, a method of a first gNB Centralized Unit User Plane (gNB-CU-UP) apparatus includes receiving a BEARER CONTEXT SETUP REQUEST message from a gNB Centralized Unit Control Plane (gNB-CU-CP) apparatus in a case where a second gNB-CU-UP apparatus fails. The BEARER CONTEXT SETUP REQUEST message includes gNB-DU ID and first information. The first information indicates Tunnel Endpoint Identifier (TEID) and Internet Protocol (IP) address of a gNB Distributed Unit (gNB-DU) apparatus to which the first gNB-CU-UP apparatus sends a downlink packet. The method includes sending a BEARER CONTEXT SETUP RESPONSE message to the gNB-CU-CP apparatus. The BEARER CONTEXT SETUP RESPONSE message includes second information. The second information indicates TEID and an IP address of the first gNB-CU-UP apparatus to which the gNB-DU apparatus sends an uplink packet.

In an aspect of the present disclosure, a method of an Access and Mobility management Function (AMF) apparatus includes receiving a PDU SESSION RESOURCE MODIFY INDICATION message from a gNB Centralized Unit Control Plane (gNB-CU-CP) apparatus in a case where a first gNB Centralized Unit User Plane (gNB-CU-UP) apparatus fails. The PDU SESSION RESOURCE MODIFY INDICATION message includes Protocol Data Unit (PDU) session ID and information. The information indicates Tunnel Endpoint Identifier (TEID) and Internet Protocol (IP) address of a second gNB-CU-UP apparatus to which a User Plane Function (UPF) apparatus sends a downlink packet. The method includes sending a Nsmf_PDUSession_UpdateSMContext request message to Session Management Function (SMF) apparatus. The Nsmf_PDUSession_UpdateSMContext request message includes the information.

In an aspect of the present disclosure, a method of a Session Management Function (SMF) apparatus includes receiving a Nsmf_PDUSession_UpdateSMContext request message from an Access and Mobility management Function (AMF) apparatus in a case where a first gNB Centralized Unit User Plane (gNB-CU-UP) apparatus fails. The Nsmf_PDUSession_UpdateSMContext request message includes information. The information indicates Tunnel Endpoint Identifier (TEID) and Internet Protocol (IP) address of a second gNB-CU-UP apparatus to which a User Plane Function (UPF) apparatus sends a downlink packet. The method includes sending a N4 Session Modification Request message to the UPF apparatus. The N4 Session Modification Request message includes the information.

In an aspect of the present disclosure, a method of a gNB Distributed Unit (gNB-DU) apparatus includes detecting failure of a gNB Centralized Unit User Plane (gNB-CU-UP) apparatus. The method includes sending a UE COTEXT RELEASE REQUEST message to a gNB Centralized Unit Control Plane (gNB-CU-CP) apparatus in a case of detecting the failure of the gNB-CU-UP apparatus. The UE COTEXT RELEASE REQUEST message includes information indicating detection of the failure of the gNB-CU-UP apparatus and information indicating that Data Radio Bearer (DRB) connection with a User Equipment (UE) needs to be re-established.

In an aspect of the present disclosure, A method of a gNB Centralized Unit Control Plane (gNB-CU-CP) apparatus includes receiving a UE COTEXT RELEASE REQUEST message from a gNB Distributed Unit (gNB-DU) apparatus in a case where a gNB Centralized Unit User Plane (gNB-CU-UP) apparatus fails. The UE COTEXT RELEASE REQUEST message includes first information indicating detection of failure of the gNB-CU-UP apparatus and second information indicating that Data Radio Bearer (DRB) connection with a User Equipment (UE) needs to be re-established. The method includes sending a PDU SESSION RESOURCE NOTIFY message to an Access and Mobility management Function (AMF) apparatus. The PDU SESSION RESOURCE NOTIFY message includes the first information and third information. The third information indicates that a Protocol Data Unit (PDU) session with the UE needs to be re-established.

In an aspect of the present disclosure, a method of an Access and Mobility management Function (AMF) apparatus includes receiving a PDU SESSION RESOURCE NOTIFY message from a gNB Centralized Unit Control Plane (gNB-CU-CP) apparatus in a case where a gNB Centralized Unit User Plane (gNB-CU-UP) apparatus fails. The PDU SESSION RESOURCE NOTIFY message includes first information indicating detection of failure of the gNB-CU-UP apparatus and second information indicating that a Protocol Data Unit (PDU) session with a User Equipment (UE) needs to be re-established. The method includes sending a Nsmf_PDUSession_ReleaseSMContext request message to a Session Management Function (SMF) apparatus. The Nsmf_PDUSession_ReleaseSMContext request message includes the first information and the second information. The method includes receiving a Nsmf_PDUSession_ReleaseSMContext response message from the SMF apparatus. The Nsmf_PDUSession_ReleaseSMContext response message includes the second information and third information indicating PDU session ID. The method includes sending a PDU session release command message to the UE. The wherein the PDU session release command message includes the second information and the third information.

In an aspect of the present disclosure, a method of a Session Management Function (SMF) apparatus includes receiving a Nsmf_PDUSession_ReleaseSMContext request message from an Access and Mobility management Function (AMF) apparatus in a case where a gNB Centralized Unit User Plane (gNB-CU-UP) apparatus fails. The Nsmf_PDUSession_ReleaseSMContext request message includes first information indicating detection of failure of the gNB-CU-UP apparatus and second information indicating that a Protocol Data Unit (PDU) session with a User Equipment (UE) needs to be re-established. The method includes sending a N4 Session Release Request message to a User Plane Function (UPF) apparatus for releasing N3 tunnel information. The method includes sending a Nsmf_PDUSession_ReleaseSMContext response message to the AMF apparatus. The Nsmf_PDUSession_ReleaseSMContext response message includes the second information and a third information indicating PDU session ID.

In an aspect of the present disclosure, a method of a User Equipment (UE) includes receiving a PDU session release command message from an Access and Mobility management Function (AMF) apparatus in a case where a gNB Centralized Unit User Plane (gNB-CU-UP) apparatus fails. The PDU session release command message includes information indicating that a Protocol Data Unit (PDU) session with the UE needs to be re-established and information indicating PDU session ID. The method includes initiating a procedure to establish the PDU session after receiving the PDU session release command message.

In an aspect of the present disclosure, a gNB Distributed Unit (gNB-DU) apparatus includes means for detecting failure of a gNB Centralized Unit User Plane (gNB-CU-UP) apparatus. The gNB-DU apparatus includes means for sending a UE COTEXT RELEASE REQUEST message to a gNB Centralized Unit Control Plane (gNB-CU-CP) apparatus in a case of detecting the failure of the gNB-CU-UP apparatus. The UE COTEXT RELEASE REQUEST message includes information indicating detection of the failure of the gNB-CU-UP apparatus and information indicating that Radio Resource control (RRC) connection with a User Equipment (UE) needs to be re-established. The gNB-DU apparatus includes means for receiving a UE CONTEXT RELEASE COMMAND message from the gNB-CU-CP apparatus. The gNB-DU apparatus includes means for sending a RRC Release message to the UE.

In an aspect of the present disclosure, a gNB Centralized Unit Control Plane (gNB-CU-CP) apparatus includes means for receiving a UE COTEXT RELEASE REQUEST message from a gNB Distributed Unit (gNB-DU) apparatus in a case where a gNB Centralized Unit User Plane (gNB-CU-UP) apparatus fails. The UE COTEXT RELEASE REQUEST message includes first information indicating detection of failure of the gNB-CU-UP apparatus and second information indicating that Radio Resource control (RRC) connection with a User Equipment (UE) needs to be re-established. The gNB-CU-CP apparatus includes means for sending a UE CONTEXT RELEASE REQUEST message to an Access and Mobility management Function (AMF) apparatus. The UE CONTEXT RELEASE REQUEST message includes the first information and the second information. The gNB-CU-CP apparatus includes means for receiving a first UE CONTEXT RELEASE COMMAND message from the AMF apparatus. The first UE CONTEXT RELEASE COMMAND message includes the first information and the second information. The gNB-CU-CP apparatus includes means for sending a second UE CONTEXT RELEASE COMMAND message to the gNB-DU apparatus. The second UE CONTEXT RELEASE COMMAND message includes the first information and the second information.

In an aspect of the present disclosure, an Access and Mobility management Function (AMF) apparatus includes means for receiving a UE CONTEXT RELEASE REQUEST message from a gNB Centralized Unit Control Plane (gNB-CU-CP) apparatus in a case where a gNB Centralized Unit User Plane (gNB-CU-UP) apparatus fails. The UE CONTEXT RELEASE REQUEST message includes first information indicating detection of failure of the gNB-CU-UP apparatus and second information indicating that Radio Resource control (RRC) connection with a User Equipment (UE) needs to be re-established. The AMF apparatus includes means for sending a UE CONTEXT RELEASE COMMAND message to the gNB-CU-CP apparatus. The UE CONTEXT RELEASE COMMAND message includes the first information and the second information.

In an aspect of the present disclosure, a User Equipment (UE) includes means for receiving a RRC Release message from a gNB Distributed Unit (gNB-DU) apparatus in a case where a gNB Centralized Unit User Plane (gNB-CU-UP) apparatus fails. The RRC Release message includes information indicating detection of failure of the gNB-CU-UP apparatus and information indicating that Radio Resource control (RRC) connection needs to be re-established. The UE includes means for initiating a procedure to establish a Protocol Data Unit (PDU) session after receiving the RRC Release message.

In an aspect of the present disclosure, a gNB Distributed Unit (gNB-DU) apparatus includes means for detecting failure of a first gNB Centralized Unit User Plane (gNB-CU-UP) apparatus. The gNB-DU apparatus includes means for sending a UE CONTEXT MODIFICATION REQUIRED message to a gNB Centralized Unit Control Plane (gNB-CU-CP) apparatus in a case of detecting the failure of the first gNB-CU-UP apparatus. The UE CONTEXT MODIFICATION REQUIRED message includes first information indicating detection of the failure of the first gNB-CU-UP apparatus and second information indicating Data Radio Bearer (DRB) ID and third information indicating that F1-U connection for the DRB ID needs to be re-established. The gNB-DU apparatus includes means for receiving a UE CONTEXT MODIFICATION REQUEST message from the gNB-CU-CP apparatus. The UE CONTEXT MODIFICATION REQUEST message includes the second information and fourth information. The fourth information indicates Tunnel Endpoint Identifier (TEID) and an Internet Protocol (IP) address of second gNB-CU-UP apparatus to which the gNB-DU sends an uplink packet.

In an aspect of the present disclosure, a gNB Centralized Unit Control Plane (gNB-CU-CP) apparatus includes means for receiving a UE CONTEXT MODIFICATION REQUIRED message from a gNB Distributed Unit (gNB-DU) apparatus in a case where a first gNB Centralized Unit User Plane (gNB-CU-UP) apparatus fails. The UE CONTEXT MODIFICATION REQUIRED message includes first information indicating detection of failure of the first gNB-CU-UP apparatus and second information indicating Data Radio Bearer (DRB) ID and third information indicating that F1-U connection for the DRB ID needs to be re-established. The gNB-CU-CP apparatus includes means for sending a BEARER CONTEXT SETUP REQUEST message to a second gNB-CU-UP apparatus. The BEARER CONTEXT SETUP REQUEST message includes gNB-DU ID and fourth information. The fourth information indicates Tunnel Endpoint Identifier (TEID) and Internet Protocol (IP) address of the gNB-DU apparatus to which the second gNB-CU-UP apparatus sends a downlink packet. The gNB-CU-CP apparatus includes means for receiving a BEARER CONTEXT SETUP RESPONSE message from the second gNB-CU-UP apparatus. The BEARER CONTEXT SETUP RESPONSE message includes fifth information. The fifth information indicates TEID and an IP address of the second gNB-CU-UP apparatus to which the gNB-DU apparatus sends an uplink packet. The gNB-CU-CP apparatus includes means for sending a UE CONTEXT MODIFICATION REQUEST message to the gNB-DU apparatus. The UE CONTEXT MODIFICATION REQUEST message includes the second information and the fifth information.

In an aspect of the present disclosure, a first gNB Centralized Unit User Plane (gNB-CU-UP) apparatus includes means for receiving a BEARER CONTEXT SETUP REQUEST message from a gNB Centralized Unit Control Plane (gNB-CU-CP) apparatus in a case where a second gNB-CU-UP apparatus fails. The BEARER CONTEXT SETUP REQUEST message includes gNB-DU ID and first information. The first information indicates Tunnel Endpoint Identifier (TEID) and Internet Protocol (IP) address of a gNB Distributed Unit (gNB-DU) apparatus to which the first gNB-CU-UP apparatus sends a downlink packet. The gNB-CU-CP apparatus includes means for sending a BEARER CONTEXT SETUP RESPONSE message to the gNB-CU-CP apparatus. The BEARER CONTEXT SETUP RESPONSE message includes second information. The second information indicates TEID and an IP address of the first gNB-CU-UP apparatus to which the gNB-DU apparatus sends an uplink packet.

In an aspect of the present disclosure, an Access and Mobility management Function (AMF) apparatus includes means for receiving a PDU SESSION RESOURCE MODIFY INDICATION message from a gNB Centralized Unit Control Plane (gNB-CU-CP) apparatus in a case where a first gNB Centralized Unit User Plane (gNB-CU-UP) apparatus fails. The PDU SESSION RESOURCE MODIFY INDICATION message includes Protocol Data Unit (PDU) session ID and information. The information indicates Tunnel Endpoint Identifier (TEID) and Internet Protocol (IP) address of a second gNB-CU-UP apparatus to which a User Plane Function (UPF) apparatus sends a downlink packet. The AMF apparatus includes means for sending a Nsmf_PDUSession_UpdateSMContext request message to Session Management Function (SMF) apparatus. The Nsmf_PDUSession_UpdateSMContext request message includes the information.

In an aspect of the present disclosure, a Session Management Function (SMF) apparatus includes means for receiving a Nsmf_PDUSession_UpdateSMContext request message from an Access and Mobility management Function (AMF) apparatus in a case where a first gNB Centralized Unit User Plane (gNB-CU-UP) apparatus fails. The Nsmf_PDUSession_UpdateSMContext request message includes information. The information indicates Tunnel Endpoint Identifier (TEID) and Internet Protocol (IP) address of a second gNB-CU-UP apparatus to which a User Plane Function (UPF) apparatus sends a downlink packet. The SMF apparatus includes means for sending a N4 Session Modification Request message to the UPF apparatus. The N4 Session Modification Request message includes the information.

In an aspect of the present disclosure, a gNB Distributed Unit (gNB DU) apparatus includes means for detecting failure of a gNB Centralized Unit User Plane (gNB-CU-UP) apparatus. The gNB-DU apparatus includes means for sending a UE COTEXT RELEASE REQUEST message to a gNB Centralized Unit Control Plane (gNB-CU-CP) apparatus in a case of detecting the failure of the gNB-CU-UP apparatus. The UE COTEXT RELEASE REQUEST message includes information indicating detection of the failure of the gNB-CU-UP apparatus and information indicating that Data Radio Bearer (DRB) connection with a User Equipment (UE) needs to be re-established.

In an aspect of the present disclosure, a gNB Centralized Unit Control Plane (gNB-CU-CP) apparatus includes means for receiving a UE COTEXT RELEASE REQUEST message from a gNB Distributed Unit (gNB-DU) apparatus in a case where a gNB Centralized Unit User Plane (gNB-CU-UP) apparatus fails. The UE COTEXT RELEASE REQUEST message includes first information indicating detection of failure of the gNB-CU-UP apparatus and second information indicating that Data Radio Bearer (DRB) connection with a User Equipment (UE) needs to be re-established. The gNB-CU-CP apparatus includes means for sending a PDU SESSION RESOURCE NOTIFY message to an Access and Mobility management Function (AMF) apparatus. The PDU SESSION RESOURCE NOTIFY message includes the first information and third information. The third information indicates that a Protocol Data Unit (PDU) session with the UE needs to be re-established.

In an aspect of the present disclosure, an Access and Mobility management Function (AMF) apparatus includes means for receiving a PDU SESSION RESOURCE NOTIFY message from a gNB Centralized Unit Control Plane (gNB-CU-CP) apparatus in a case where a gNB Centralized Unit User Plane (gNB-CU-UP) apparatus fails. The PDU SESSION RESOURCE NOTIFY message includes first information indicating detection of failure of the gNB-CU-UP apparatus and second information indicating that a Protocol Data Unit (PDU) session with a User Equipment (UE) needs to be re-established. The AMF apparatus includes means for sending a Nsmf_PDUSession_ReleaseSMContext request message to a Session Management Function (SMF) apparatus. The Nsmf_PDUSession_ReleaseSMContext request message includes the first information and the second information. The AMF apparatus includes means for receiving a Nsmf_PDUSession_ReleaseSMContext response message from the SMF apparatus. The Nsmf_PDUSession_ReleaseSMContext response message includes the second information and third information indicating PDU session ID. The AMF apparatus includes means for sending a PDU session release command message to the UE. The PDU session release command message includes the second information and the third information.

In an aspect of the present disclosure, a Session Management Function (SMF) apparatus includes means for receiving a Nsmf_PDUSession_ReleaseSMContext request message from an Access and Mobility management Function (AMF) apparatus in a case where a gNB Centralized Unit User Plane (gNB-CU-UP) apparatus fails. The Nsmf_PDUSession_ReleaseSMContext request message includes first information indicating detection of failure of the gNB-CU-UP apparatus and second information indicating that a Protocol Data Unit (PDU) session with a User Equipment (UE) needs to be re-established. The SMF apparatus includes means for sending a N4 Session Release Request message to a User Plane Function (UPF) apparatus for releasing N3 tunnel information. The SMF apparatus includes means for sending a Nsmf_PDUSession_ReleaseSMContext response message to the AMF apparatus. The Nsmf_PDUSession_ReleaseSMContext response message includes the second information and a third information indicating PDU session ID.

In an aspect of the present disclosure, a User Equipment (UE) includes means for receiving a PDU session release command message from an Access and Mobility management Function (AMF) apparatus in a case where a gNB Centralized Unit User Plane (gNB-CU-UP) apparatus fails. The PDU session release command message includes information indicating that a Protocol Data Unit (PDU) session with the UE needs to be re-established and information indicating PDU session ID. The UE includes means for initiating a procedure to establish the PDU session after receiving the PDU session release command message.

### BRIEF DESCRIPTION OF DRAWINGS

FIG. 1 illustrates a (R)AN architecture with gNB-CU-CP pool.

FIG. 2 illustrates a System data handling with the UDSF-SI.

FIG. 3 illustrates a (R)AN architecture with gNB-CU-CP backup.

FIG. 4 illustrates a F1 Setup procedure with backup gNB-CU-CP related information.

FIG. 5 illustrates a NG Setup procedure with backup gNB-CU-CP related information.

FIG. 6 illustrates a GNB-CU-UP E1 Setup procedure with backup gNB-CU-CP related information.

FIG. 7 illustrates a GNB-CU-CP E1 Setup procedure with backup gNB-CU-CP related information.

FIG. 8 illustrates a XN Setup procedure with backup gNB-CU-CP related information.

FIG. 9 illustrates a Switchover procedure with the gNB-CU-CP backup scheme.

FIG. 10 illustrates a Switchover procedure with the UDSF backup scheme.

FIG. 11 illustrates a Deployment example for resource distributed operation.

FIG. 12 illustrates an NG-(R)AN architecture which proposes some gNB-CU-UP failure recovery mechanisms when the gNB-CU-UP fails.

FIG. 13 illustrates a gNB-CU-UP failure recovery by releasing RRC connection.

FIG. 14 illustrates a gNB-CU-UP failure recovery by choosing alternative gNB-CU-UP.

FIG. 15 illustrates a gNB-CU-UP failure recovery by releasing PDU session.

FIG. 16 illustrates a System overview.

FIG. 17 is a block diagram for a User equipment (UE).

FIG. 18 is a block diagram for a (R)AN node.

FIG. 19 illustrates a System overview of (R)AN node based on O-RAN architecture.

FIG. 20 is a block diagram for a Radio Unit (RU).

FIG. 21 is a block diagram for a Distributed Unit (DU).

FIG. 22 is a block diagram for a Centralized Unit (CU).

FIG. 23 is a block diagram for Access and Mobility Management Function (AMF).

FIG. 24 is a block diagram for Session Management Function (SMF).

FIG. 25 is a block diagram for User Plane Function (UPF).

FIG. 26 is a block diagram for Policy Control Function (PCF).

FIG. 27 is a block diagram for Network Exposure Function (NEF).

FIG. 28 is a block diagram for Unified Data Management (UDM).

FIG. 29 is a block diagram for Network Data Analytics Function (NWDAF).

FIG. 30 is a block diagram for Unstructured Data Storage Function for System Information (UDSF-SI).

FIG. 31 is a block diagram for Network Repository Function (NRF).

### DESCRIPTION OF EMBODIMENTS

The disclosure relates to a method of a gNB-DU apparatus, a method of a gNB-CU-CP apparatus, a method of an AMF apparatus, a method of a UE, a method of a first gNB-CU-UP apparatus, a method of a SMF apparatus, a gNB-DU apparatus, a gNB-CU-CP apparatus, an AMF apparatus, a UE, a first gNB-CU-UP apparatus and a SMF apparatus.

In the following detailed description, for purposes of explanation, numerous specific details are set forth in order to provide a thorough understanding of the disclosed aspects. It will be apparent, however, that one or more aspects may be practiced without these specific details. In other instances, well-known structures and devices are schematically shown in order to simplify the drawing.

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in the each Aspects described below may be implemented independently or in combination with any other. These Aspects include novel characteristics different from one another. Accordingly, these Aspects contribute to achieving objects or solving problems different from one another and contribute to obtaining advantages different from one another.

### <Abbreviations>

For the purposes of the present document, the abbreviations given in NPL 1 and the following apply. An abbreviation defined in the present document takes precedence over the definition of the same abbreviation, if any, in NPL 1.

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN | 5G Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G VN | 5G Virtual Network |
| 5G-S-TMSI | 5G S-Temporary Mobile Subscription Identifier |
| 5QI | 5G QoS Identifier |
| ABBA | Anti-Bidding-down Between Architectures |
| AF | Application Function |
| AMF | Access and Mobility Management Function |
| API | Application Programming Interface |
| AS | Access Stratum |
| ATSSS | Access Traffic Steering, Switching, Splitting |
| ATSSS-LL | ATSSS Low-Layer |
| AUSF | Authentication Server Function |
| AUTN | Authentication token |
| BBF | Broadband Forum |
| BMCA | Best Master Clock Algorithm |
| BSF | Binding Support Function |
| CAG | Closed Access Group |
| CAPIF | Common API Framework for 3GPP northbound APIs |
| CHF | Charging Function |
| CN PDB | Core Network Packet Delay Budget |
| CP | Control Plane |
| CU | Centralized Unit/Central Unit |
| DAPS | Dual Active Protocol Stacks |
| DL | Downlink |
| DN | Data Network |
| DNAI | DN Access Identifier |
| DNN | Data Network Name |
| DRB | Data Radio Bearer |
| DRX | Discontinuous Reception |
| DS-TT | Device-side TSN translator |
| DU | Distributed Unit |
| ePDG | evolved Packet Data Gateway |
| EAP | Extensible Authentication Protocol |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| gNB-CU-CP | gNB Central Unit Control Plane |
| gNB-CU-UP | gNB Central Unit User Plane |
| gNB-DU | gNB Distributed Unit |
| GPSI | Generic Public Subscription Identifier |
| GUAMI | Globally Unique AMF Identifier |
| GUTI | Globally Unique Temporary UE Identity |
| HR | Home Routed (roaming) |
| IAB | Integrated access and backhaul |
| IMEI | International Mobile Equipment Identity |
| IMEI/TAC | IMEI Type Allocation Code |
| IMS | IP Multimedia Subsystem |
| IOWN | Innovative Optical and Wireless Network |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| LTE | Long Term Evolution |
| MAC | Medium Access Control |
| MCC | Mobile country code |
| MCX | Mission Critical Service |
| MDBV | Maximum Data Burst Volume |
| MFBR | Maximum Flow Bit Rate |
| MICO | Mobile Initiated Connection Only |
| MNC | Mobile Network Code |
| MO | Mobile Originated |
| MPS | Multimedia Priority Service |
| MPTCP | Multi-Path TCP Protocol |
| MT | Mobile Terminated |
| MT | Mobile Termination |
| N3IWF | Non-3GPP InterWorking Function |
| N5CW | Non-5G-Capable over WLAN |
| NAI | Network Access Identifier |
| NAS | Non-Access Stratum |
| NEF | Network Exposure Function |
| NF | Network Function |
| NFV | Network Functions Virtualization |
| NGAP | Next Generation Application Protocol |
| ngKSI | Next Generation Key Set Identifier |
| NID | Network identifier |
| NPN | Non-Public Network |
| NR | New Radio |
| NRF | Network Repository Function |
| NSI ID | Network Slice Instance Identifier |
| NSSAA | Network Slice-Specific Authentication and Authorization |
| NSSAAF | Network Slice-Specific Authentication and Authorization |
| | Function |
| NSSAI | Network Slice Selection Assistance Information |
| NSSF | Network Slice Selection Function |
| NSSP | Network Slice Selection Policy |
| NW-TT | Network-side TSN translator |
| NWDAF | Network Data Analytics Function |
| O&M | Operations & Maintenance |
| O-RAN | Open RAN Alliance |
| O-DU | O-RAN Distributed Unit |
| O-CU | O-RAN Centralized Unit |
| O-RU | O-RAN Radio Unit |
| PCF | Policy Control Function |
| PDB | Packet Delay Budget |
| PDCP | Packet Data Convergence Protocol |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| QoS | Quality of Service |
| RACS | Radio Capabilities Signalling optimisation |
| (R)AN | (Radio) Access Network |
| RG | Residential Gateway |
| RU | Radio Unit |
| RIM | Remote Interference Management |
| RLC | Radio Link Control |
| RQA | Reflective QOS Attribute |
| RQI | Reflective QoS Indication |
| RRC | Radio Resource Control |
| RSN | Redundancy Sequence Number |
| SA NR | Standalone New Radio |
| SBA | Service Based Architecture |
| SBI | Service Based Interface |
| SCP | Service Communication Proxy |
| SCTP | Stream Control Transport Protocol |
| SD | Slice Differentiator |
| SDAP | Service Data Adaptation Protocol |
| SEAF | Security Anchor Functionality |
| SEPP | Security Edge Protection Proxy |
| SMF | Session Management Function |
| SMS | Short Message Service |
| SMSF | Short Message Service Function |
| SN | Sequence Number |
| SN name | Serving Network Name. |
| SNPN | Stand-alone Non-Public Network |
| S-NSSAI | Single Network Slice Selection Assistance Information |
| SOR | Steering Of Roaming |
| SSC | Session and Service Continuity |
| SSCMSP | Session and Service Continuity Mode Selection Policy |
| SST | Slice/Service Type |
| SUCI | Subscription Concealed Identifier |
| SUPI | Subscription Permanent Identifier |
| SV | Software Version |
| TAI | Tracking Area Identity |
| TCP | Transmission Control Protocol |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UDSF-SI | Unstructured Data Storage Function for System Information |
| UE | User Equipment |
| UL | Uplink |
| UL CL | Uplink Classifier |
| UP | User Plane |
| UPF | User Plane Function |
| URLLC | Ultra Reliable Low Latency Communication |
| URRP-AMF | UE Reachability Request Parameter for AMF |
| URSP | UE Route Selection Policy |
| UU | Interface between User Equipment and Radio Access |
| | Network |
| VID | VLAN Identifier |
| VLAN | Virtual Local Area Network |
| VNF | Virtualised Network Function |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |
| WLAN | Wireless Local Area Network |
| WUS | Wake Up Signal |

### <Definitions>

For the purposes of the present document, the terms and definitions given in NPL 1 and the following apply. A term defined in the present document takes precedence over the definition of the same term, if any, in NPL 1.

### <General>

This disclosure proposes solutions for improving the resiliency of gNB-CU.

The followings aspects can provide stable services against the gNB-CU failure.

Note that the following interpretations can apply in this disclosure.
gNB-CU-CP can be interpreted as gNB-CU-Control Plane.
CU-CP can be interpreted as gNB-CU-Control Plane.
gNB-CU-UP can be interpreted as gNB-CU-User Plane.
CU-UP can be interpreted as gNB-CU-User Plane.
DU can be interpreted as gNB-DU.
F1 interface can be interpreted as F1 reference point.

Although this disclosure mainly discloses solutions to gNB, all aspects in this disclosure are equally applicable to the ng-eNB. In order to apply the solutions to ng-eNB, the following replacements are needed.
gNB-CU-CP and CU-CP is replaced with ng-eNB-CU-CP.
gNB-CU-UP and CU-UP is replaced with ng-eNB-CU-UP.
gNB-DU and DU is replaced with ng-eNB-DU.
gNB-CU-CP pool is replaced with ng-eNB-CU-CP pool.
F1 interface and F1 reference point are replaced with W1 interface and W1 reference point respectively.
   <Aspect 1: Introduction of gNB-CU Pool Architecture>

According to NPL 2, a gNB-DU is connected to only one gNB-CU except (R)AN sharing scenario among different PLMNs. With this architecture principle, all gNB-DUs enter out of service state in a case where the connected gNB-CU fails.

In order to mitigate the service disruption due to gNB-CU failure, this disclosure proposes the gNB-CU pool architecture to the gNB-CU-Control Plane (gNB-CU-CP) with the following technical enhancements to the NG-(R)AN architecture.
gNB-CU-CP pool architecture
gNB-CU-CP selection mechanism in gNB-DU
Introduction of UDSF-SI (Unstructured Data Storage Function for System Information)

The gNB-CU pool architecture can mitigate the service disruption due to gNB-CU failure.

<Aspect 2: Introduction of gNB-CU Backup Architecture>

In order to prevent service disruption to the established PDU sessions, this disclosure proposes the gNB-CU backup architecture with the following technical enhancements to the NG-(R)AN architecture.
gNB-CU-CP backup architecture
Backup indication to connected nodes
Switchover mechanism with the gNB-CU-CP backup scheme
Switchover mechanism with the UDSF backup scheme

The gNB-CU backup architecture can prevent service disruption to the established PDU sessions.

<Aspect 3: Introduction of gNB-CU-UP Failure Recovery Mechanism>

In order to prevent service disruption to the established PDU sessions, this disclosure proposes a gNB-CU-UP failure recovery mechanism with the following technical enhancements to the NG-(R)AN architecture.
gNB-CU-UP failure recovery by releasing RRC connection
gNB-CU-UP failure recovery by choosing alternative gNB-CU-UP
gNB-CU-UP failure recovery by releasing PDU session

The gNB-CU-UP failure recovery mechanism can prevent service disruption to the established PDU sessions.

### <Aspect 1: General>

The gNB-CU pool concept to the gNB-CU-Control Plane (gNB-CU-CP) is disclosed.

<gNB-CU-CP Pool Architecture>

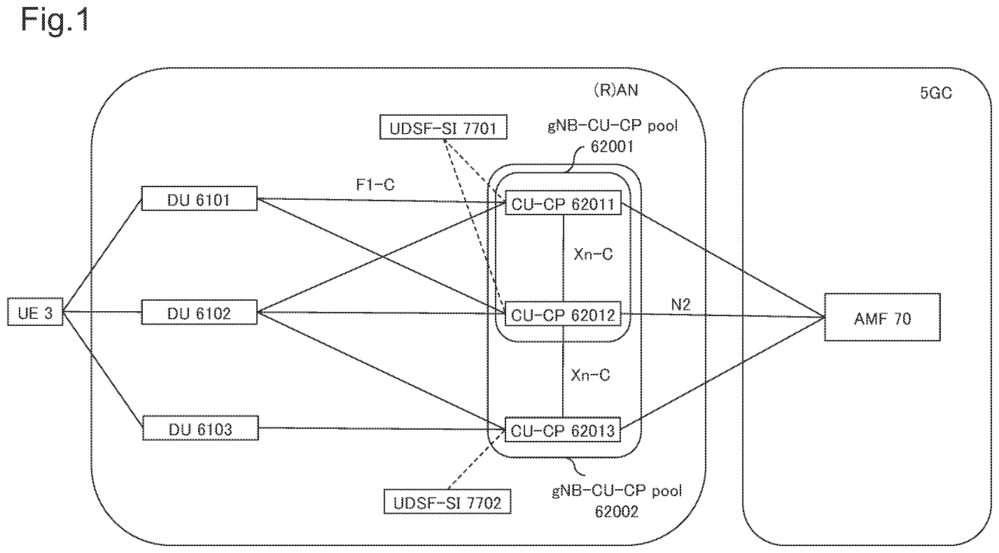

The FIG. 1 illustrates the (R)AN architecture with gNB-CU-CP pool.

A new concept “the gNB-CU-CP pool” is disclosed in order to mitigate the service disruption due to gNB-CU-CP failure.

The gNB-CU-CP pool is a concept where from the gNB-DU point of view, the gNB-DU has multiple F1-C connections to the gNB-CU-CPs.

For example, if gNB-DU 6101 has two F1-C connections, one with the gNB-CU-CP 62011 and another one with the gNB-CU-CP 62012, it can be considered that the gNB-CU-CP pool 62001 for gNB-DU 6101 comprises the gNB-CU-CP 62011 and the gNB-CU-CP 62012. If gNB-DU 6102 has three F1-C connections with CU-CP 62011, CU-CP 62012 and CU-CP 62013, it can be considered that gNB-CU-CP pool 62002 for gNB-DU 6102 comprises the gNB-CU-CP 62011, gNB-CU-CP 62012 and gNB-CU-CP 62013. The gNB-DU 6103 has an F1-C connection with CU-CP 62013. In this example, gNB-CU-CP 62011 and gNB-CU-CP 62012 are shared among gNB-DU 6101 and gNB-DU 6102. Similarly, gNB-CU-CP 62013 is shared among gNB-DU 6102 and gNB-DU 6103. Here, gNB-CU-CP 62011, gNB-CU-CP 62012 and gNB-CU-CP 62013 can be called shared gNB-CU-CP(s). The shared gNB-CU-CP can share its resource among the gNB-DUs. If the shared gNB-CU-CP 62011 is shared among gNB-DU 6101 and gNB-DU 6102, the shared gNB-CU-CP 62011 may split its resource to two or more, use one for gNB-DU 6101 and use another one for gNB-DU 6102.

In another example, there can be no shared gNB-CU-CP(s) among the gNB-DUs.

In case that gNB-CU-CP 62011 fails, the gNB-CU-CP 62012 can be chosen by the gNB-DU 6101 when the gNB-DU 6101 receives new RRC initial message from the UE. However, existing RRC connections with the failed gNB-CU-CP 62011 cannot be moved to the gNB-CU-CP 62012.

In case that the gNB-DU 6101 detects the failure of the gNB-CU-CP 62011, all resources related to the gNB-CU-CP 62011 may be locally released in the gNB-DU 6101. For example, in case that the gNB-DU 6101 detects the failure of the gNB-CU-CP 62011, the gNB-DU 6101 may release all resources related to the gNB-CU-CP 62011. The gNB-DU 6101 optionally sends the RRC release message to the UEs which have an RRC association with the failed gNB-CU-CP 62011. The RRC release message to the UEs may include cause parameter indicating that Re-establishment of the RRC connection is required.

The UDSF-SI (Unstructured Data Storage Function for System Information) 7701 may be connected to the gNB-CU-CP 62011 and the gNB-CU-CP 62012. The UDSF-SI 7702 may be connected to the gNB-CU-CP 62013. The gNB-CU-CP 62011 may be connected to the gNB-CU-CP 62012 via Xn-C interface. The gNB-CU-CP 62012 may be connected to the gNB-CU-CP 62013 via Xn-C interface. The gNB-CU-CP 62011 may be connected to the gNB-CU-CP 62013 via Xn-C interface.

<gNB-CU-CP Selection Mechanism in gNB-DU>

To enable the gNB-DU to determine which gNB-CU-CP to select when the UE performs the UE Initial Access, a gNB-CU-CP selection mechanism (and other related mechanism) may be required in the gNB-DU.

The gNB-CU-CP selection mechanism may be required in the gNB-DU when the gNB-DU has multiple associations with the gNB-CU-CPs, i.e. the gNB-DU has multiple F1-C connections with multiple gNB-CU-CPs. In this case, the gNB-DU may select one gNB-CU-CP taking the following factors into account:
In order to select a live (i.e. active) gNB-CU-CP, the gNB-DU may have a mechanism to monitor the status of the connected gNB-CU-CPs.
In one example, the gNB-DU 6101 monitors the IP connectivity (e.g. Internet Protocol connectivity) to the gNB-CU-CP 62011 and the IP connectivity to the gNB-CU-CP 62012. For example, the IP connectivity can be monitored by using the ICMP as defined in NPL 19. If the IP connectivity to the gNB-CU-CP 62011 is lost, the gNB-DU 6101 removes that gNB-CU-CP 62011 out from the list of candidate gNB-CU-CPs for gNB-CU-CP selection. The gNB-DU 6101 may store the list of candidate gNB-CU-CPs. For example, in a case where the list includes the gNB-CU-CP 62011 and the gNB-CU-CP 62012 and the gNB-DU 6101 detects that the IP connectivity to the gNB-CU-CP 62011 is lost (e.g. the gNB-DU 6101 detects that the gNB-CU-CP 62011 fails), the gNB-DU 6101 removes the gNB-CU-CP 62011 out from the list of candidate gNB-CU-CPs.
In another example, the gNB-DU 6101 monitors the SCTP association status with the connected gNB-CU-CP 62011 and the SCTP association status with the connected gNB-CU-CP 62012. If the SCTP association with the gNB-CU-CP 62011 is lost, the gNB-DU 6101 removes that gNB-CU-CP 62011 out from the list of candidate gNB-CU-CPs for gNB-CU-CP selection.
In another example, the gNB-DU 6101 monitors the SCTP status of the connected gNB-CU-CP 62011 and the connected gNB-CU-CP 62012 based on HEARTBEAT-HEARTBEAT ACK chunk and Error chunk. If the HEARTBEAT-HEARTBEAT ACK chunk and Error chunk indicate that the gNB-CU-CP 62011 is not usable, the gNB-DU 6101 removes that gNB-CU-CP 62011 out from the list of candidate gNB-CU-CPs for gNB-CU-CP selection.
In order to balance the load among connected gNB-CU-CPs, the gNB-DU may have an internal logic for selection of a gNB-CU-CP. For example, the gNB-DU uses round-robin algorism for gNB-CU-CP selection.
In order to balance the load among connected gNB-CU-CPs, the gNB-DU may take the weight factors in each gNB-CU-CP into account. For example, the gNB-DU 6101 chooses a gNB-CU-CP 62011 with the lowest weight factor out of all connected gNB-CU-CP(s), i.e. among the gNB-CU-CP 62011 and the gNB-CU-CP 62012. The weight factor of the gNB-CU-CP 62011 can be provided as a status information of the gNB-CU-CP 62011 from the gNB-CU-CP 62011 by F1 SETUP RESPONSE message, GNB-DU CONFIGURATION UPDATE ACKNOWLEDGE message and GNB-CU CONFIGURATION UPDATE message.
In order to balance the load among established TNL Associations to gNB-CU-CPs, the gNB-DU may take the weight factors in each TNL Association into account. For example, the gNB-DU 6101 chooses the TNL Association to gNB-CU-CP 62011 with the lowest weight factor out of all established TNL Associations. The weight factor of the established TNL Association to gNB-CU-CP 62011 can be provided as a status information of the established TNL Association from the gNB-CU-CP 62011 by GNB-CU CONFIGURATION UPDATE message.

### <Introduction of UDSF-SI (Unstructured Data Storage Function for System Information)>

As the gNB-CU-CP is in charge of providing system information to each connected gNB-DUs, all gNB-CU-CPs in the same gNB-CU-CP pool may have the same system information per each connected gNB-DU. The UDSF-SI is introduced to the (R)AN architecture for the purpose of sharing system information for the gNB-DU among multiple gNB-CU-CPs. For example, in FIG. 1, gNB-CU-CP 62011 and gNB-CU-CP 62012 in the same gNB-CU-CP pool 62001 may send the same system information for the gNB-DU 6101 to the connected gNB-DU 6101.

Each gNB-CU-CP is connected to one or multiple UDSF-SI(s). When the gNB-CU-CP 62011 needs to obtain the latest system information of the gNB-DU 6101, the gNB-CU-CP 62011 makes a query to the UDSF-SI 7701 with the gNB-DU Identity to get the latest system information for the gNB-DU 6101. For example, the gNB-CU-CP 62011 makes a query to the UDSF-SI 7701 with the gNB-DU Identity of the gNB-DU 6101 to get the latest system information for the gNB-DU 6101.

A UDSF-SI manages the system information for one or multiple gNB-DU(s). For example, in FIG. 1, the UDSF-SI 7701 manages the system information for gNB-DU 6101 and gNB-DU 6102 while the UDSF-SI 7702 manages the system information for gNB-DU 6102 and gNB-DU 6103.

The system information is not limited to the RRC level system information but also other system parameter for the gNB-DU(s). The other system parameter for the gNB-DU(s) may include for example Activated Cell List, gNB-CU TNL Association, Cells to be barred List, Protected E-UTRA Resources List, and/or Neighbor Cell Information List.

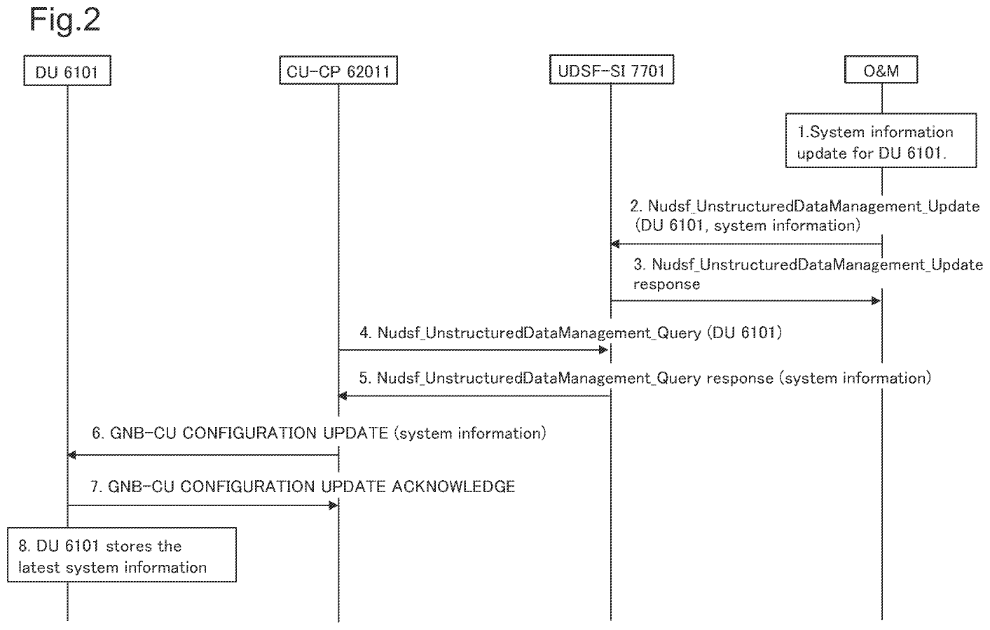

The FIG. 2 illustrates the system data handling with the UDSF-SI.

The detailed processes of the system data handling with the UDSF-SI are described as below:

1. The O&M updates the system information for the gNB-DU 6101.

2. The O & M sends, to the UDSF-SI 7701, Nudsf_UnstructuredDataManagement_Update message including DU 6101 as the data identifier corresponding to the gNB-DU Identity and the updated system information for gNB-DU 6101 as the data.

In case that the O&M generates new system information for new gNB-DU, e.g. gNB-DU 6102, the O&M sends, to the UDSF-SI 7701, Nudsf_UnstructuredDataManagement_Update message including DU 6102 as the data identifier corresponding to the gNB-DU Identity of gNB-DU 6102 and the new system information for gNB-DU 6102 as the data. Once the system information for gNB-DU 6102 is installed in the UDSF-SI 7701, the UDSF-SI 7701 can provide the system information for gNB-DU 6102 when the UDSF-SI 7701 receives Nudsf_UnstructuredDataManagement_Query message including DU 6102 as the data identifier corresponding to the gNB-DU Identity.

3. The UDSF-SI 7701 updates the stored system information for gNB-DU 6101 associated with the DU 6101 to the received system information for gNB-DU 6101, stores the updated system information for gNB-DU 6101 associated with the DU 6101 as the data identifier corresponding to the gNB-DU Identity, and sends Nudsf_UnstructuredDataManagement_Update response message to the O&M.

4. The gNB-CU-CP 62011 sends, to the UDSF-SI 7701, Nudsf_UnstructuredDataManagement_Query message including DU 6101 as the data identifier corresponding to the gNB-DU Identity. The step 4 may be triggered by the gNB-CU-CP 62011 periodically. The query periodicity can be a configurable parameter in the O&M based on the operator policy or configuration.

5. The UDSF-SI 7701 sends, to the gNB-CU-CP 62011, Nudsf_UnstructuredDataManagement_Query response message including the updated system information for gNB-DU 6101 as the data.

6. The gNB-CU-CP 62011 sends, to the gNB-DU 6101, GNB-CU CONFIGURATION UPDATE message including the received system information if the gNB-CU-CP 62011 decides to update the system information in the gNB-DU 6101. The step 6 may be triggered by the gNB-CU-CP 62011 after the gNB-CU-CP 62011 receives the Nudsf_UnstructuredDataManagement_Query response message from the UDSF-SI 7701 in step 5.

7. The gNB-DU 6101 sends GNB-CU CONFIGURATION UPDATE ACKNOWLEDGE message to the gNB-CU-CP 62011.

8. The gNB-DU 6101 updates the stored system information to the received system information in step 6, stores the received system information, and uses it, for example, for broadcasting the system information.

### <Aspect 2: General>

The gNB-CU-Control Plane (gNB-CU-CP) backup architectures are disclosed.

<gNB-CU-CP Backup Architecture>

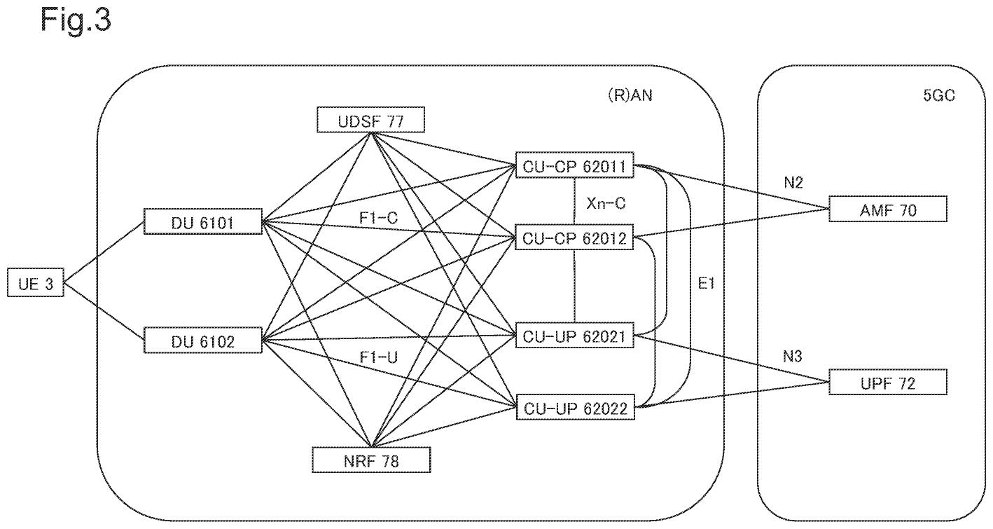

The FIG. 3 illustrates the (R)AN architecture with gNB-CU-CP backup.

Each gNB-CU-CP may have one or multiple backup gNB-CU-CP(s) to ensure service continuity in a case where the gNB-CU-CP fails. For example, each gNB-CU-CP may be connected to one or multiple backup gNB-CU-CP(s) to ensure service continuity in a case where the gNB-CU-CP fails.

In a case where the gNB-CU-CP fails, one of the backup gNB-CU-CPs takes over the role of the failed gNB-CU-CP so that existing RRC connections can be continuously served.

Two backup schemes are disclosed: one is gNB-CU-CP backup scheme and the other is UDSF backup scheme. For the gNB-CU-CP backup scheme, the UDSF may not be required in (R)AN.

<gNB-CU-CP Backup Scheme>

To deal with gNB-CU-CP failure, a gNB-CU-CP may optionally provide backup gNB-CU-CP related information to connected node(s), for example, gNB-DU(s), connected AMF(s), connected gNB-CU-UP(s) or connected gNB-CU-CP(s). The exemplary backup gNB-CU-CP related information is explained in the following procedures. At least one backup gNB-CU-CP acts as a backup of the associated gNB-CU-CP and takes over the role of the failed gNB-CU-CP so that existing RRC connections can be continuously served. One backup gNB-CU-CP is used if the associated gNB-CU-CP becomes unavailable to the connected gNB-DU(s), connected AMF(s), connected gNB-CU-UP(s) and connected gNB-CU-CP(s). The backup gNB-CU-CP may be chosen by the associated gNB-CU-CP based on local configuration in the associated gNB-CU-CP and be notified to the connected node(s). The associated gNB-CU-CP can be called as an original gNB-CU-CP or a failed gNB-CU-CP.

In a case where the original gNB-CU-CP fails, the backup gNB-CU-CP takes over the role of the failed gNB-CU-CP so that existing RRC connections in the original gNB-CU-CP can be continuously served by the backup gNB-CU-CP.

A new concept of the “gNB-CU-CP set” is disclosed in order to make it possible to share the same UE context(s) between the original gNB-CU-CP and the backup gNB-CU-CP(s).

The gNB-CU-CP set comprises at least one gNB-CU-CP that can share at least one given UE context. The gNB-CU-CP set indicates a group of the gNB-CU-CP(s) that can share UE context(s) within the group. The gNB-CU-CPs in the same gNB-CU-CP set may be geographically distributed, but they can access to the same UE context(s).

In order to maintain uniqueness of the UE context(s) among the gNB-CU-CPs in the same gNB-CU-CP set, the RAN UE NGAP ID, the NG-RAN node UE XnAP ID, gNB-CU-CP UE EIAP ID and gNB-CU UE F1AP ID in the UE context(s) are unique per gNB-CU-CP set.

Similarly, the P-RNTI (Paging-RNTI), the SI-RNTI (System Information-RNTI), RA-RNTI (Random Access-RNTI), the TC-RNTI (Temporary C-RNTI), the C-RNTI (Cell-RNTI), the MCS-C-RNTI, the CS-RNTI (Configured Scheduling-RNTI), the SP-CSI-RNTI (Semi-Persistent CSI-RNTI), the SFI-RNTI (Slot Format Indication-RNTI), the INT-RNTI (Interruption-RNTI), the TPC-PUCCH-RNTI, the TPC-PUSCH-RNTI, the TPC-SRS-RNTI and I-RNTI (Inactive-RNTI) may be unique per gNB-CU-CP set.

The UE context(s) in the original gNB-CU-CP are copied to the backup gNB-CU-CP(s) with implementation specific technology. For example, the UE context(s) in the original gNB-CU-CP are mirrored to the backup gNB-CU-CP(s) by low layer technology or the UE context(s) are copied to the backup gNB-CU-CP(s) upon completion of an ongoing transaction in the original gNB-CU-CP.

The gNB-CU-CP may have one or multiple backup gNB-CU-CP(s). If the original gNB-CU-CP has multiple backup gNB-CU-CPs, the UE context(s) in the original gNB-CU-CP are copied to the one or more multiple backup gNB-CU-CP(s).

### <UDSF Backup Scheme>

To deal with gNB-CU-CP failure, a gNB-CU-CP stores the UE context(s) in the UDSF. If the gNB-CU-CP supports the UDSF backup scheme, a gNB-CU-CP set needs to be assigned to the gNB-CU-CP.

The UE context(s) in the original gNB-CU-CP are copied to the UDSF with implementation specific technology. For example, the UE context(s) in the original gNB-CU-CP are mirrored to the UDSF by low layer technology or the UE context(s) are copied to the UDSF upon completion of an ongoing transaction in the original gNB-CU-CP.

In a case where the original gNB-CU-CP fails, any one of the gNB-CU-CPs in the gNB-CU-CP set takes over the role of the failed gNB-CU-CP so that the existing RRC connections in the original gNB-CU-CP can be continuously served by the one of the gNB-CU-CPs. The one of the gNB-CU-CPs in the gNB-CU-CP set may be chosen by the original gNB-CU-CP based on local configuration in the original gNB-CU-CP and be notified to the connected node(s) before the original gNB-CU-CP fails. In one example, the original gNB-CU-CP may provide, to the connected node(s), the gNB-CU-CP set including the gNB-CU-CPs with priority order. In this case, the connected node(s) choose a gNB-CU-CP with the highest priority in the gNB-CU-CP set when the original gNB-CU-CP fails. The one of the gNB-CU-CPs in the gNB-CU-CP set can be called as a chosen gNB-CU-CP, a selected gNB-CU-CP, a backup gNB-CU-CP or any other.

In addition, the gNB-CU-CP(s) in the gNB-CU-CP set can be added, deleted or updated anytime, for example, based on a traffic in the (R)AN. The gNB-CU-CP addition, deleting and updating may be performed based on the Network Functions Virtualisation (NFV); Management and Orchestration as defined in NPL 17. In this case, gNB-CU-CP can be considered as the Virtualised Network Function (VNF).

### <Backup Indication to Connected Nodes>

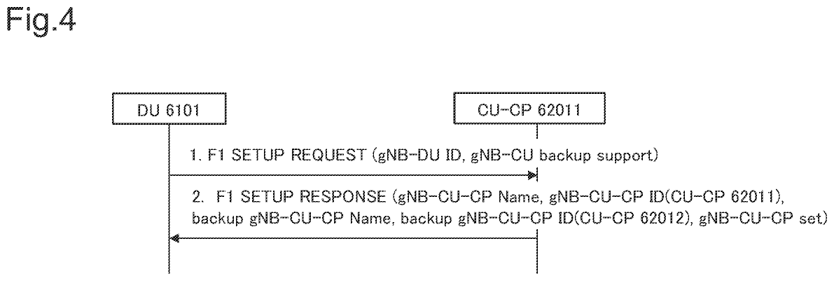

All connected nodes to the original gNB-CU-CP can know the backup gNB-CU-CP(s) before the original gNB-CU-CP may fail. The negotiation flows with connected nodes are illustrated in FIG. 4 to FIG. 10.

<F1 Setup Procedure with Backup gNB-CU-CP Related Information>

The FIG. 4 illustrates a procedure when the gNB-CU-CP informs backup gNB-CU-CP related information to the gNB-DU.

The detailed processes of the procedure are described as below.

1. The gNB-DU 6101 sends, to the gNB-CU-CP 62011, the F1 SETUP REQUEST message including gNB-DU ID and gNB-CU backup support parameter. The gNB-CU backup support parameter indicates the gNB-DU capability for supporting the gNB-CU-CP backup scheme or the UDSF backup scheme or both. The gNB-CU backup support parameter may indicate backup scheme which is supported by the gNB-DU 6101 in case of gNB-CU-CP failure. The gNB-CU backup support parameter may be set to the gNB-CU-CP backup scheme or the UDSF backup scheme or both.

2. Upon the gNB-CU-CP 62011 receiving the F1 SETUP REQUEST message, the gNB-CU-CP 62011 chooses a backup scheme based on the received gNB-CU backup support parameter. For example, the gNB-CU-CP 62011 chooses the gNB-CU-CP backup scheme in a case where the gNB-CU backup support parameter indicates the gNB-DU capability for supporting the gNB-CU-CP backup scheme. For example, the gNB-CU-CP 62011 chooses the UDSF backup scheme in a case where the gNB-CU backup support parameter indicates the gNB-DU capability for supporting the UDSF backup scheme. In a case where the gNB-CU backup support parameter indicates the gNB-DU capability for supporting both the gNB-CU-CP backup scheme and the UDSF backup scheme, the gNB-CU-CP 62011 may choose either the gNB-CU-CP backup scheme or the UDSF backup scheme based on a local configuration in the gNB-CU-CP 62011. In a case where the gNB-CU backup support parameter indicates the gNB-DU capability for supporting neither the gNB-CU-CP backup scheme nor the UDSF backup scheme, or in a case where the gNB-CU-CP 62011 determines that the gNB-CU backup support parameter is not included in the F1 SETUP REQUEST message or that the gNB-CU backup support parameter is set to null, the gNB-CU-CP 62011 may not choose the gNB-CU-CP backup scheme and the UDSF backup scheme.
If the UDSF backup scheme is chosen, the gNB-CU-CP 62011 sends, to the gNB-DU 6101, the F1 SETUP RESPONSE message including the gNB-CU-CP set. The gNB-CU-CP set indicates a group of the gNB-CU-CP(s) that can share UE context(s) within the group. The gNB-CU-CP set may include the gNB-CU-CP 62011 and the gNB-CU-CP 62012. The F1 SETUP RESPONSE message may include gNB-CU-CP Name. For example, the gNB-DU 6101 may select a backup gNB-CU-CP from gNB-CU-CP(s) indicated by the gNB-CU-CP set in a case where the original gNB-CU-CP fails. The gNB-CU-CP set may include IP address of the gNB-CU-CP(s).
If the gNB-CU-CP backup scheme is chosen, the gNB-CU-CP 62011 sends, to the gNB-DU 6101, the F1 SETUP RESPONSE message including backup gNB-CU-CP Name, gNB-CU-CP ID, backup gNB-CU-CP ID and optionally gNB-CU-CP set. The backup gNB-CU-CP Name may be called as backup gNB-CU-CP Name parameter or backup gNB-CU-CP name. The backup gNB-CU-CP Name parameter can be a FQDN format or IP address that can indicate a backup gNB-CU-CP to be used when the gNB-DU 6101 detects a failure on the original gNB-CU-CP. The backup gNB-CU-CP Name parameter may be a FQDN format or IP address of a backup gNB-CU-CP to be used when the gNB-DU 6101 detects a failure on the original gNB-CU-CP. The backup gNB-CU-CP Name parameter may be a name of backup gNB-CU-CP. The backup gNB-CU-CP Name parameter can be a FQDN format or IP address of the gNB-CU-CP 62012 in a case where the backup gNB-CU-CP for the gNB-CU-CP 62011 is gNB-CU-CP 62012. The gNB-CU-CP ID may be an identifier of gNB-CU-CP. For example, the gNB-CU-CP ID may be an identifier of the gNB-CU-CP 62011. The backup gNB-CU-CP ID may be an identifier of the backup gNB-CU-CP. For example, the backup gNB-CU-CP ID may be an identifier of gNB-CU-CP 62012. For example, in a case where the backup gNB-CU-CP for the gNB-CU-CP 62011 is gNB-CU-CP 62012, the backup gNB-CU-CP ID may be an identifier of the gNB-CU-CP 62012. The F1 SETUP RESPONSE message may include gNB-CU-CP Name. For example, the gNB-DU 6101 may select the gNB-CU-CP indicated by the backup gNB-CU-CP Name or the backup gNB-CU-CP ID as the backup gNB-CU-CP in a case where the original gNB-CU-CP fails.

If the gNB-CU-CP 62011 is configured to have multiple backup gNB-CU-CPs, the backup gNB-CU-CP Name parameter is a list of multiple backup gNB-CU-CPs. The list of the backup gNB-CU-CPs can be set with priority order. It means that if original gNB-CU-CP 62011 fails, the first entry of the gNB-CU-CP in the list is chosen as the backup gNB-CU-CP. If the first entry of the gNB-CU-CP in the list is out of service or heavily congested, the second entry of the gNB-CU-CP in the list is chosen as the backup gNB-CU-CP. The gNB-DU 6101 may select the backup gNB-CU-CP from gNB-CU-CPs included in the list.

The gNB-DU may initiate another F1 SETUP procedure to the backup gNB-CU-CP right after the F1 SETUP RESPONSE message of step 2 is received from the original gNB-CU-CP. Alternatively, the gNB-DU may initiate the F1 SETUP procedure to the backup gNB-CU-CP when the gNB-DU detects the failure in the original gNB-CU-CP.
If none of backup scheme is chosen, the gNB-CU-CP 62011 sends the F1 SETUP RESPONSE message to the gNB-DU 6101 including neither the backup gNB-CU-CP Name, the backup gNB-CU-CP ID nor the gNB-CU-CP set. In this case no gNB-CU backup procedure takes place.

Note that the backup gNB-CU-CP Name, the gNB-CU-CP ID and the gNB-CU-CP set can also be transferred from the gNB-CU-CP to the gNB-DU by GNB-CU CONFIGURATION UPDATE message or other F1AP messages.

Note that the gNB-CU-CP set can be an independent parameter or subset of gNB-CU-CP ID parameter. The gNB-CU-CP ID is a new parameter that identifies the gNB-CU-CP.

For example, according to the above processes, the gNB-DU 6101 can know the backup gNB-CU-CP for the gNB-CU-CP 62011. For example, according to the above processes, the gNB-DU 6101 can know the gNB-CU-CP 62012 as the backup gNB-CU-CP for the gNB-CU-CP 62011. The backup gNB-CU-CP related information may be information included in the F1 SETUP REQUEST message. The backup gNB-CU-CP related information may be information included in the F1 SETUP RESPONSE message. The F1 Setup procedure may be triggered when a predetermined condition is met. For example, the F1 Setup procedure may be triggered periodically or based on local configuration in the gNB-DU 6101.

<NG Setup Procedure with Backup gNB-CU-CP Related Information>

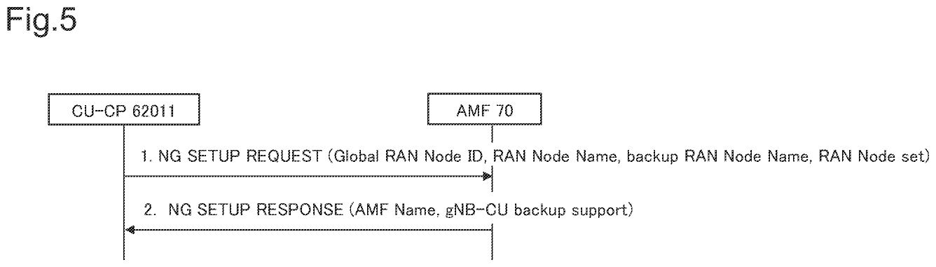

The FIG. 5 illustrates the procedure when the gNB-CU-CP informs backup gNB-CU-CP related information to the AMF.

The detailed processes of the procedure are described as below.

1. The gNB-CU-CP 62011 sends, to the AMF 70, the NG SETUP REQUEST message including Global RAN Node ID, RAN Node Name, backup RAN Node Name and RAN Node set parameter. The RAN Node Name may be called as RAN Node Name parameter or RAN Node name. The backup RAN Node Name may be called as backup RAN Node Name parameter or backup RAN Node name. The RAN Node set parameter may be called as RAN Node set. The backup RAN Node name may be a name of the backup RAN Node. For example, the backup RAN Node name may be a name or identifier of backup gNB-CU-CP for the gNB-CU-CP 62011. For example, the backup RAN Node name may be a name or identifier of the gNB-CU-CP 62012 in case where the backup gNB-CU-CP for the gNB-CU-CP 62011 is the gNB-CU-CP 62012. The backup RAN Node name can be a FQDN format or IP address that can indicate a gNB-CU-CP to be used in case of a failure on the original gNB-CU-CP. The backup RAN Node name may be a FQDN format or IP address of a gNB-CU-CP to be used in case of a failure on the original gNB-CU-CP. The backup RAN Node name can be a FQDN format or IP address of the gNB-CU-CP 62012 in a case where the backup gNB-CU-CP for the gNB-CU-CP 62011 is gNB-CU-CP 62012. The RAN Node set parameter indicates a group of the RAN Node(s). The RAN Node set parameter may indicate a group of the gNB-CU-CP(s) that can share UE context(s) within the group. The RAN Node set parameter may include the gNB-CU-CP 62011 and the gNB-CU-CP 62012. The RAN Node set parameter may include IP address of the gNB-CU-CP(s). The backup RAN Node name may be a FQDN format or IP address of a backup RAN Node to be used in case of a failure on the original gNB-CU-CP. The backup RAN Node name may be a FQDN format or IP address of backup gNB-CU-CP for the gNB-CU-CP 62011 to be used in case of a failure on the original gNB-CU-CP. The backup RAN Node name may be a FQDN format or IP address of the gNB-CU-CP 62012 in case where the backup gNB-CU-CP for the gNB-CU-CP 62011 is the gNB-CU-CP 62012.

If the gNB-CU-CP 62011 is configured to have multiple backup RAN Nodes (e.g. multiple backup gNB-CU-CPs), the backup RAN Node name parameter is a list of multiple backup RAN Nodes (i.e. multiple backup gNB-CU-CPs). The list of backup RAN Nodes can be set with priority order. It means that if the original gNB-CU-CP 62011 fails, the first entry of the backup RAN Node (e.g. gNB-CU-CP) in the list is chosen as the backup RAN Node (e.g. backup gNB-CU-CP). If the first entry of the backup RAN Node in the list is out of service or heavily congested, the second entry of the backup RAN Node (e.g. gNB-CU-CP) in the list is chosen as the backup RAN Node (e.g. backup gNB-CU-CP).

2. Upon the AMF 70 receiving the NG SETUP REQUEST message, the AMF 70 chooses a backup scheme based on the received parameter in step 1 and a local configuration in the AMF 70. The AMF 70 sends, to the gNB-CU-CP 62011, the NG SETUP RESPONSE message including AMF Name and gNB-CU backup support parameter. The AMF Name may be called as AMF Name parameter or AMF name. The gNB-CU backup support parameter may be called as gNB-CU backup support. The gNB-CU backup support parameter can be the UDSF backup scheme or the gNB-CU-CP backup scheme or both or null. For example, the AMF 70 chooses the UDSF backup scheme as the backup scheme, and sets the UDSF backup scheme in the gNB-CU backup support parameter. For example, the AMF 70 chooses the gNB-CU-CP backup scheme as the backup scheme, and sets the gNB-CU-CP backup scheme in the gNB-CU backup support parameter. For example, in a case where the AMF 70 does not support the UDSF backup scheme and the gNB-CU-CP backup scheme, the AMF 70 sets the gNB-CU backup support parameter to null.
If the gNB-CU-CP 62011 receives the UDSF backup scheme in the gNB-CU backup support parameter, the gNB-CU-CP 62011 recognizes that the UDSF backup scheme is chosen as the backup scheme and thus the RAN Node set parameter in the NG SETUP REQUEST message in step 1 is respected in the AMF 70.
If the gNB-CU-CP 62011 receives the gNB-CU-CP backup scheme in the gNB-CU backup support parameter, the gNB-CU-CP 62011 recognizes that the gNB-CU-CP backup scheme is chosen as the backup scheme and thus the backup RAN Node name and RAN Node set parameter in the NG SETUP REQUEST message in step 1 is respected in the AMF 70.
If none of the backup schemes is chosen (e.g. if the gNB-CU-CP 62011 receives the gNB-CU backup support parameter which is set to null), the gNB-CU backup procedure does not take place.

Note that the backup RAN Node name and RAN Node set parameter can also be transferred from the gNB-CU-CP to the AMF by RAN CONFIGURATION UPDATE message, AMF CONFIGURATION UPDATE ACKNOWLEDGE message or other NGAP messages.

Note that the RAN Node set can be an independent parameter or subset of Global RAN Node ID parameter.

For example, according to the above processes, the AMF 70 can know the backup gNB-CU-CP for the gNB-CU-CP 62011. For example, according to the above processes, the AMF 70 can know the gNB-CU-CP 62012 as the backup gNB-CU-CP for the gNB-CU-CP 62011. The backup gNB-CU-CP related information may be information included in the NG SETUP REQUEST message. The backup gNB-CU-CP related information may be information included in the NG SETUP RESPONSE message. The NG Setup procedure may be triggered when a predetermined condition is met. For example, the NG Setup procedure may be triggered periodically or based on local configuration in the gNB-CU-CP 62011.

<E1 Setup Procedure with Backup gNB-CU-CP Related Information>

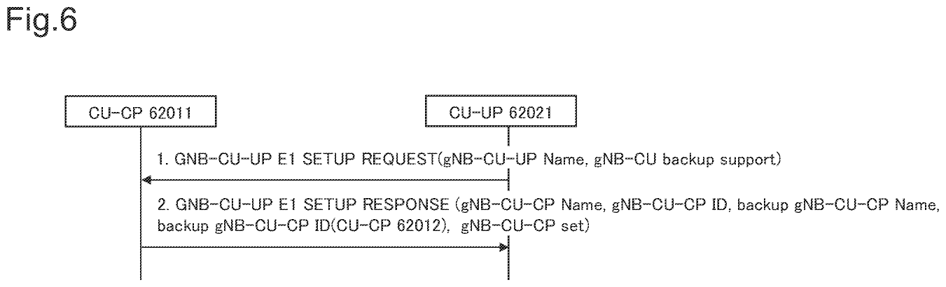

The FIG. 6 illustrates the procedure when the gNB-CU-CP informs backup gNB-CU-CP related information to the gNB-CU-UP by GNB-CU-UP E1 SETUP procedure.

The detailed processes of the procedure are described as below.

1. The gNB-CU-UP 62021 sends, to the gNB-CU-CP 62011, the GNB-CU-UP E1 SETUP REQUEST message including gNB-CU-UP Name and gNB-CU backup support parameter. The gNB-CU backup support parameter indicates the gNB-CU-UP 62021 capability for supporting the gNB-CU-CP backup scheme or the UDSF backup scheme or both. For example, in a case where the gNB-CU-UP 62021 supports the UDSF backup scheme as the backup scheme, the gNB-CU-UP 62021 sets the UDSF backup scheme in the gNB-CU backup support parameter. For example, in a case where the gNB-CU-UP 62021 supports the gNB-CU-CP backup scheme as the backup scheme, the gNB-CU-UP 62021 sets the gNB-CU-CP backup scheme in the gNB-CU backup support parameter. For example, in a case where the gNB-CU-UP 62021 does not support the UDSF backup scheme and the gNB-CU-CP backup scheme, the gNB-CU-UP 62021 sets the gNB-CU backup support parameter to null. For example, in a case where the gNB-CU-UP 62021 supports both the UDSF backup scheme and the gNB-CU-CP backup scheme, the gNB-CU-UP 62021 sets either the UDSF backup scheme or the gNB-CU-CP backup scheme in the gNB-CU backup support parameter based on a local configuration in the gNB-CU-UP 62021.

2. Upon the gNB-CU-CP 62011 receiving the GNB-CU-UP E1 SETUP REQUEST message, the gNB-CU-CP 62011 sends, to the gNB-CU-UP 62021, the GNB-CU-UP E1 SETUP RESPONSE message including gNB-CU-CP Name, gNB-CU-CP ID, backup gNB-CU-CP Name, backup gNB-CU-CP ID and gNB-CU-CP set parameter depending upon the received gNB-CU backup support parameter. The gNB-CU-CP ID may be an identifier of gNB-CU-CP. The gNB-CU-CP ID may be an identifier of gNB-CU-CP 62011. The backup gNB-CU-CP Name may be a name of backup gNB-CU-CP. The backup gNB-CU-CP Name can be a FQDN format or IP address that can indicate a gNB-CU-CP to be used in case of a failure on the original gNB-CU-CP. The backup gNB-CU-CP Name may be a FQDN format or IP address of a gNB-CU-CP to be used in case of a failure on the original gNB-CU-CP. The backup gNB-CU-CP Name can be a FQDN format or IP address of the gNB-CU-CP 62012 in a case where the backup gNB-CU-CP for the gNB-CU-CP 62011 is gNB-CU-CP 62012. The backup gNB-CU-CP ID may be an identifier of the backup gNB-CU-CP. The backup gNB-CU-CP ID may be an identifier of the backup gNB-CU-CP 62012. For example, in a case where the backup gNB-CU-CP for the gNB-CU-CP 62011 is gNB-CU-CP 62012, the backup gNB-CU-CP ID may be an identifier of the gNB-CU-CP 62012. The gNB-CU-CP set parameter may be called as gNB-CU-CP set. The gNB-CU-CP set parameter indicates a group of the gNB-CU-CPs. The gNB-CU-CP set parameter may indicate gNB-CU-CP set. The gNB-CU-CP set parameter may indicate a group of the gNB-CU-CP(s) that can share UE context(s) within the group. The gNB-CU-CP set parameter may include the gNB-CU-CP 62011 and the gNB-CU-CP 62012. The gNB-CU-CP set parameter may include IP address of the gNB-CU-CP(s).

If the gNB-CU-CP 62011 receives the UDSF backup scheme in the gNB-CU backup support parameter, the gNB-CU-CP 62011 sends the gNB-CU-CP set parameter in the GNB-CU-UP E1 SETUP RESPONSE message. For example, the gNB-CU-UP 62021 may select the backup gNB-CU-CP from gNB-CU-CPs indicated by the gNB-CU-CP set parameter in a case where the original gNB-CU-CP fails. The gNB-CU-CP set parameter may include IP address of the gNB-CU-CP(s).

If the gNB-CU-CP 62011 receives the gNB-CU-CP backup scheme in the gNB-CU backup support parameter, the gNB-CU-CP 62011 sends the gNB-CU-CP ID, the backup gNB-CU-CP Name, backup gNB-CU-CP ID and optionally gNB-CU-CP set in the GNB-CU-UP E1 SETUP RESPONSE message. For example, the gNB-CU-UP 62021 may select a gNB-CU-CP indicated by the backup gNB-CU-CP Name or the backup gNB-CU-CP ID as the backup gNB-CU-CP in a case where the original gNB-CU-CP fails.

If the gNB-CU-CP 62011 is configured to have multiple backup gNB-CU-CPs, the backup gNB-CU-CP Name parameter is a list of backup gNB-CU-CPs. The list of backup gNB-CU-CPs can be set with priority order. It means that if original gNB-CU-CP 62011 fails, the first entry of the gNB-CU-CP in the list is chosen as the backup gNB-CU-CP. If the first entry of the gNB-CU-CP in the list is out of service or heavily congested, the second entry of the gNB-CU-CP in the list is chosen as the backup gNB-CU-CP. The gNB-CU-UP 62021 may select the backup gNB-CU-CP from gNB-CU-CPs included in the list.

If none of the backup scheme is chosen (e.g. if the gNB-CU-CP 62011 receives the gNB-CU backup support parameter which is set to null), the gNB-CU-CP 62011 sends, to the gNB-CU-UP 62021, the GNB-CU-UP E1 SETUP RESPONSE message including neither the backup gNB-CU-CP Name nor the gNB-CU-CP set. In this case no gNB-CU backup procedure takes place.

Note that the gNB-CU-CP set can be an independent parameter or subset of gNB-CU-CP ID parameter. The gNB-CU-CP ID is a new parameter that identifies the gNB-CU-CP.

For example, according to the above processes in the FIG. 6, the gNB-CU-UP 62021 can know the backup gNB-CU-CP for the gNB-CU-CP 62011. For example, according to the above processes in the FIG. 6, the gNB-CU-UP 62021 can know the gNB-CU-CP 62012 as the backup gNB-CU-CP for the gNB-CU-CP 62011. The backup gNB-CU-CP related information may be information included in the GNB-CU-UP E1 SETUP REQUEST message. The backup gNB-CU-CP related information may be information included in the GNB-CU-UP E1 SETUP RESPONSE message. The GNB-CU-UP E1 Setup procedure may be triggered when predetermined condition is met. For example, the GNB-CU-UP E1 Setup procedure may be triggered periodically or based on local configuration in the gNB-CU-UP 62021.

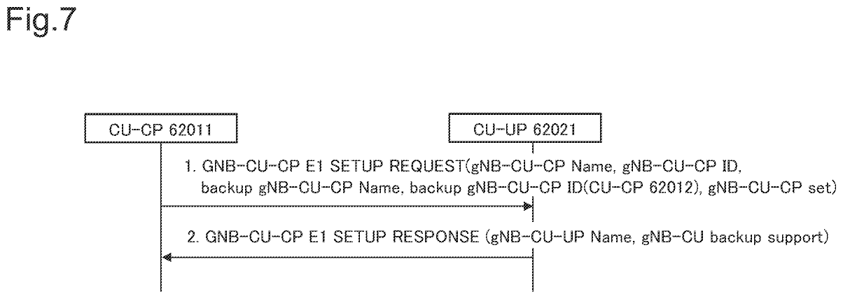

The FIG. 7 illustrates the procedure when the gNB-CU-CP provides the backup gNB-CU-CP related information to the gNB-CU-UP by GNB-CU-CP E1 SETUP procedure.

The detailed processes of the procedure are described as below:

1. The gNB-CU-CP 62011 sends, to the gNB-CU-UP 62021, the GNB-CU-CP E1 SETUP REQUEST message including gNB-CU-CP Name, gNB-CU-CP ID, backup gNB-CU-CP Name, backup gNB-CU-CP ID and gNB-CU-CP set parameter. The backup gNB-CU-CP name may be called as backup gNB-CU-CP name parameter. The gNB-CU-CP ID may be identifier of gNB-CU-CP. The gNB-CU-CP ID may be identifier of gNB-CU-CP 62011. The backup gNB-CU-CP Name may be a name of backup gNB-CU-CP. The backup gNB-CU-CP Name can be a FQDN format or IP address that can indicate a gNB-CU-CP to be used in case of a failure on the original gNB-CU-CP. The backup gNB-CU-CP Name may be a FQDN format or IP address of a gNB-CU-CP to be used in case of a failure on the original gNB-CU-CP. The backup gNB-CU-CP name can be a FQDN format or IP address of the gNB-CU-CP 62012 in a case where the backup gNB-CU-CP for the gNB-CU-CP 62011 is gNB-CU-CP 62012. The backup gNB-CU-CP ID may be identifier of the backup gNB-CU-CP. The backup gNB-CU-CP ID may be identifier of the backup gNB-CU-CP 62012. For example, in a case where the backup gNB-CU-CP for the gNB-CU-CP 62011 is gNB-CU-CP 62012, the backup gNB-CU-CP ID may be identifier of the gNB-CU-CP 62012. The gNB-CU-CP set parameter may be called as gNB-CU-CP set. The gNB-CU-CP set parameter indicates a group of the gNB-CU-CP(s). The gNB-CU-CP set parameter may indicate gNB-CU-CP set. The gNB-CU-CP set parameter may indicate a group of the gNB-CU-CP(s) that can share UE context(s) within the group. The gNB-CU-CP set parameter may include the gNB-CU-CP 62011 and the gNB-CU-CP 62012. The gNB-CU-CP set parameter may include IP address of the gNB-CU-CP(s).

If the gNB-CU-CP 62011 is configured to have multiple backup gNB-CU-CPs, the backup gNB-CU-CP Name parameter is a list of backup gNB-CU-CPs. The list of backup gNB-CU-CPs can be set with priority order. It means that if original gNB-CU-CP 62011 fails, the first entry of the gNB-CU-CP in the list is chosen as the backup gNB-CU-CP. If the first entry of the gNB-CU-CP in the list is out of service or heavily congested, the second entry of the gNB-CU-CP in the list is chosen as the backup gNB-CU-CP.

2. Upon the gNB-CU-UP 62021 receives the GNB-CU-CP E1 SETUP REQUEST message, the gNB-CU-UP 62021 chooses a backup scheme based on the received parameter. The gNB-CU-UP 62021 sends, to the gNB-CU-CP 62011, the GNB-CU-CP E1 SETUP RESPONSE message including gNB-CU-UP Name and gNB-CU backup support parameter. The gNB-CU backup support parameter can be null, the UDSF backup scheme or gNB-CU-CP backup scheme. For example, in a case where the gNB-CU-UP 62021 supports the UDSF backup scheme as the backup scheme, the gNB-CU-UP 62021 sets the UDSF backup scheme in the gNB-CU backup support parameter. For example, in a case where the gNB-CU-UP 62021 supports the gNB-CU-CP backup scheme as the backup scheme, the gNB-CU-UP 62021 sets the gNB-CU-CP backup scheme in the gNB-CU backup support parameter. For example, in a case where the gNB-CU-UP 62021 does not support the UDSF backup scheme and the gNB-CU-CP backup scheme, the gNB-CU-UP 62021 sets the gNB-CU backup support parameter to null. For example, in a case where the gNB-CU-UP 62021 supports both the UDSF backup scheme and the gNB-CU-CP backup scheme, the gNB-CU-UP 62021 sets either the UDSF backup scheme or the gNB-CU-CP backup scheme in the gNB-CU backup support parameter based on a local configuration in the gNB-CU-UP 62021.

For example, the gNB-CU-UP 62021 may select the backup gNB-CU-CP from gNB-CU-CP(s) indicated by the gNB-CU-CP set parameter in a case where the original gNB-CU-CP fails. For example, the gNB-CU-UP 62021 may select the gNB-CU-CP indicated by the backup gNB-CU-CP Name or the backup gNB-CU-CP ID as the backup gNB-CU-CP in a case where the original gNB-CU-CP fails. The gNB-CU-UP 62021 may select the backup gNB-CU-CP from gNB-CU-CPs included in the list of backup gNB-CU-CPs.
If the gNB-CU-CP 62011 receives the UDSF backup scheme in the gNB-CU backup support parameter, the gNB-CU-CP 62011 recognizes that the UDSF backup scheme is chosen as the backup scheme and thus the gNB-CU-CP set parameter in the GNB-CU-CP E1 SETUP REQUEST message in step 1 is respected in the gNB-CU-UP 62021.
If the gNB-CU-CP 62011 receives the gNB-CU-CP backup scheme in the gNB-CU backup support parameter, the gNB-CU-CP 62011 recognizes that the gNB-CU-CP backup scheme is chosen as the backup scheme and thus the gNB-CU-CP ID, the backup gNB-CU-CP Name, the backup gNB-CU-CP ID and optionally gNB-CU-CP set in the GNB-CU-CP E1 SETUP REQUEST message in step 1 is respected in the gNB-CU-UP 62021.
If none of backup scheme is chosen (e.g. if the gNB-CU-CP 62011 receives the gNB-CU backup support parameter which is set to null), the gNB-CU backup procedure does not take place.

Note that the backup gNB-CU-CP Name and gNB-CU-CP set parameter can also be transferred from the gNB-CU-CP to the gNB-CU-UP by GNB-CU-UP E1 SETUP RESPONSE message, GNB-CU-CP CONFIGURATION UPDATE message, GNB-CU-UP CONFIGURATION UPDATE ACKNOWLEDGE message or other NGAP messages.

Note that the gNB-CU-CP set can be an independent parameter or subset of gNB-CU-CP ID parameter. The gNB-CU-CP ID is a new parameter that identifies the gNB-CU-CP.

For example, according to the above processes in the FIG. 7, the gNB-CU-UP 62021 can know the backup gNB-CU-CP for the gNB-CU-CP 62011. For example, according to the above processes in the FIG. 7, the gNB-CU-UP 62021 can know the gNB-CU-CP 62012 as the backup gNB-CU-CP for the gNB-CU-CP 62011. The backup gNB-CU-CP related information may be information included in the GNB-CU-CP E1 SETUP REQUEST message. The backup gNB-CU-CP related information may be information included in the GNB-CU-CP E1 SETUP RESPONSE message. The GNB-CU-CP E1 Setup procedure may be triggered when a predetermined condition is met. For example, the GNB-CU-CP E1 Setup procedure may be triggered periodically or based on local configuration in the gNB-CU-CP 62011.

<XN Setup Procedure with Backup gNB-CU-CP Related Information>

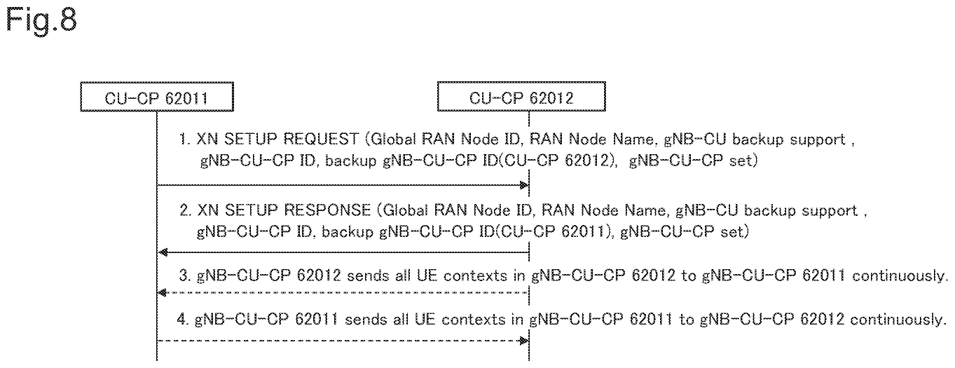

The FIG. 8 illustrates the procedure when the gNB-CU-CP informs backup gNB-CU-CP related information to another gNB-CU-CP.

The detailed processes of the procedure are described as below.

1. The gNB-CU-CP 62011 sends, to the gNB-CU-CP 62012, the XN SETUP REQUEST message including Global RAN Node ID, RAN Node Name, gNB-CU backup support, gNB-CU-CP ID, backup gNB-CU-CP ID and gNB-CU-CP set parameter. The RAN Node Name may be a name of a RAN Node. The gNB-CU-CP ID may be an identifier of the gNB-CU-CP 62011. The gNB-CU backup support may be called as gNB-CU backup support parameter. The gNB-CU backup support parameter indicates the gNB-CU-CP 62011 capability for supporting the gNB-CU-CP backup scheme or the UDSF backup scheme or both.

The backup gNB-CU-CP ID may be an identifier of backup gNB-CU-CP. For example, the backup gNB-CU-CP ID may be an identifier of gNB-CU-CP 62012. For example, in a case where the backup gNB-CU-CP for the gNB-CU-CP 62011 is gNB-CU-CP 62012, the backup gNB-CU-CP ID may be an identifier of the gNB-CU-CP 62012. If the gNB-CU-CP 62011 is configured to have multiple backup gNB-CU-CPs, the backup gNB-CU-CP ID may include a list of backup gNB-CU-CPs. The list of backup gNB-CU-CPs can be set with priority order. It means that if original gNB-CU-CP 62011 fails, the first entry of the gNB-CU-CP in the list is chosen as the backup gNB-CU-CP. If the first entry of the gNB-CU-CP in the list is out of service or heavily congested, the second entry of the gNB-CU-CP in the list is chosen as the backup gNB-CU-CP. The gNB-CU-CP set parameter indicates a group of the gNB-CU-CP(s). The gNB-CU-CP set parameter may indicate gNB-CU-CP set. The gNB-CU-CP set parameter may indicate a group of the gNB-CU-CP(s) that can share UE context(s) within the group. The gNB-CU-CP set parameter may include the gNB-CU-CP 62011 and the gNB-CU-CP 62012. The gNB-CU-CP set parameter may include IP address of the gNB-CU-CP(s).

The XN SETUP REQUEST message may include backup gNB-CU-CP Name. The backup gNB-CU-CP Name may be a name of backup gNB-CU-CP. The backup gNB-CU-CP Name can be a FQDN format or IP address that can indicate a gNB-CU-CP to be used in case of a failure on the original gNB-CU-CP. The backup gNB-CU-CP Name may be a FQDN format or IP address of a gNB-CU-CP to be used in case of a failure on the original gNB-CU-CP. The backup gNB-CU-CP Name can be a FQDN format or IP address of the gNB-CU-CP 62012 in a case where the backup gNB-CU-CP for the gNB-CU-CP 62011 is gNB-CU-CP 62012.

2. Upon the gNB-CU-CP 62012 receiving the XN SETUP REQUEST message, the gNB-CU-CP 62012 chooses a backup scheme based on the received parameter. The gNB-CU-CP 62012 sends, to the gNB-CU-CP 62011, the XN SETUP RESPONSE message including Global RAN Node ID, RAN Node Name, gNB-CU backup support, gNB-CU-CP ID, backup gNB-CU-CP ID and gNB-CU-CP set parameter. The gNB-CU backup support parameter indicates a chosen backup scheme by the gNB-CU-CP 62012. The gNB-CU backup support parameter can be the gNB-CU-CP backup scheme or the UDSF backup scheme or none. The RAN Node Name may be a name of a RAN Node. The gNB-CU-CP ID may be identifier of the gNB-CU-CP 62012. The backup gNB-CU-CP ID may be identifier of backup gNB-CU-CP. For example, the backup gNB-CU-CP ID may be identifier of gNB-CU-CP 62011. For example, in a case where the backup gNB-CU-CP for the gNB-CU-CP 62012 is gNB-CU-CP 62011, the backup gNB-CU-CP ID may be an identifier of the gNB-CU-CP 62011. The gNB-CU-CP set parameter indicates a group of the gNB-CU-CP(s). The gNB-CU-CP set parameter may indicate gNB-CU-CP set. The gNB-CU-CP set parameter may indicate a group of the gNB-CU-CP(s) that can share UE context(s) within the group. The gNB-CU-CP set parameter may include the gNB-CU-CP 62011 and the gNB-CU-CP 62012. The gNB-CU-CP set parameter may include IP address of the gNB-CU-CP(s).

The XN SETUP RESPONSE message may include backup gNB-CU-CP Name. The backup gNB-CU-CP Name may be a name of backup gNB-CU-CP. The backup gNB-CU-CP Name can be a FQDN format or IP address that can indicate a backup gNB-CU-CP to be used in case of a failure on the original gNB-CU-CP. The backup gNB-CU-CP Name may be a FQDN format or IP address of a backup gNB-CU-CP to be used in case of a failure on the original gNB-CU-CP. The backup gNB-CU-CP Name can be a FQDN format or IP address of the gNB-CU-CP 62011 in a case where the backup gNB-CU-CP for the gNB-CU-CP 62012 is gNB-CU-CP 62011.

If both the XN SETUP REQUEST message and the XN SETUP RESPONSE message includes the backup gNB-CU-CP ID indicating each peer gNB-CU-CP ID and gNB-CU-CP backup scheme is chosen, it means that each gNB-CU-CP chooses peer gNB-CU-CP as a backup node and mutual backup is activated. For example, in a case where the XN SETUP REQUEST message which is transmitted by gNB-CU-CP 62011 includes backup gNB-CU-CP ID which is set to “gNB-CU-CP 62012” and the XN SETUP RESPONSE message which is transmitted by gNB-CU-CP 62012 includes backup gNB-CU-CP ID which is set to “gNB-CU-CP 62011” and both of the XN SETUP REQUEST message and the XN SETUP RESPONSE message include the gNB-CU back up support which is set to the gNB-CU-CP backup scheme or the UDSF backup scheme, the gNB-CU-CP 62011 is a backup node for the gNB-CU-CP 62012, and the gNB-CU-CP 62012 is a backup node for the gNB-CU-CP 62011.

In case that gNB-CU-CP 62011 designates gNB-CU-CP 62013 as a backup gNB-CU-CP, it is assumed that there is Xn interface established between the backup gNB-CU-CP 62013 and the gNB-CU-CP 62012 based on the local configuration. In addition, for example, in a case where the gNB-CU-CP 62013 may receive, from the gNB-CU-CP 62011, XN SETUP REQUEST message including the backup gNB-CU-CP ID which is set to gNB-CU-CP 62012, the gNB-CU-CP 62013 can know that the backup gNB-CU-CP for the gNB-CU-CP 62011 is the gNB-CU-CP 62012.

3. If the gNB-CU-CP 62012 includes backup gNB-CU-CP ID set to gNB-CU-CP 62011 in the XN SETUP RESPONSE message, the gNB-CU-CP 62012 starts sending UE context(s) in gNB-CU-CP 62012 to the gNB-CU-CP 62011 for backup purpose.

4. If the gNB-CU-CP 62011 receives the successful XN SETUP RESPONSE message including gNB-CU-CP backup scheme in the gNB-CU backup support parameter, the gNB-CU-CP 62011 starts sending UE contexts in gNB-CU-CP 62011 to the gNB-CU-CP 62012 for backup purpose.

Note that the gNB-CU-CP set can be an independent parameter or a subset of Global RAN Node ID parameter.

For example, according to the above processes, the gNB-CU-CP 62011 can know the backup gNB-CU-CP for the gNB-CU-CP 62011. For example, according to the above processes, the gNB-CU-CP 62011 can know the gNB-CU-CP 62012 as the backup gNB-CU-CP for the gNB-CU-CP 62011. For example, according to the above processes, the gNB-CU-CP 62012 can know the backup gNB-CU-CP for the gNB-CU-CP 62012. For example, according to the above processes, the gNB-CU-CP 62012 can know the gNB-CU-CP 62011 as the backup gNB-CU-CP for the gNB-CU-CP 62012.

The backup gNB-CU-CP related information may be information included in the XN SETUP REQUEST message. The backup gNB-CU-CP related information may be information included in the XN SETUP RESPONSE message. The XN Setup procedure may be triggered when a predetermined condition is met. For example, the XN Setup procedure may be triggered periodically or based on local configuration in the gNB-CU-CP 62011.

<Switchover Mechanism with the gNB-CU-CP Backup Scheme>

In case that a gNB-CU-CP fails, all existing processes in the failed gNB-CU-CP are switched over to the backup gNB-CU-CP.

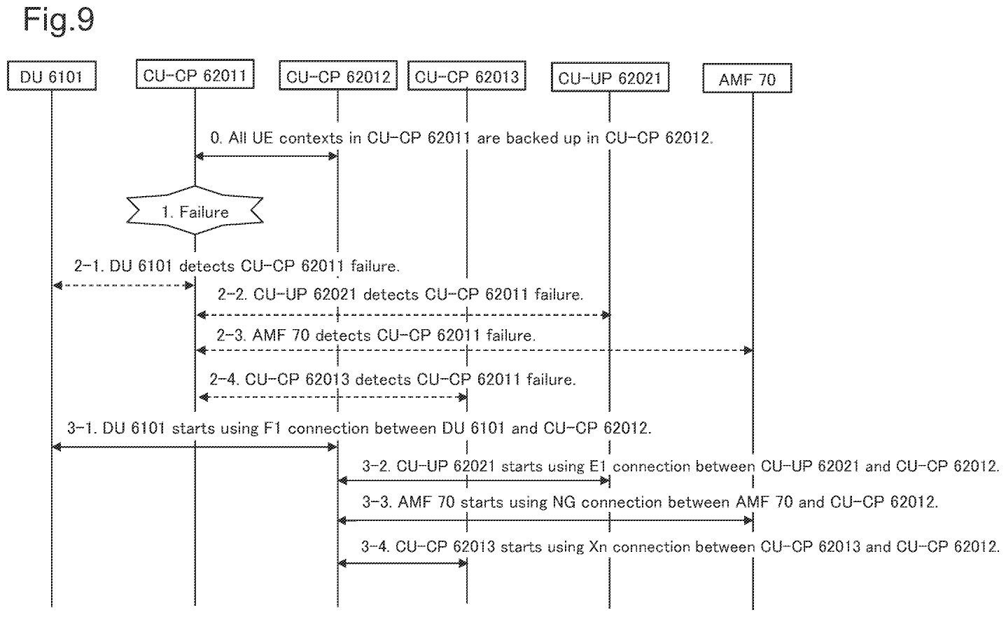

The FIG. 9 illustrates the switchover procedure with the gNB-CU-CP backup scheme when the gNB-CU-CP fails.

The detailed processes of the procedure are described as below:

0. All UE context(s) to handle the UE in both RRC INACTIVE state and RRC_CONNECTED state in the gNB-CU-CP 62011 are constantly backed up in the gNB-CU-CP 62012 by implementation specific technology. For example, the UE context(s) in the original gNB-CU-CP 62011 are mirrored to the backup gNB-CU-CP 62012 by low layer technology or UE context(s) are copied to the backup gNB-CU-CP 62012 upon completion of an ongoing transaction in the gNB-CU-CP 62011.

In addition, other data, for example system information related data, in the gNB-CU-CP 62011 may also be backed up in the gNB-CU-CP 62012. For example, the UE context(s) in the original gNB-CU-CP 62011 are mirrored or copied to the backup gNB-CU-CP 62012 based on the step 4 in FIG. 8.

1. The gNB-CU-CP 62011 fails. The failure in gNB-CU-CP 62011 includes unexpected system reset, system rebooting, system stall, system congestion and communication failure with connected nodes.

2-1. The gNB-DU 6101 detects that the gNB-CU-CP 62011 has failed based on one or combination of the following monitored events at the gNB-DU 6101.
Based on the SCTP layer between the gNB-DU 6101 and the gNB-CU-CP 62011 as defined in NPL 4, a sanity of the gNB-CU-CP 62011 can be monitored. The SCTP, as defined in NPL 5, provides the heartbeat mechanism between peer ends. If the gNB-DU 6101 does not receive the Heartbeat Acknowledgement chunk as a reply to the Heartbeat Request Chunk for pre-determined period from the gNB-CU-CP 62011, the gNB-DU 6101 may determine that the gNB-CU-CP 62011 has failed.
In case that the gNB-DU 6101 receives Abort Association chunk, Shutdown Association chunk, Operation Error chunk or another erroneous chunks, as defined in NPL 5, from the gNB-CU-CP 62011, the gNB-DU 6101 may determine that the gNB-CU-CP 62011 has failed.
In case that the gNB-DU 6101 receives F1 REMOVAL REQUEST message, RESET message, F1 SETUP FAILURE message or another existing message as defined in NPL 6 or new erroneous F1AP message over the F1 interface, the gNB-DU 6101 may determine that the gNB-CU-CP 62011 has failed.
In case that the gNB-DU 6101 receives, from the gNB-CU-CP 62012, an F1AP message indicating that the gNB-CU-CP 62011 has failed and the gNB-CU-CP 62012 takes over all processes from the gNB-CU-CP 62011, the gNB-DU 6101 may determine that the gNB-CU-CP 62011 has failed.

2-2. The gNB-CU-UP 62021 detects that the gNB-CU-CP 62011 has failed based on one or combination of the following monitored events at the gNB-CU-UP 62021.
Based on the SCTP layer between the gNB-CU-UP 62021 and the gNB-CU-CP 62011 as defined in NPL 7, a sanity of the gNB-CU-CP 62011 can be monitored. The SCTP, as defined in NPL 5, provides the heartbeat mechanism between peer ends. If the gNB-CU-UP 62021 does not receive the Heartbeat Acknowledgement chunk as a reply to the Heartbeat Request Chunk for pre-determined period from the gNB-CU-CP 62011, the gNB-CU-UP 62021 may determine that the gNB-CU-CP 62011 has failed.
In case that the gNB-CU-UP 62021 receives Abort Association chunk, Shutdown Association chunk, Operation Error chunk or another erroneous chunks, as defined in NPL 5, from the gNB-CU-CP 62011, the gNB-CU-UP 62021 may determine that the gNB-CU-CP 62011 has failed.
In case that the gNB-CU-UP 62021 receives E1 RELEASE REQUEST message, RESET message, GNB-CU-UP E1 SETUP FAILURE message, GNB-CU-CP E1 SETUP FAILURE message, RESOURCE STATUS FAILURE message or another existing message as defined in NPL 8 or new erroneous E1AP message over the E1 interface, the gNB-CU-UP 62021 may determine that the gNB-CU-CP 62011 has failed.
In case that the gNB-CU-UP 62021 receives, from the gNB-CU-CP 62012, an E1AP message indicating that the gNB-CU-CP 62011 has failed and the gNB-CU-CP 62012 takes over all processes from the gNB-CU-CP 62011, the gNB-CU-UP 62021 may determine that the gNB-CU-CP 62011 has failed.

2-3. The AMF 70 detects that the gNB-CU-CP 62011 has failed based on one or combination of the following monitored events at the AMF 70.
Based on the SCTP layer between the AMF 70 and the gNB-CU-CP 62011 as defined in NPL 9, a sanity of the gNB-CU-CP 62011 can be monitored. The SCTP, as defined in NPL 5, provides the heartbeat mechanism between peer ends. If the AMF 70 does not receive the Heartbeat Acknowledgement chunk as a reply to the Heartbeat Request Chunk for pre-determined period from the gNB-CU-CP 62011, the AMF 70 may determine that the gNB-CU-CP 62011 has failed.
In case that the AMF 70 receives Abort Association chunk, Shutdown Association chunk, Operation Error chunk or another erroneous chunks, as defined in NPL 5, from the gNB-CU-CP 62011, the AMF 70 may determine that the gNB-CU-CP 62011 has failed.
In case that the AMF 70 receives NG RESET message, ERROR INDICATION message, OVERLOAD START message or another existing NGAP message as defined in NPL 10 or new erroneous message over the NG interface, the AMF 70 may determine that the gNB-CU-CP 62011 has failed.
In case that the AMF 70 receives, from the gNB-CU-CP 62012, an NGAP message indicating that the gNB-CU-CP 62011 has failed and the gNB-CU-CP 62012 takes over all processes from the gNB-CU-CP 62011, the AMF 70 may determine that the gNB-CU-CP 62011 has failed.

2-4. The gNB-CU-CP 62013 detects that the gNB-CU-CP 62011 has failed based on one or combination of the following monitored events at the gNB-CU-CP 62013.
Based on the STCP layer between the gNB-CU-CP 62013 and the gNB-CU-CP 62011 as defined in NPL 11, a sanity of the gNB-CU-CP 62011 can be monitored. The STCP, as defined in NPL 5, provides the heartbeat mechanism between peer ends. If the gNB-CU-UP 62013 does not receive the Heartbeat Acknowledgement chunk as a reply to the Heartbeat Request Chunk for pre-determined period from the gNB-CU-CP 62011, the gNB-CU-CP 62013 may determine that the gNB-CU-CP 62011 has failed.
In case that the gNB-CU-CP 62013 receives Abort Association chunk, Shutdown Association chunk, Operation Error chunk or another erroneous chunks, as defined in NPL 5, from the gNB-CU-CP 62011, the gNB-CU-CP 62013 may determine that the gNB-CU-CP 62011 has failed.
In case that the gNB-CU-CP 62013 receives XN SETUP FAILURE message, NG-RAN NODE CONFIGURATION UPDATE FAILURE message, RESET REQUEST message, ERROR INDICATION message, XN REMOVAL REQUEST message, RESOURCE STATUS FAILURE message or another existing XnAP message as defined in NPL 12 or new erroneous message over the Xn interface, the gNB-CU-CP 62013 may determine that the gNB-CU-CP 62011 has failed.
In case that the gNB-CU-CP 62013 receives, from the gNB-CU-CP 62012, an XnAP message indicating that the gNB-CU-CP 62011 has failed and the gNB-CU-CP 62012 takes over all processes from the gNB-CU-CP 62011, the gNB-CU-CP 62013 may determine that the gNB-CU-CP 62011 has failed.

3-1. If the gNB-DU 6101 determined that the gNB-CU-CP 62011 has failed based on the decision in step 2-1, the gNB-DU 6101 sends all F1AP messages to the gNB-CU-CP 62012, as a backup of gNB-CU-CP 62011, if the messages are destined to the gNB-CU-CP 62011. For example, the gNB-DU 6101 can know the gNB-CU-CP 62012 as the backup gNB-CU-CP for the gNB-CU-CP 62011 based on the processes in FIG. 4, and the gNB-DU 6101 may select the gNB-CU-CP 62012 as a backup of gNB-CU-CP 62011 and may send the F1AP messages to the gNB-CU-CP 62012. Note that UE contexts including gNB-CU UE F1AP ID, C-RNTI, gNB-CU UE F1AP ID for the gNB-CU-CP 62011 can be used with the gNB-CU-CP 62012 as they are backed up in step 0. If the gNB-DU 6101 receives an F1AP message from the gNB-CU-CP 62012, the gNB-DU 6101 may treat it as it is received from the gNB-CU-CP 62011. If the gNB-DU 6101 receives an F1AP message from the gNB-CU-CP 62011 after the step 2-1, the gNB-DU 6101 may treat it as it is received from the gNB-CU-CP 62011.

3-2. If the gNB-CU-UP 62021 determined that the gNB-CU-CP 62011 has failed based on the decision in step 2-2, the gNB-CU-UP 62021 sends all E1AP messages to the gNB-CU-CP 62012, as a backup of gNB-CU-CP 62011, if the messages are destined to the gNB-CU-CP 62011. For example, the gNB-CU-UP 62021 can know the gNB-CU-CP 62012 as the backup gNB-CU-CP for the gNB-CU-CP 62011 based on the processes in FIG. 6 or FIG. 7, and the gNB-CU-UP 62021 may select the gNB-CU-CP 62012 as a backup of gNB-CU-CP 62011 and may send the E1AP messages to the gNB-CU-CP 62012. Note that DRB related data for the UE including gNB-CU-CP UE E1AP ID, DRB Setup List, PDU Session Resource Setup List for the gNB-CU-CP 62011 can be used with the gNB-CU-CP 62012 as they are backed up in step 0. If the gNB-CU-UP 62021 receives an E1AP message from the gNB-CU-CP 62012, the gNB-CU-UP 62021 may treat it as it is received from the gNB-CU-CP 62011. If the gNB-CU-UP 62021 receives an E1AP message from the gNB-CU-CP 62011 after the step 2-2, the gNB-CU-UP 62021 may treat it as it is received from the gNB-CU-CP 62011.

3-3. If the AMF 70 determined that the gNB-CU-CP 62011 has failed based on the decision in step 2-3, the AMF 70 sends all NGAP messages to the gNB-CU-CP 62012, as a backup of gNB-CU-CP 62011, if the messages are destined to the gNB-CU-CP 62011. For example, the AMF 70 can know the gNB-CU-CP 62012 as the backup gNB-CU-CP for the gNB-CU-CP 62011 based on the processes in FIG. 5, and the AMF 70 may select the gNB-CU-CP 62012 as a backup of gNB-CU-CP 62011 and may send the NGAP messages to the gNB-CU-CP 62012. Note that UE contexts including RAN UE NGAP ID, PDU Session Resource Setup Response List for the gNB-CU-CP 62011 can be used with the gNB-CU-CP 62012 as they are backed up in step 0. If the AMF 70 receives an NGAP message from the gNB-CU-CP 62012, the AMF 70 may treat it as it is received from the gNB-CU-CP 62011. If the AMF 70 receives an NGAP message from the gNB-CU-CP 62011 after the step 2-3, the AMF 70 may treat it as it is received from the gNB-CU-CP 62011.

3-4. If the gNB-CU-CP 62013 determined that the gNB-CU-CP 62011 has failed based on the decision in step 2-4, the gNB-CU-CP 62013 sends all XnAP messages to the gNB-CU-CP 62012, as a backup of gNB-CU-CP 62011, if the messages are destined to the gNB-CU-CP 62011. For example, the gNB-CU-CP 62013 can know the gNB-CU-CP 62012 as the backup gNB-CU-CP for the gNB-CU-CP 62011 based on the process in FIG. 8, and the gNB-CU-CP 62013 may select the gNB-CU-CP 62012 as a backup of gNB-CU-CP 62011 and may send the XnAP messages to the gNB-CU-CP 62012. If the gNB-CU-CP 62013 receives an XnAP message from the gNB-CU-CP 62012, the gNB-CU-CP 62013 may treat it as it is received from the gNB-CU-CP 62011. If the gNB-CU-CP 62013 receives an XnAP message from the gNB-CU-CP 62011 after the step 2-4, the gNB-CU-CP 62013 may treat it as it is received from the gNB-CU-CP 62011.

<First Variant of Aspect 2: Graceful gNB-CU CP Removal>

In case that the gNB-CU-CP 62011 detects its partial failure in the gNB-CU-CP 62011 or the gNB-CU-CP 62011 plans to be out-of-service, the gNB-CU-CP 62011 can indicate a planned out-of-service to connected nodes. It can be done by the following modifications to the FIG. 9.
The step 1 is replaced with the gNB-CU-CP 62011 partial failure, the gNB-CU-CP 62011 partial congestion or the gNB-CU-CP 62011 planned removal. It means that the gNB-CU-CP 62011 can serve as the gNB-CU-CP at this moment but plans to close the service. One example of the plan to close the service is a plan that system reset is performed soon.
The step 2-1 is replaced with the ERROR INDICATION message from the gNB-CU-CP 62011 to the gNB-DU 6101 including new cause value and time information for closure of service. The new cause value indicates that the gNB-CU-CP 62011 is going to close the service. The time information indicates a remaining time to close the service. The time information can be absolute time or a remaining time period to close of the service. Once the gNB-DU 6101 receives the ERROR INDICATION message, the gNB-DU 6101 performs the step 3-1. The time information may be used by the gNB-DU 6101 for internal process. For example, the gNB-DU 6101 stops contacting to the gNB-CU-CP 62011 after the indicated time by the time information elapsed. The GNB-CU CONFIGURATION UPDATE message, new F1AP message or existing F1AP message may be used instead of the ERROR INDICATION message in step 2-1.
The step 2-2 is replaced with the ERROR INDICATION message from the gNB-CU-CP 62011 to the gNB-CU-UP 62021 including new cause value and time information for closure of service. The new cause value indicates that the gNB-CU-CP 62011 is going to close the service. The time information indicates a remaining time to close the service. The time information can be absolute time or a remaining time period to close of the service. Once the gNB-CU-UP 62021 receives the ERROR INDICATION message, the gNB-CU-UP 62021 performs the step 3-2. The time information may be used by the gNB-CU-UP 62021 for internal process. For example, the gNB-CU-UP 62021 stops contacting to the gNB-CU-CP 62011 after the indicated time by the time information elapsed. The GNB-CU-CP CONFIGURATION UPDATE message, new E1AP message or existing E1AP message may be used instead of the ERROR INDICATION message in step 2-2.
The step 2-3 is replaced with the ERROR INDICATION message from the gNB-CU-CP 62011 to the AMF 70 including new cause value and time information for closure of service. The new cause indicates that the gNB-CU-CP 62011 is going to close the service. The time information indicates a remaining time to close the service. The time information can be absolute time or a remaining time period to close of the service. Once the AMF 70 receives the ERROR INDICATION message, the AMF 70 performs the step 3-3. The time information may be used by the AMF 70 for internal process. For example, the AMF 70 stops contacting to the gNB-CU-CP 62011 after the indicated time by the time information elapsed. The RAN CONFIGURATION UPDATE message, new NGAP message or existing NGAP message may be used instead of the ERROR INDICATION message in step 2-3.
The step 2-4 is replaced with the ERROR INDICATION message from the gNB-CU-CP 62011 to the gNB-CU-CP 62013 including new cause value and time information for closure of service. The new cause indicates that the gNB-CU-CP 62011 is going to close the service. The time information indicates a remaining time to close the service. The time information can be absolute time or a remaining time period to close of the service. Once the gNB-CU-CP 62013 receives the ERROR INDICATION message, the gNB-CU-CP 62013 performs the step 3-4. The time information may be used by the gNB-CU-CP 62013 for internal process. For example, the gNB-CU-CP 62013 stops contacting to the gNB-CU-CP 62011 after the indicated time by the time information elapsed. The NG-RAN NODE CONFIGURATION UPDATE message, new XnAP message or existing XnAP message may be used instead of the ERROR INDICATION message in step 2-4.

### <Second Variant of Aspect 2: Handover Due to Out-of-Service>

In case that the gNB-CU-CP 62011 detects its partial failure in the gNB-CU-CP 62011 or the gNB-CU-CP 62011 plans to be out-of-service, the gNB-CU-CP 62011 performs the inter gNB-CU-CP handover. It can be done by the following modifications to the FIG. 9.
The step 1 is replaced with the gNB-CU-CP 62011 partial failure, the gNB-CU-CP 62011 partial congestion or the gNB-CU-CP 62011 planned removal. It means that the gNB-CU-CP 62011 can serve as the gNB-CU-CP at this moment but plans to close the service. One example of the plan to close the service is a plan that system reset is performed soon.
Instead of steps 2-1, 2-2, 2-3 and 2-4, the gNB-CU-CP 62011 performs the Inter-gNB handover procedure as described in NPL 18 for all PDU sessions in the gNB-CU-CP 62011.
Steps 3-1, 3-2, 3-3 and 3-4 do not take place.
   <Switchover Mechanism with the UDSF Backup Scheme>

In case that a gNB-CU-CP fails, all existing processes in the failed gNB-CU-CP are switched over to another gNB-CU-CP in the gNB-CU-CP set.

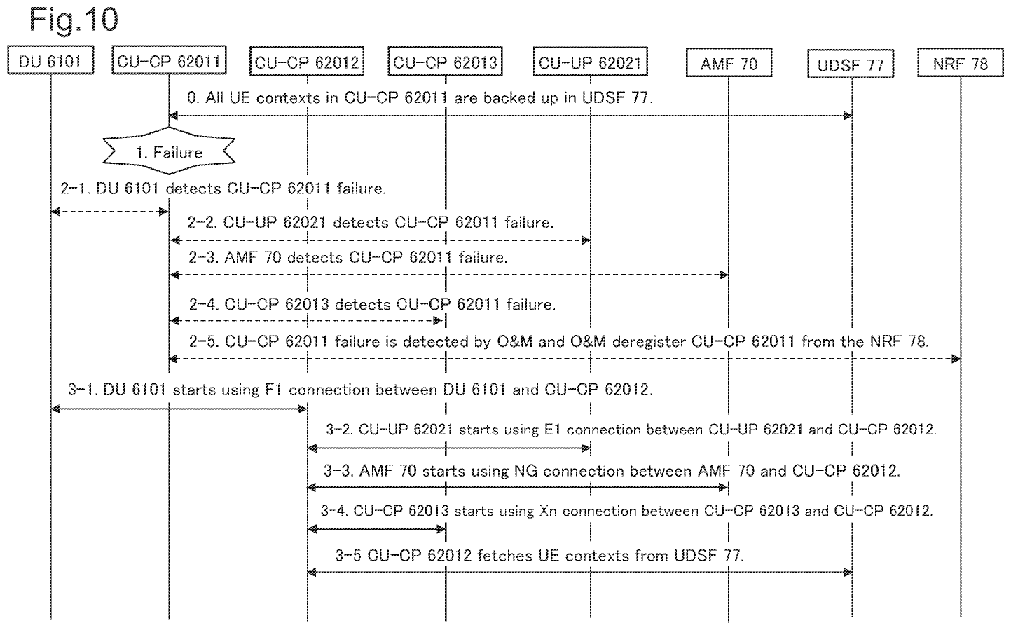

The FIG. 10 illustrates the switchover procedure with the UDSF backup scheme when the gNB-CU-CP fails.

The detailed processes of the switchover procedure with the UDSF backup scheme are described as below.

0. All UE context(s) to handle the UE in both RRC INACTIVE state and RRC_CONNECTED state in the gNB-CU-CP 62011 are constantly backed up in the UDSF 77 by implementation specific technology. For example, the UE context(s) in the original gNB-CU-CP 62011 are mirrored to the UDSF 77 by low layer technology or UE context(s) are copied to the UDSF 77 upon completion of an ongoing transaction in the gNB-CU-CP 62011. In addition, other data, for example system information related data, in the gNB-CU-CP 62011 may also be backed up in the UDSF 77. For example, the UE context(s) in the original gNB-CU-CP 62011 are mirrored or copied to the UDSF 77 when a predetermined condition is met. For example, the UE context(s) in the original gNB-CU-CP 62011 are mirrored or copied to the UDSF 77 periodically or the mirroring or coping is performed by the gNB-CU-CP 62011 based on local configuration in the gNB-CU-CP 62011.

1. The gNB-CU-CP 62011 fails. The failure in gNB-CU-CP 62011 includes unexpected system reset, system rebooting, system stall, system congestion and communication failure with neighboring nodes.

2-1. The gNB-DU 6101 detects that the gNB-CU-CP 62011 has failed. How the gNB-DU 6101 detects the gNB-CU-CP 62011 failure is similar to step 2-1 in FIG. 9.

2-2. The gNB-CU-UP 62021 detects that the gNB-CU-CP 62011 has failed. How the gNB-CU-UP 62021 detects the gNB-CU-CP 62011 failure is similar to step 2-2 in FIG. 9.

2-3. The AMF 70 detects that the gNB-CU-CP 62011 has failed. How the AMF 70 detects the gNB-CU-CP 62011 failure is similar to step 2-3 in FIG. 9.

2-4. The gNB-CU-CP 62013 detects that the gNB-CU-CP 62011 has failed. How the gNB-CU-CP 62013 detects the gNB-CU-CP 62011 failure is similar to step 2-4 in FIG. 9.

2-5. The gNB-CU-CP 62011 failure is detected by an O&M system and the O&M system contacts to the NRF 78 to deregister the entry of gNB-CU-CP 62011. In one example, the O&M system detects the gNB-CU-CP 62011 failure by monitoring the IP connectivity (e.g. Internet Protocol connectivity) with the gNB-CU-CP 62011. For example, if the O&M system detects a loss of the IP connectivity with the gNB-CU-CP 62011 by using the ICMP as defined in NPL 19, the O&M system may conclude that the gNB-CU-CP 62011 has failed.

The O&M system may indicate the NRF 78 that this de-registration is due to gNB-CU-CP failure. With this de-registration, the failed gNB-CU-CP 62011 is not chosen for a request from other NF (Network Function). The NRF 78 may notify the subscribed NFs that gNB-CU-CP 62011 has failed so that subscribed NFs can take an appropriate action.

For example, if gNB-DU 6101, gNB-CU-UP 62021, AMF 70 and gNB-CU-CP 62013 has subscribed to the NRF 78 for notifying the gNB-CU-CP 62011 failure, the notification of gNB-CU-CP 62011 failure can be used for gNB-CU-CP 62011 failure detection instead of step 2-1, step 2-2, step 2-3 and step 2-4 respectively.

3-1. If the gNB-DU 6101 determined that the gNB-CU-CP 62011 has failed based on the decision in step 2-1 or based on the notification of gNB-CU-CP 62011 failure in step 2-5, the gNB-DU 6101 sends all F1AP messages to the gNB-CU-CP 62012, as the gNB-CU-CP 62012 has the same gNB-CU-CP set with the failed gNB-CU-CP 62011, if the messages are destined to the gNB-CU-CP 62011. In this case, for example, the gNB-CU-CP 62011 and the gNB-CU-CP 62012 are included in the same gNB-CU-CP set. For example, in a case where the gNB-DU 6101 received the F1 SETUP RESPONSE message including the gNB-CU-CP set based on the processes in the FIG. 4 and the gNB-DU 6101 determined that the gNB-CU-CP 62011 has failed, the gNB-DU 6101 may select the gNB-CU-CP 62012 as the backup g-NB-CU-CP from the gNB-CU-CP set, may send the F1AP messages to the gNB-CU-CP 62012.

If the gNB-DU 6101 receives an F1AP message from the gNB-CU-CP 62012, the gNB-DU 6101 may treat it as it is received from the gNB-CU-CP 62011. If the gNB-DU 6101 receives an F1AP message from the gNB-CU-CP 62011 after the step 2-1, the gNB-DU 6101 may treat it as it is received from the gNB-CU-CP 62011.

In one example, the gNB-DU 6101 chooses arbitrary gNB-CU-CP out of the gNB-CU-CPs that shares the same gNB-CU-CP set with the failed gNB-CU-CP 62011.

In another example, the gNB-DU 6101 chooses less busy gNB-CU-CP out of the gNB-CU-CPs that shares the same gNB-CU-CP set with the failed gNB-CU-CP 62011 if weight factor information for gNB-CU-CPs are available in the gNB-DU 6101.

3-2. If the gNB-CU-UP 62021 determined that the gNB-CU-CP 62011 has failed based on the decision in step 2-2 or based on the notification of gNB-CU-CP 62011 failure in step 2-5, the gNB-CU-UP 62021 sends all E1AP messages to the gNB-CU-CP 62012, as the gNB-CU-CP 62012 has the same gNB-CU-CP set with the failed gNB-CU-CP 62011, if the messages are destined to the gNB-CU-CP 62011. In this case, for example, the gNB-CU-CP 62011 and the gNB-CU-CP 62012 are included in the same gNB-CU-CP set. For example, in a case where the gNB-CU-UP 62021 received the GNB-CU-UP E1 SETUP RESPONSE message including the gNB-CU-CP set based on the processes in the FIG. 6 and the gNB-CU-UP 62021 determined that the gNB-CU-CP 62011 has failed, the gNB-CU-UP 62021 may select the gNB-CU-CP 62012 as the backup g-NB-CU-CP from the gNB-CU-CP set, and may send the E1AP messages to the gNB-CU-CP 62012. For example, in a case where the gNB-CU-UP 62021 received the GNB-CU-CP E1 SETUP REQUEST message including the gNB-CU-CP set based on the processes in the FIG. 7 and the gNB-CU-UP 62021 determined that the gNB-CU-CP 62011 has failed, the gNB-CU-UP 62021 may select the gNB-CU-CP 62012 as the backup g-NB-CU-CP from the gNB-CU-CP set, and may send the E1AP messages to the gNB-CU-CP 62012.

If the gNB-CU-UP 62021 receives an E1AP message from the gNB-CU-CP 62012, the gNB-CU-UP 62021 may treat it as it is received from the gNB-CU-CP 62011. If the gNB-CU-UP 62021 receives an E1AP message from the gNB-CU-CP 62011 after the step 2-2, the gNB-CU-UP 62021 may treat it as it is received from the gNB-CU-CP 62011.

In one example, the gNB-CU-UP 62021 chooses arbitrary gNB-CU-CP out of the gNB-CU-CPs that shares the same gNB-CU-CP set with the failed gNB-CU-CP 62011.

In another example, the gNB-CU-UP 62021 chooses less busy gNB-CU-CP out of the gNB-CU-CPs that shares the same gNB-CU-CP set with the failed gNB-CU-CP 62011 if weight factor information for gNB-CU-CPs are available in the gNB-CU-UP 62021.

3-3. If the AMF 70 determined that the gNB-CU-CP 62011 has failed based on the decision in step 2-3 or based on the notification of gNB-CU-CP 62011 failure in step 2-5, the AMF 70 sends all NGAP messages to the gNB-CU-CP 62012, as the gNB-CU-CP 62012 has the same gNB-CU-CP set with the failed gNB-CU-CP 62011, if the messages are destined to the gNB-CU-CP 62011. In this case, for example, the gNB-CU-CP 62011 and the gNB-CU-CP 62012 are included in the same gNB-CU-CP set. For example, in a case where the AMF 70 received the NG SETUP REQUEST message including the RAN Node set based on the processes in the FIG. 5 and the AMF 70 determined that the gNB-CU-CP 62011 has failed, the AMF 70 may select the gNB-CU-CP 62012 as the backup g-NB-CU-CP from the RAN Node set, and may send the NGAP messages to the gNB-CU-CP 62012. In this case, for example, the gNB-CU-CP 62011 and the gNB-CU-CP 62012 are included in the same RAN Node set.

If the AMF 70 receives an NGAP message from the gNB-CU-CP 62012, the AMF 70 may treat it as it is received from the gNB-CU-CP 62011. If the AMF 70 receives an NGAP message from the gNB-CU-CP 62011 after the step 2-3, the AMF 70 may treat it as it is received from the gNB-CU-CP 62011.

In one example, the AMF 70 chooses arbitrary gNB-CU-CP out of the gNB-CU-CPs that shares the same gNB-CU-CP set with the failed gNB-CU-CP 62011. For example, the AMF 70 chooses arbitrary gNB-CU-CP out of the gNB-CU-CPs that shares the same RAN Node set with the failed gNB-CU-CP 62011.

In another example, the AMF 70 chooses less busy gNB-CU-CP out of the gNB-CU-CPs that shares the same gNB-CU-CP set with the failed gNB-CU-CP 62011 if weight factor information for gNB-CU-CPs are available in the AMF 70. For example, the AMF 70 chooses less busy gNB-CU-CP out of the gNB-CU-CPs that shares the same RAN Node set with the failed gNB-CU-CP 62011 if weight factor information for gNB-CU-CPs are available in the AMF 70.

3-4. If the gNB-CU-CP 62013 determined that the gNB-CU-CP 62011 has failed based on the decision in step 2-4 or based on the notification of gNB-CU-CP 62011 failure in step 2-5, the gNB-CU-CP 62013 sends all XnAP messages to the gNB-CU-CP 62012, as the gNB-CU-CP 62012 has the same gNB-CU-CP set with the failed gNB-CU-CP 62011, if the messages are destined to the gNB-CU-CP 62011. In this case, for example, the gNB-CU-CP 62011 and the gNB-CU-CP 62012 are included in the same gNB-CU-CP set. For example, in a case where the gNB-CU-CP 62013 received, from the gNB-CU-CP 62011, the XN SETUP REQUEST message including the gNB-CU-CP set based on the processes in the FIG. 8 and the gNB-CU-CP 62013 determined that the gNB-CU-CP 62011 has failed, the gNB-CU-CP 62013 may select the gNB-CU-CP 62012 as the backup g-NB-CU-CP from the gNB-CU-CP set, and may send the XnAP messages to the gNB-CU-CP 62012.

If the gNB-CU-CP 62013 receives an XnAP message from the gNB-CU-CP 62012, the gNB-CU-CP 62013 may treat it as it is received from the gNB-CU-CP 62011. If the gNB-CU-CP 62013 receives an XnAP message from the gNB-CU-CP 62011 after the step 2-4, the gNB-CU-CP 62013 may treat it as it is received from the gNB-CU-CP 62011.

In one example, the gNB-CU-CP 62013 chooses arbitrary gNB-CU-CP out of the gNB-CU-CPs that shares the same gNB-CU-CP set with the failed gNB-CU-CP 62011.

In another example, the gNB-CU-CP 62013 chooses less busy gNB-CU-CP out of the gNB-CU-CPs that shares the same gNB-CU-CP set with the failed gNB-CU-CP 62011 if weight factor information for gNB-CU-CPs are available in the gNB-CU-CP 62013.

3-5. If the gNB-CU-CP 62012 needs some information, for example UE context, to process signals from gNB-DU 6101, gNB-CU-UP 62021, AMF 70 and gNB-CU-CP 62013 over F1, E1, N2 and Xn interface respectively, the gNB-CU-CP 62012 downloads necessary information, for example UE context, from the UDSF 77.

In one example, associated gNB-DU 6101, associated gNB-CU-UP 62021, associated AMF 70 and associated gNB-CU-CP 62013 may choose totally different gNB-CU-CP each other within the same gNB-CU-CP set.

<First Variant of Aspect 2: Graceful gNB-CU CP Removal>

In case that the gNB-CU-CP 62011 detects its partial failure in the gNB-CU-CP 62011 or the gNB-CU-CP 62011 plans to be out-of-service, the gNB-CU-CP 62011 can indicate a planned out-of-service to connected nodes. It can be done by the following modifications to the FIG. 10.
The step 1 is replaced with the gNB-CU-CP 62011 partial failure, the gNB-CU-CP 62011 partial congestion or the gNB-CU-CP 62011 planned removal. It means that the gNB-CU-CP 62011 can serve as the gNB-CU-CP at this moment but plans to close the service. One example of the plan to close the service is a plan that system reset is performed soon.
The step 2-1 is replaced with the ERROR INDICATION message from the gNB-CU-CP 62011 to gNB-DU 6101 including new cause value and time information for closure of service. The new cause value indicates that the gNB-CU-CP 62011 is going to close the service. The time information indicates a remaining time to close the service. The time information can be absolute time or a remaining time period to close of the service. Once the gNB-DU 6101 receives the ERROR INDICATION message, the gNB-DU 6101 performs the step 3-1. The time information may be used by the gNB-DU 6101 for internal process. For example, the gNB-DU 6101 stops contacting to the gNB-CU-CP 62011 after the indicated time by the time information elapsed. The GNB-CU CONFIGURATION UPDATE message, new F1AP message or existing F1AP message may be used instead of the ERROR INDICATION message in step 2-1.
The step 2-2 is replaced with the ERROR INDICATION message from the gNB-CU-CP 62011 to gNB-CU-UP 62021 including new cause value and time information for closure of service. The new cause value indicates that the gNB-CU-CP 62011 is going to close the service. The time information indicates a remaining time to close the service. The time information can be absolute time or a remaining time period to close of the service. Once the gNB-CU-UP 62021 receives the ERROR INDICATION message, the gNB-CU-UP 62021 performs the step 3-2. The time information may be used by the gNB-CU-UP 62021 for internal process. For example, the gNB-CU-UP 62021 stops contacting to the gNB-CU-CP 62011 after the indicated time by the time information elapsed. The GNB-CU-CP CONFIGURATION UPDATE message, new E1AP message or existing E1AP message may be used instead of the ERROR INDICATION message in step 2-2.
The step 2-3 is replaced with the ERROR INDICATION message from the gNB-CU-CP 62011 to the AMF 70 including new cause value and time information for closure of service. The new cause indicates that the gNB-CU-CP 62011 is going to close the service. The time information indicates a remaining time to close the service. The time information can be absolute time or a remaining time period to close of the service. Once the AMF 70 receives the ERROR INDICATION message, the AMF 70 performs the step 3-3. The time information may be used by the AMF for internal process. For example, the AMF 70 stops contacting to the gNB-CU-CP 62011 after the indicated time by the time information elapsed. The RAN CONFIGURATION UPDATE message, new NGAP message or existing NGAP message may be used instead of the ERROR INDICATION message in step 2-3.
The step 2-4 is replaced with the ERROR INDICATION message from the gNB-CU-CP 62011 to the gNB-CU-CP 62013 including new cause value and time information for closure of service. The new cause indicates that the gNB-CU-CP 62011 is going to close the service. The time information indicates a remaining time to close the service. The time information can be absolute time or a remaining time period to close of the service. Once the gNB-CU-CP 62013 receives the ERROR INDICATION message, the gNB-CU-CP 62013 performs the step 3-4. The time information may be used by the gNB-CU-CP 62013 for internal process. For example, the gNB-CU-CP 62013 stops contacting to the gNB-CU-CP 62011 after the indicated time by the time information elapsed. The NG-RAN NODE CONFIGURATION UPDATE message, new XnAP message or existing XnAP message may be used instead of the ERROR INDICATION message in step 2-4.
The step 2-5 is replaced with the de-registration message from the gNB-CU-CP 62011 to the NRF 78 indicating that this is de-registration due to gNB-CU-CP failure. Or the step 2-5 is replaced with the error indication message from the gNB-CU-CP 62011 to the O&M system and the O&M system sends, to the NRF 78, the de-registration message indicating that this is de-registration due to gNB-CU-CP failure. With this de-registration, the failed gNB-CU-CP 62011 is not chosen by the NRF 78 for a request from other NF (Network Function). The NRF 78 may notify the subscribed NFs that gNB-CU-CP 62011 has failed so that subscribed NFs can take an appropriate action.

### <Second Variant of Aspect 2: Distributed Resource Operation>

Although FIG. 10 takes an assumption that the gNB-CU-CP 62012 is chosen as replacement of the failed gNB-CU-CP 62011, the architecture as disclosed by the FIG. 3 has a potential capability to distribute Interface resource and processing resource in the gNB-CU-CP to any of gNB-CU-CPs within the same gNB-CU-CP set.

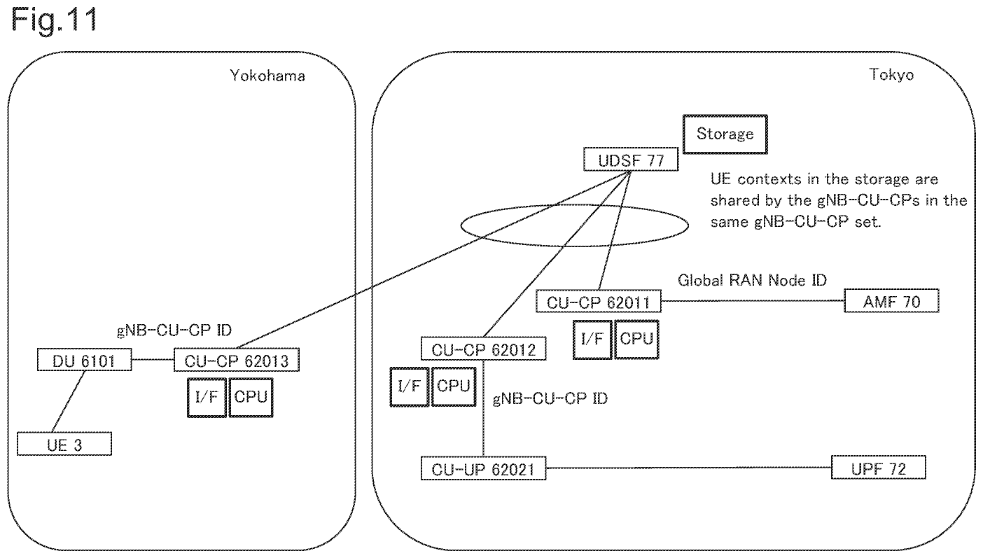

The FIG. 11 illustrates a deployment example for resource distributed operation. In this example, Interface resource and processing resource are distributed to each gNB-CU-CP per 3GPP defined interface basis. Any F1AP message with the gNB-CU-CP ID from the gNB-DU is routed to the gNB-CU-CP 62013 and that message is received by an NIC, Network Interface Card, as the interface resource in the gNB-CU-CP 62013 and processed by the CPU, Central Processing Unit, as the processing resource in the gNB-CU-CP 62013. Similarly, any NGAP message with the global RAN Node ID from the AMF 70 is routed to the gNB-CU-CP 62011 and that message is received by a NIC in the gNB-CU-CP 62011 and processed by the CPU in the gNB-CU-CP 62011. Similarly, any E1AP message with the gNB-CU-CP ID from the gNB-CU-UP 62021 is routed to the gNB-CU-CP 62012 and that message is received by a NIC in the gNB-CU-CP 62012 and processed by the CPU in the gNB-CU-CP 62012. Since the gNB-CU-CP 62011, the gNB-CU-CP 62012 and the gNB-CU-CP 62013 share the same UE context in the UDSF 77, the combination of the gNB-CU-CP 62011, the gNB-CU-CP 62012 and the gNB-CU-CP 62013 can be seen as one gNB-CU-CP from interworking nodes around the gNB-CU-CP.

In addition, the FIG. 11 also shows a possible deployment scenario where the gNB-CU-CP 62013 takes care of DUs in one place (e.g. Yokohama) while the associated UDSF 77 is located in another place (e.g. Tokyo). This example demonstrates that as far as the gNB-CU-CP can communicate with the same UDSF 77, the gNB-CU-CPs in the same gNB-CU-CP set can span any geographical locations. In one aspect, this deployment scenario is beneficial in case that the gNB-CU-CP 62013 in Yokohama failed, for example due to earthquake in Yokohama area, the eNB-DUs in Yokohama may continue servicing by re-connecting to any of gNB-CU-CPs in Tokyo based on the switchover procedure as disclosed by FIG. 10. This can be considered as a reliable resiliency against natural disasters that might happen in a specific region.

At least one of the aspect 1, the aspect 2 and the variants of the aspect 2 propose solutions for providing a resiliency of gNB-CU-Control Plane against possible node failures. For example, at least one of the aspect 1, the aspect 2 and the variants of the aspect 2 can solve a problem that all gNB-DUs enter out of service state in a case where the connected gNB-CU-CP fails and can solve a problem of a major service disruption to all users who are under the gNB-DU coverages if the connected gNB-CU fails. For example, according to the aspect 1, the aspect 2 and the variants of the aspect 2, in a case where the gNB-CU-CP fails, the backup (or alternative) gNB-CU-CP takes over a role for communicating other network nodes (e.g. the gNB-DU, another gNB-CU-CP, the gNB-CU-UP and the AMF) instead of the failed gNB-CU-CP, hence, at least one of the aspect 1, the aspect 2 and the variants of the aspect 2 can solve a problem that all gNB-DUs enter out of service state in a case where the connected gNB-CU-CP fails and can solve a problem of a major service disruption to all users who are under the gNB-DU coverages if the connected gNB-CU fails.

### <Aspect 3: General>

The gNB-CU-UP failure recovery mechanism is disclosed.

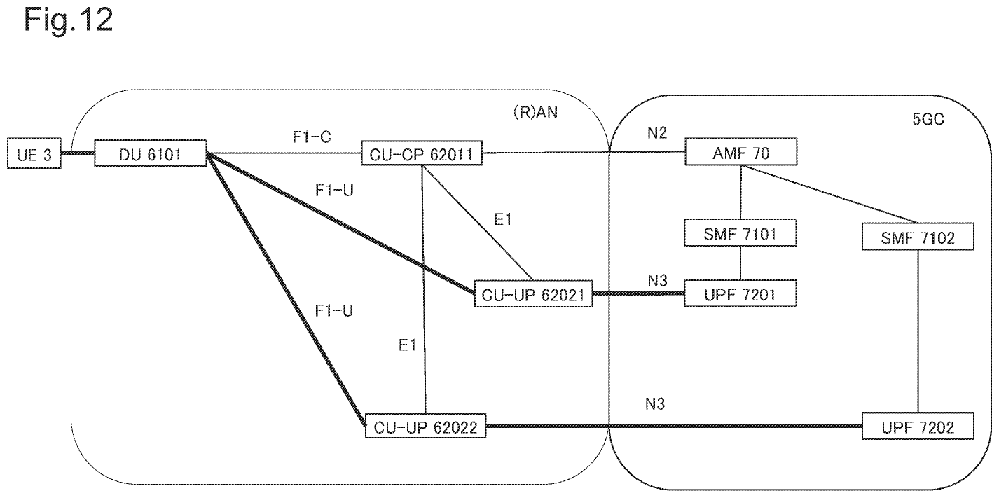

The FIG. 12 illustrates the NG-(R)AN architecture which proposes some gNB-CU-UP failure recovery mechanisms when the gNB-CU-UP fails.

<gNB-CU-UP Failure Recovery by Releasing RRC Connection>

A solution for recovering mechanism against the gNB-CU-UP failure by releasing the RRC connections is disclosed.

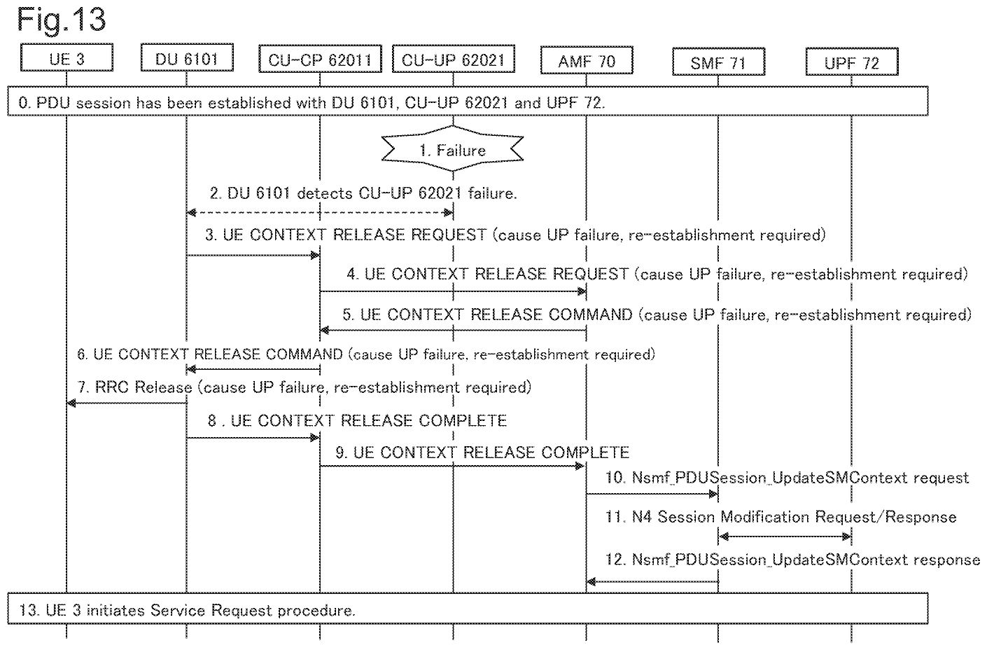

The FIG. 13 illustrates the handling of the gNB-CU-UP failure in AS layer by releasing the RRC connection.

The detailed processes of procedure are described as below.

0. A UE 3 has at least one established PDU session and a Data Radio Bearer (DRB) is established for the PDU session. The gNB-DU 6101, gNB-CU-UP 62021 and UPF 72 are used for user data handling for the PDU session.

1. The gNB-CU-UP 62021 fails. The failure in gNB-CU-UP 62021 includes unexpected system reset, system rebooting, system stall, recovering after rebooting, system congestion and communication failure with neighboring nodes.

2. The gNB-DU 6101 detects that the gNB-CU-UP 62021 has failed based on one or combination of the following monitoring events at the gNB-DU 6101.
In case that the gNB-DU 6101 cannot receive the Echo response message as a reply to the Echo request message sent to the gNB-CU-UP 62021 for pre-defined period, the gNB-DU 6101 detects that the gNB-CU-UP 62021 has failed.

Note that the Path Management function, i.e. Echo request/Echo response messages, is defined in NPL 16.
In case that the gNB-DU 6101 receives the Error Indication message from the gNB-CU-UP 62021, the gNB-DU 6101 detects that the gNB-CU-UP 62021 has failed.

Note that the Tunnel Management function, i.e. Error Indication message, is defined in NPL 16.
In case that the gNB-CU-UP 62021 is not reachable in IP layer from the gNB-DU 6101, the gNB-DU 6101 detects that the gNB-CU-UP 62021 has failed.

3. Once the gNB-CU-UP 62021 failure is detected by the gNB-DU 6101, the gNB-DU 6101 sends UE CONTEXT RELEASE REQUEST message to the gNB-CU-CP 62011 as an associated gNB-CU-CP with the failed gNB-CU-UP 62021. The gNB-DU 6101 may store information indicating that the gNB-CU-CP 62011 is associated with the gNB-CU-UP 62021 and the gNB-DU 6101 may select the gNB-CU-CP 62011 as the associated gNB-CU-CP based on the information in a case where the gNB-CU-UP 62021 fails. Then the gNB-DU 6101 may send the UE CONTEXT RELEASE REQUEST message to the gNB-CU-CP 62011. The gNB-DU 6101 may obtain the information from other network nodes before the failure of the gNB-CU-UP 62021 occurs. The gNB-DU 6101 may obtain the information from the gNB-CU-CP 62011 or the gNB-CU-UP 62021 before the failure of the gNB-CU-UP 62021 occurs. The UE CONTEXT RELEASE REQUEST message includes cause parameter with a value of UP failure and re-establishment required parameter. The re-establishment required parameter indicates to the gNB-CU-CP 62011 that the RRC connection with the UE 3 needs to be re-established after the RRC release procedure. The cause parameter may have a value indicating that the gNB-CU-UP 62021 has failed. The UP failure may be interpreted as failure of the gNB-CU-UP 62021.

4. Upon reception of UE CONTEXT RELEASE REQUEST message from the gNB-DU 6101, the gNB-CU-CP 62011 sends, to the AMF 70, UE CONTEXT RELEASE REQUEST message including cause parameter with a value of UP failure and re-establishment required parameter. The re-establishment required parameter indicates to the AMF 70 that the RRC connection with the UE 3 needs to be re-established after the RRC release procedure. The UE CONTEXT RELEASE REQUEST message to the AMF 70 can be another existing NGAP message. The cause parameter may have a value indicating that the gNB-CU-UP 62021 has failed. The UP failure may be interpreted as failure of the gNB-CU-UP 62021.

5. Upon reception of UE CONTEXT RELEASE REQUEST message from the gNB-CU-CP 62011, the AMF 70 sends, to the gNB-CU-CP 62011, UE CONTEXT RELEASE COMMAND message including cause parameter with a value of UP failure and re-establishment required parameter. The re-establishment required parameter indicates to the gNB-CU-CP 62011 that the RRC connection with the UE 3 needs to be re-established after the RRC release procedure. The cause parameter may have a value indicating that the gNB-CU-UP 62021 has failed. The UP failure may be interpreted as failure of the gNB-CU-UP 62021.

6. Upon reception of UE CONTEXT RELEASE COMMAND message from the AMF 70, the gNB-CU-CP 62011 sends, to the gNB-DU 6101, UE CONTEXT RELEASE COMMAND message including cause parameter with a value of UP failure and re-establishment required parameter. The re-establishment required parameter indicates to the gNB-DU 6101 that the RRC connection with the UE 3 needs to be re-established after the RRC release procedure. The cause parameter may have a value indicating that the gNB-CU-UP 62021 has failed. The UP failure may be interpreted as failure of the gNB-CU-UP 62021.

7. Upon reception of UE CONTEXT RELEASE COMMAND message from the gNB-CU-CP 62011, the gNB-DU 6101 sends, to the UE 3, the RRC Release message including cause parameter with a value of UP failure and re-establishment required parameter. The re-establishment required parameter indicates to the UE 3 that the RRC connection needs to be re-established after the RRC release procedure. The cause parameter may have a value indicating that the gNB-CU-UP 62021 has failed. The UP failure may be interpreted as failure of the gNB-CU-UP 62021.

8. The gNB-DU 6101 sends the UE CONTEXT RELEASE COMPLETE message to the gNB-CU-CP 62011.

9. Upon reception of UE CONTEXT RELEASE COMPLETE message from the gNB-DU 6101, the gNB-CU-CP 62011 sends the UE CONTEXT RELEASE COMPLETE message to the AMF 70.

10. Upon reception of UE CONTEXT RELEASE COMPLETE message from the gNB-CU-CP 62011, the AMF 70 sends Nsmf_PDUSession_UpdateSMContext request message to the SMF 71.

11. Upon reception of Nsmf_PDUSession_UpdateSMContext request message from the AMF 70, the SMF 71 contacts to the UPF 72 for releasing N3 tunnel information in the UPF 72. The N4 Session Modification Request message may be sent from the SMF 71 to the UPF 72 for releasing N3 tunnel information in the UPF 72. The N4 Session Modification Response message may be sent from the UPF 72 to the SMF 71 in response to the N4 Session Modification Request message.

12. The SMF 71 sends Nsmf_PDUSession_UpdateSMContext response message to the AMF 70.

13. Upon reception of the RRC Release message from the gNB-DU 6101 in step 7, The UE 3 initiates the Service request procedure as defined in NPL 14 in order to re-establish necessary PDU sessions after the gNB-CU-UP 62021 failure in step 1. In addition, the UE 3 may re-establish the RRC connection in step 13.

### <First Variant of Aspect 3>

In one example, steps 6 and 7 in FIG. 13 may be performed as follows. In step 6, the gNB-CU-CP 62011 sends, to the gNB-DU 6101, RRC Release message containing a cause parameter indicating UP failure and another parameter indicating re-establishment required. In step 7, the gNB-DU 6101 sends the RRC Release message to the UE 3. This RRC Release message is sent to UE 3 either in F1 DL RRC message transfer or in the UE CONTEXT RELEASE COMMAND. The another parameter may indicate that the RRC connection with the UE 3 needs to be re-established after the RRC release procedure. The cause parameter may have a value indicating that the gNB-CU-UP 62021 has failed. The UP failure may be interpreted as failure of the gNB-CU-UP 62021.

<gNB-CU-UP Failure Recovery by Choosing Alternative gNB-CU-UP>

A solution for recovering mechanism against the gNB-CU-UP failure by choosing alternative gNB-CU-UP is disclosed.

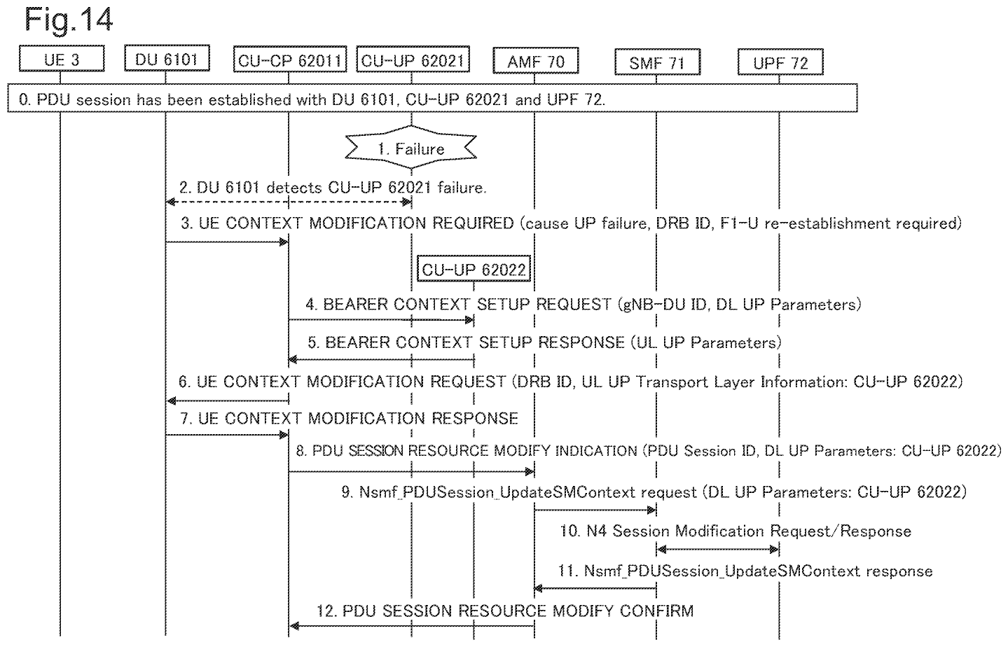

The FIG. 14 illustrates the handling of the gNB-CU-UP failure in AS layer by choosing alternative gNB-CU-UP.

The detailed processes of the procedure are described as below:

0. A UE 3 has at least one established PDU session and DRB is established for the PDU session. The gNB-DU 6101, gNB-CU-UP 62021 and UPF 72 are used for user data handling for the PDU session.

1. The gNB-CU-UP 62021 fails. The failure in gNB-CU-UP 62021 includes unexpected system reset, system rebooting, system stall, recovering after rebooting, system congestion and communication failure with neighboring nodes.

2. The gNB-DU 6101 detects that the gNB-CU-UP 62021 has failed based on one or combination of the following monitoring events at the gNB-DU 6101.
In case that the gNB-DU 6101 cannot receive the Echo response message as a reply to the Echo request message sent to the gNB-CU-UP 62021 for pre-defined period, the gNB-DU 6101 detects that the gNB-CU-UP 62021 has failed.

Note that the Path Management function, I.E. Echo request/Echo response messages, is defined in NPL 16.
In case that the gNB-DU 6101 receives the Error Indication message from the gNB-CU-UP 62021, the gNB-DU 6101 detects that the gNB-CU-UP 62021 has failed.

Note that the Tunnel Management function, I.E. Error Indication message, is defined in NPL 16.
In case that the gNB-CU-UP 62021 is not reachable in IP layer from the gNB-DU 6101, the gNB-DU 6101 detects that the gNB-CU-UP 62021 has failed.

3. Once the gNB-CU-UP 62021 failure is detected by the gNB-DU 6101, the gNB-DU 6101 sends UE CONTEXT MODIFICATION REQUIRED message to the gNB-CU-CP 62011 as an associated gNB-CU-CP with the failed gNB-CU-UP 62021. The UE CONTEXT MODIFICATION REQUIRED message includes cause parameter with a value of UP failure, DRB ID and F1-U re-establishment required parameter. The cause parameter with a value of UP failure together with the DRB ID indicate to the gNB-CU-CP 62011 that the gNB-CU-UP 62021 that is associated with DRB has been failed. The F1-U re-establishment required parameter indicates to the gNB-CU-CP 62011 that the F1-U connection for the DRB ID needs to be re-established. The DRB ID may be in the DRB Required to Be Modified Item IEs. The DRB ID may be in the DRB Required to be Released List Item IEs with an indication that this DRB needs to be established. The DRB ID may be identifier of the DRB which is established for the PDU session. The DRB ID may be identifier of the DRB which is established for the PDU session before the failure of the gNB-CU-UP 62021. The DRB ID may be identifier of the DRB which is required to be established.

The cause parameter may have a value indicating that the gNB-CU-UP 62021 has failed. The UP failure may be interpreted as failure of the gNB-CU-UP 62021.

4. Upon reception of UE CONTEXT MODIFICATION REQUIRED message from the gNB-DU 6101, the gNB-CU-CP 62011 selects gNB-CU-UP 62022 as an alternative gNB-CU-UP to be used for DRB handling. For example, the gNB-CU-CP 62011 selects gNB-CU-UP 62022 based on information indicating list of alternative gNB-CU-UPs. The information indicating list of alternative gNB-CU-UPs may be stored in the gNB-CU-CP 62011. The gNB-CU-CP 62011 may obtain information indicating list of alternative gNB-CU-UPs from other network node before the failure of the gNB-CU-UP 62021 occurs. The gNB-CU-CP 62011 may obtain information indicating list of alternative gNB-CU-UPs from the gNB-CU-UP 62021 before the failure of the gNB-CU-UP 62021 occurs.

The gNB-CU-CP 62011 sends, to the gNB-CU-UP 62022, BEARER CONTEXT SETUP REQUEST message including gNB-DU ID and DL UP Parameters. The DL UP Parameters indicates to the gNB-CU-UP 62022 that a Tunnel Endpoint Identifier (TEID) and IP address of the gNB-DU 6101 to which the gNB-CU-UP 62022 sends the DL packets to send.

In one example if F1-U re-establishment required parameter is not received in the UE CONTEXT MODIFICATION REQUIRED message, the gNB-CU-CP 62011 decides by itself based on the QoS, PDU sessions attributes to re-establish a user plane.

5. The gNB-CU-UP 62022 sends, to the gNB-CU-CP 62011, BEARER CONTEXT SETUP RESPONSE message including UL UP Parameters. The UL UP Parameters indicates to the gNB-CU-CP 62011 that a TEID and an IP address of the gNB-CU-UP 62022 to which the gNB-DU 6101 sends the UL packets to send.

6. Upon reception of BEARER CONTEXT SETUP RESPONSE message from the gNB-CU-UP 62022, the gNB-CU-CP 62011 sends, to the gNB-DU 6101, UE CONTEXT MODIFICATION REQUEST message including DRB ID and UP Transport Layer Information parameter. The UP Transport Layer Information parameter indicates to the gNB-DU 6101 that a TEID and an IP address of the gNB-CU-UP 62022 to which the gNB-DU 6101 sends the UL packets to send. The UP Transport Layer Information parameter may be called as UL UP Transport Layer Information parameter. The DRB ID may be same to the DRB ID received in step 3.

7. Upon reception of UE CONTEXT MODIFICATION REQUEST message from the gNB-CU-CP 62011, the gNB-DU 6101 sends UE CONTEXT MODIFICATION RESPONSE message to the gNB-CU-CP 62011.

8. Upon reception of UE CONTEXT MODIFICATION RESPONSE message from the gNB-DU 6101, the gNB-CU-CP 62011 sends, to the AMF 70, the PDU SESSION RESOURCE MODIFY INDICATION message including PDU Session ID and DL UP Parameter. The DL UP Parameter indicates to the AMF 70 that a TEID and an IP address of the gNB-CU-UP 62022 to which the UPF 72 sends the DL packets to send. The PDU session ID may be identifier for the PDU session. The PDU session ID may be identifier for the PDU session established for the UE.

9. Upon reception of PDU SESSION RESOURCE MODIFY INDICATION message from the gNB-CU-CP 62011, the AMF 70 sends, to the SMF 71, Nsmf_PDUSession_UpdateSMContext request message including the TEID and the IP address of the gNB-CU-UP 62022. The TEID and the IP address of the gNB-CU-UP 62022 may be included in DL UP Parameter of the Nsmf_PDUSession_UpdateSMContext request message. The TEID and the IP address of the gNB-CU-UP 62022 included in the Nsmf_PDUSession_UpdateSMContext request message may be same to the TEID and the IP address of the gNB-CU-UP 62022 to which the UPF 72 sends the DL packets to send included in the PDU SESSION RESOURCE MODIFY INDICATION message.

10. Upon reception of Nsmf_PDUSession_UpdateSMContext request message from the AMF 70, the SMF 71 contacts to the UPF 72 for releasing N3 tunnel information in the UPF 72. The N4 Session Modification Request message sent from the SMF 71 to the UPF 72 includes the TEID and the IP address of the gNB-CU-UP 62022 for indicating the UPF 72 that a TEID and an IP address of the gNB-CU-UP 62022 to which the UPF 72 sends the DL packets to send. The N4 Session Modification Request message may be sent from the SMF 71 to the UPF 72 for releasing N3 tunnel information in the UPF 72. The N4 Session Modification Response message may be sent from the UPF 72 to the SMF 71 in response to the N4 Session Modification Request message.

11. The SMF 71 sends Nsmf_PDUSession_UpdateSMContext response message to the AMF 70.

12. Upon reception of the Nsmf_PDUSession_UpdateSMContext response message from the SMF 71, the AMF 70 sends PDU SESSION RESOURCE MODIFY CONFIRM message to the gNB-CU-CP 62011. Then the UE 3, the gNB-DU 6101, the gNB-CU-CP 62011, the AMF 70, the SMF 71 and the UPF 72 use the gNB-CU-UP 62022 for maintaining the established PDU session and keeping the service for the UE instead of the failed gNB-CU-UP 62021.

<gNB-CU-UP Failure Recovery by Releasing PDU Session>

A solution for recovering mechanism against the gNB-CU-UP failure by releasing the PDU session is disclosed.

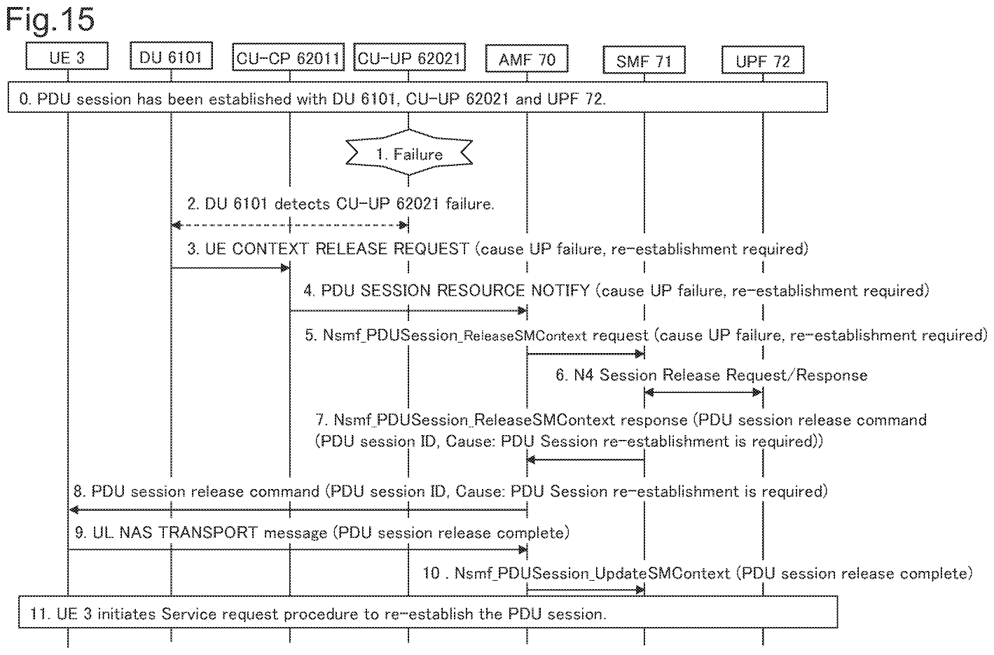

The FIG. 15 illustrates the handling of the gNB-CU-UP failure in NAS layer by releasing the PDU session.

The detailed processes of the procedure are described as below.

0. A UE 3 has at least one established PDU session and a DRB is established for the PDU session. The gNB-DU 6101, gNB-CU-UP 62021 and UPF 72 are used for user data handling for the PDU session.

1. The gNB-CU-UP 62021 fails. The failure in gNB-CU-UP 62021 includes unexpected system reset, system rebooting, system stall, recovering after rebooting, system congestion and communication failure with neighboring nodes.

2. The gNB-DU 6101 detects that the gNB-CU-UP 62021 has failed based on one or combination of the following monitoring at the gNB-DU 6101.
In case that the gNB-DU 6101 cannot receive the Echo response message as a reply to the Echo request message sent to the gNB-CU-UP 62021 for pre-defined period, the gNB-DU 6101 detects that the gNB-CU-UP 62021 has failed.

Note that the Path Management function, I.E. Echo request/Echo response messages, is defined in NPL 16.
In case that the gNB-DU 6101 receives the Error Indication message from the gNB-CU-UP 62021, the gNB-DU 6101 detects that the gNB-CU-UP 62021 has failed.

Note that the Tunnel Management function, I.E. Error Indication message, is defined in NPL 16.
In case that the gNB-CU-UP 62021 is not reachable in IP layer from the gNB-DU 6101, the gNB-DU 6101 detects that the gNB-CU-UP 62021 has failed.

3. Once the gNB-CU-UP 62021 failure is detected by the gNB-DU 6101, the gNB-DU 6101 sends UE CONTEXT RELEASE REQUEST message to the gNB-CU-CP 62011 as an associated gNB-CU-CP with the failed gNB-CU-UP 62021. The gNB-DU 6101 may store information indicating that the gNB-CU-CP 62011 is associated with the gNB-CU-UP 62021 and the gNB-DU 6101 may select the gNB-CU-CP 62011 as the associated gNB-CU-CP based on the information in a case where the gNB-CU-UP 62021 fails. Then the gNB-DU 6101 may send the UE CONTEXT RELEASE REQUEST message to the gNB-CU-CP 62011. The gNB-DU 6101 may obtain the information from other network nodes before the failure of the gNB-CU-UP 62021 occurs. The gNB-DU 6101 may obtain the information from the gNB-CU-CP 62011 or the gNB-CU-UP 62021 before the failure of the gNB-CU-UP 62021 occurs. The UE CONTEXT RELEASE REQUEST message includes cause parameter with a value of UP failure and re-establishment required parameter. The re-establishment required parameter indicates to the gNB-CU-CP 62011 that the DRB connection with the UE 3 needs to be re-established. The re-establishment required parameter indicates to the gNB-CU-CP 62011 that the DRB related to the UE 3 needs to be re-established. The re-establishment required parameter may indicate to the gNB-CU-CP 62011 that the PDU session with the UE 3 needs to be re-established. The cause parameter may have a value indicating that the gNB-CU-UP 62021 has failed. The UP failure may be interpreted as failure of the gNB-CU-UP 62021.

4. Upon reception of UE CONTEXT RELEASE REQUEST message from the gNB-DU 6101, the gNB-CU-CP 62011 sends, to the AMF 70, PDU SESSION RESOURCE NOTIFY message including cause parameter with a value of UP failure and re-establishment required parameter. The re-establishment required parameter indicates to the AMF 70 that the PDU session with the UE 3 needs to be re-established after the PDU session is released. The PDU SESSION RESOURCE NOTIFY message to the AMF 3 can be another existing NGAP message. The cause parameter may have a value indicating that the gNB-CU-UP 62021 has failed. The UP failure may be interpreted as failure of the gNB-CU-UP 62021.

5. Upon reception of PDU SESSION RESOURCE NOTIFY message from the gNB-CU-CP 62011, the AMF 70 sends, to the SMF 71, Nsmf_PDUSession_ReleaseSMContext request message including cause parameter with a value of UP failure and re-establishment required parameter. The re-establishment required parameter indicates to the SMF 71 that the PDU session with the UE needs to be re-established after the PDU session is released. The cause parameter may have a value indicating that the gNB-CU-UP 62021 has failed. The UP failure may be interpreted as failure of the gNB-CU-UP 62021.

6. Upon reception of Nsmf_PDUSession_ReleaseSMContext request message from the AMF 70, the SMF 71 contacts to the UPF 72 for releasing N3 tunnel information in the UPF 72. The N4 Session Release Request message may be sent from the SMF 71 to the UPF 72 for releasing N3 tunnel information in the UPF 72. The N4 Session Release Response message may be sent from the UPF 72 to the SMF 71 in response to the N4 Session Release Request message.

7. The SMF 71 sends, to the AMF 70, Nsmf_PDUSession_ReleaseSMContext response message including PDU session ID and cause parameter with a value of PDU Session re-establishment required. The cause parameter with a value of PDU Session re-establishment required may indicate to the AMF 70 that the PDU session with the UE 3 needs to be re-established. The PDU session ID may be identifier for the PDU session. The PDU session ID may be identifier for the PDU session established for the UE 3. The PDU session ID and the cause parameter may be included in PDU session release command message and the PDU session release command message may be included in the Nsmf_PDUSession_ReleaseSMContext response message.

8. Upon reception of the Nsmf_PDUSession_ReleaseSMContext response message from the SMF 71, the AMF 70 sends, to the UE 3, PDU session release command message including PDU session ID and cause parameter with a value of PDU Session re-establishment required. The cause parameter with a value of PDU Session re-establishment required may indicate to the UE 3 that the PDU session with the UE 3 needs to be re-established. The PDU session ID may be identifier for the PDU session. The PDU session ID may be identifier for the PDU session established for the UE 3. The PDU session ID in the step 8 may be same to the PDU session ID received in step 7.

9. The UE 3 sends, to the AMF 70, UL NAS TRANSPORT message including PDU session release complete message.

10. Upon reception of the UL NAS TRANSPORT message from the UE 3, the AMF 70 sends, to the SMF 71, Nsmf_PDUSession_UpdateSMContext message including PDU session release complete message.

11. Upon reception of PDU session release command message including cause parameter with a value of PDU Session re-establishment required, the UE 3 initiates the Service request procedure as defined in NPL 14 in order to re-establish the PDU session. The UE 3 may initiate the Service request procedure as defined in NPL 14 in order to re-establish the PDU session in a case where the UE 3 sends the UL NAS TRANSPORT message including PDU session release complete message.

At least one of the aspect 3 and the variant of the aspect 3 propose solutions for providing a resiliency of gNB-CU-User Plane against possible node failures. For example, at least one of the aspect 3 and the variant of the aspect 3 can solve a problem that all gNB-DUs enter out of service state in a case where the connected gNB-CU-UP fails and can solve a problem of a major service disruption to all users who are under the gNB-DU coverages if the connected gNB-CU fails. For example, according to at least one of the aspect 3 and the variant of the aspect 3, in a case where the gNB-CU-UP fails, the backup (or alternative) gNB-CU-UP takes over a role for communicating other network nodes (e.g. the gNB-DU, the AMF, the SMF and the UPF) instead of the failed gNB-CU-UP, hence, at least one of the aspect 3 and the variant of the aspect 3 can solve a problem that all gNB-DUs enter out of service state in a case where the connected gNB-CU-UP fails and can solve a problem of a major service disruption to all users who are under the gNB-DU coverages if the connected gNB-CU fails. For example, according to at least one of the aspect 3 and the variant of the aspect 3, by means that the RRC connection or the PDU session is re-established after the failure of the gNB-CU-UP, it can attempt to recover the service disruption.

### <System Overview>

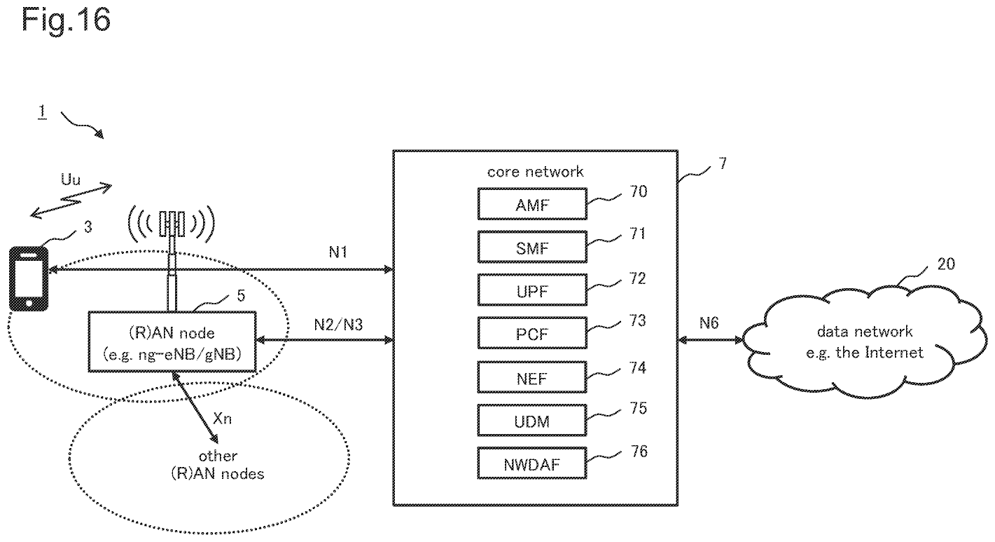

FIG. 16 schematically illustrates a telecommunication system 1 for a mobile (cellular or wireless) device (known as a user equipment (UE)) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into one or more control plane functions and one or more user plane functions. Further, multiple user plane functions can be allocated to support a communication. In some aspects, user traffic may be distributed to multiple user plane functions and user traffic over each user plane function is aggregated in both the UE 3 and the (R)AN node 5. This split architecture may be called ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA).

A Network Function (NF) can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN nodes 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane and User plane.

The User plane of the Uu interface is responsible to convey user traffic between the UE 3 and a serving (R)AN node 5. The User plane of the Uu interface may have a layered structure with SDAP, PDCP, RLC and MAC sublayer over the physical connection.

The Control plane of the Uu interface is responsible to establish, modify and release a connection between the UE 3 and a serving (R)AN node 5. The Control plane of the Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by some aspects in this disclosure, any of the following parameters may be included together in the RRC Setup Request message.
establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by some aspects in this disclosure, any of the following parameters may be included together in the RRC Setup message.
masterCellGroup and radioBearerConfig
RRC Setup Complete message: This message is sent from the UE 3 to the (R)AN node 5. In addition to the parameters that are disclosed by some aspects in this disclosure, any of the following parameters may be included together in the RRC Setup Complete message.
guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible for providing a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by some aspects in this disclosure, any of the following parameters may be included together in the Registration Request message.
5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by some aspects in this disclosure, any of the following parameters may be included together in the Registration Accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by some aspects in this disclosure, the following parameter may be included together in the Registration Complete message.
SOR transparent container.
Authentication Request message: This message is sent from the AMF 70 to the UE 3. In addition to the parameters that are disclosed by some aspects in this disclosure, any of the following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by some aspects in this disclosure, any of the following parameters may be populated together in the Authentication Response message.
Authentication response message identity, Authentication response parameter and EAP message.
Authentication Result message: This message is sent from the AMF 70 to the UE 3. In addition to the parameters that are disclosed by some aspects in this disclosure, any of the following parameters may be populated together in the Authentication Result message.
ngKSI, EAP message and ABBA.
Authentication Failure message: This message is sent from the UE 3 to the AMF 70. In addition to the parameters that are disclosed by some aspects in this disclosure, any of the following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by some aspects in this disclosure, the following parameter may be populated together in the Authentication Reject message.
EAP message.
Service Request message: This message is sent from the UE 3 to the AMF 70. In addition to the parameters that are disclosed by some aspects in this disclosure, any of the following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by some aspects in this disclosure, any of the following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by some aspects in this disclosure, any of the following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by some aspects in this disclosure, any of the following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by some aspects in this disclosure, the following parameter may be populated together in the Configuration Update Complete message.
Configuration update complete message identity.

All depicted network functions and/or (R)AN node 5 can interact with UDSF-SI, UDSF and NRF as necessary.

### <User Equipment (UE)>

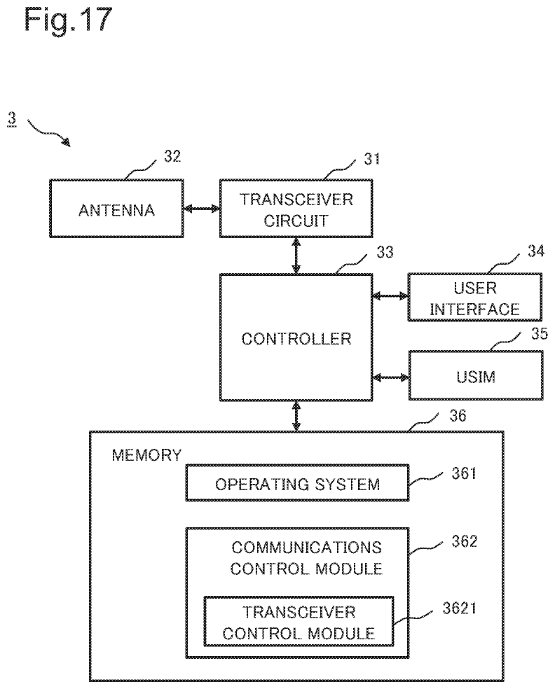

FIG. 17 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (e.g. a removable memory device (RMD)), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal generators; power nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

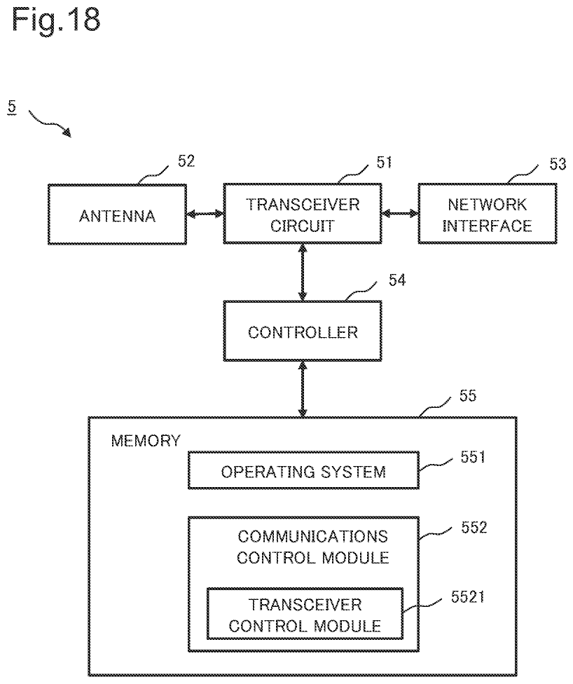

FIG. 18 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (e.g. an RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimation and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

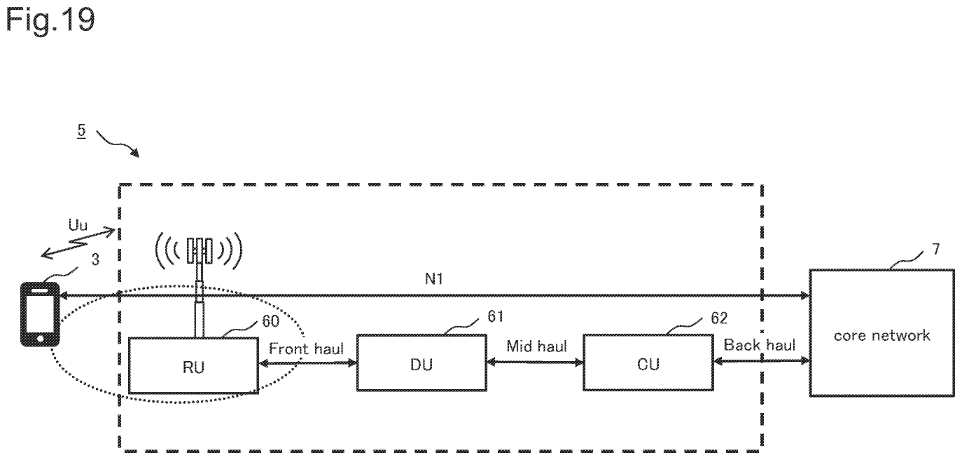

FIG. 19 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. The Centralized Unit may be called as Central Unit. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU-Control plane (CU-CP) and CU-User plane (CU-UP). The CU-CP has a control plane functionality in the (R)AN node 5. The CU-UP has a user plane functionality in the (R)AN node 5. Each CU-CP is connected to the CU-UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionality to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

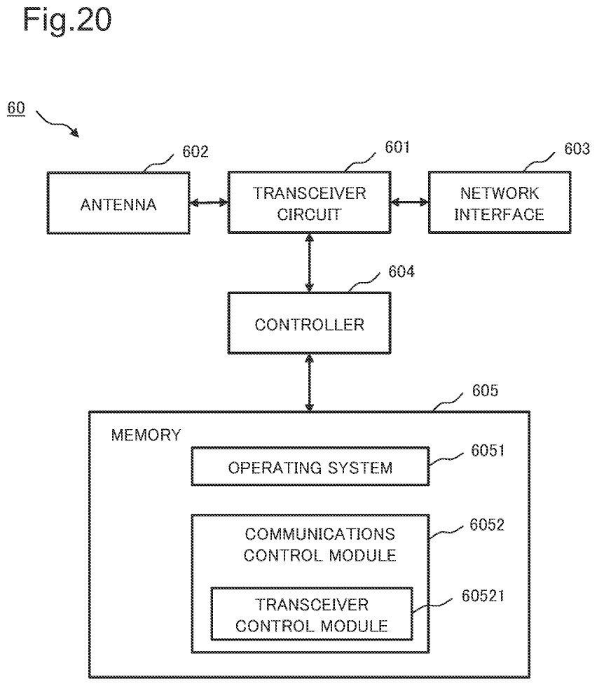

FIG. 20 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (e.g. a removable memory device (RMD)), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

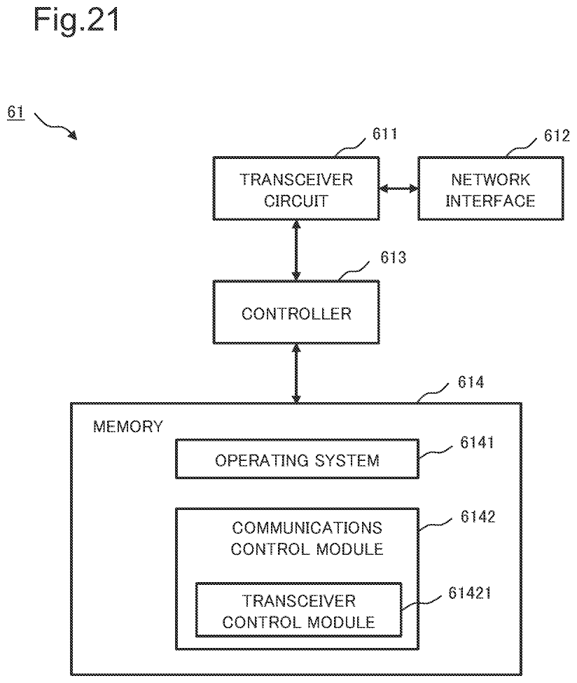

FIG. 21 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (e.g. a removable memory device (RMD)), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the DU 61 can be integrated/combined with the RU 60 or CU 62 as an integrated/combined unit. Any functionality in the description for DU 61 can be implemented in one of the integrated/combined unit above.

The gNB-DU may have same components to the DU 61.

### <Centralized Unit/Central Unit (CU)>

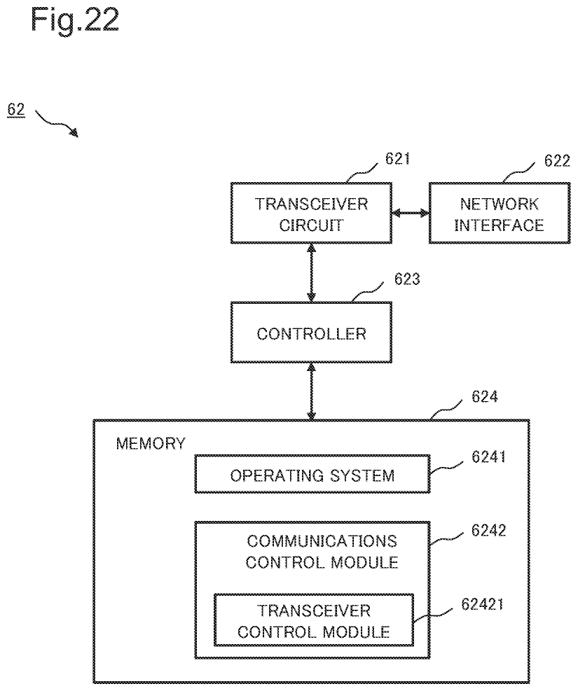

FIG. 22 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (e.g. a removable memory device (RMD)), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

The gNB-CU-CP may have same components to the CU 62.

The gNB-CU-UP may have same components to the CU 62.

### <AMF>

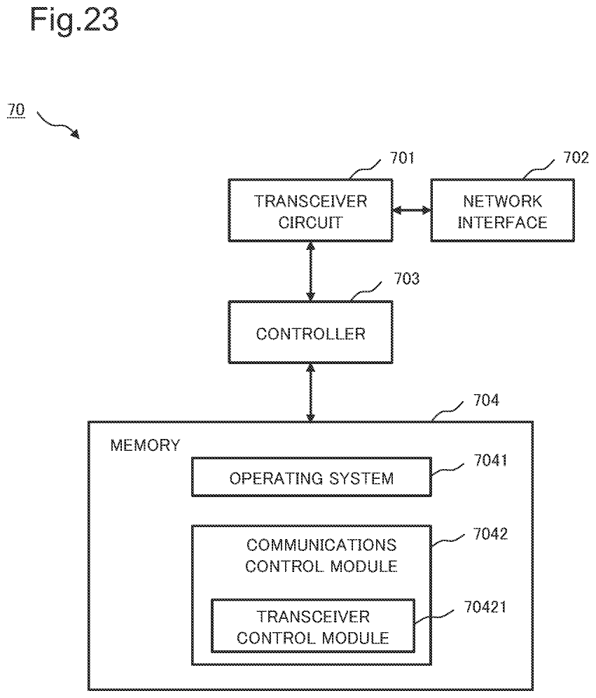

FIG. 23 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (e.g. a removable memory device (RMD)), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <SMF>

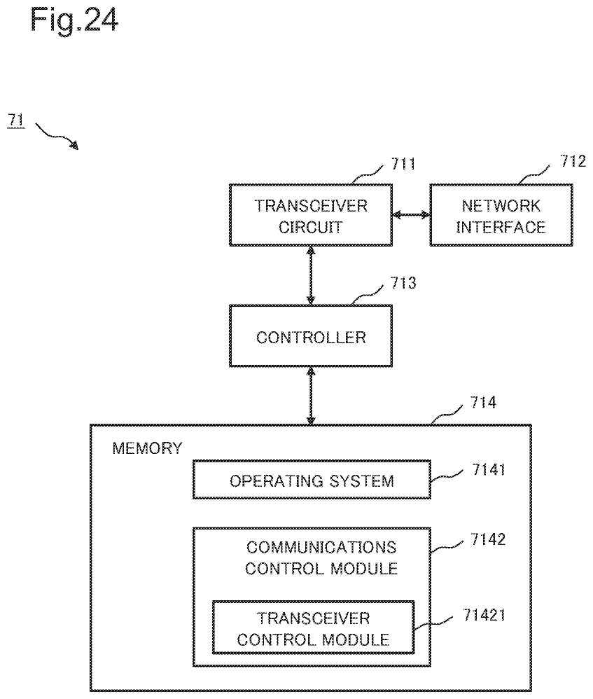

FIG. 24 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable memory device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### <UPF>

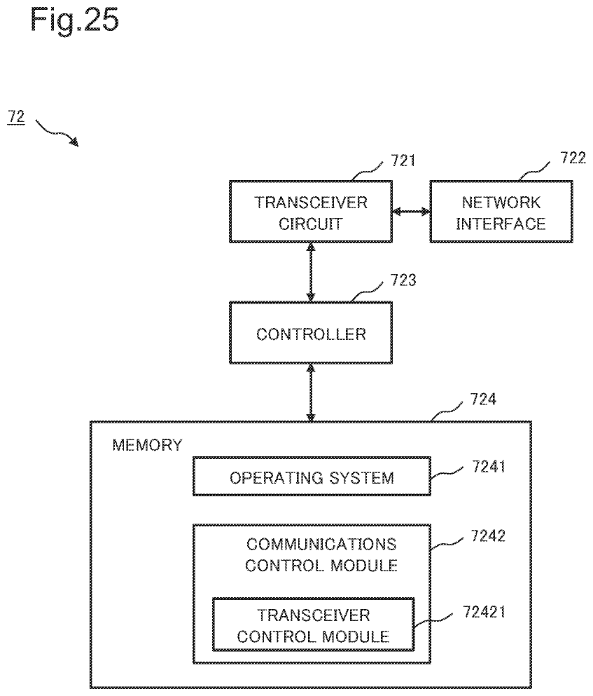

FIG. 25 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

### <PCF>

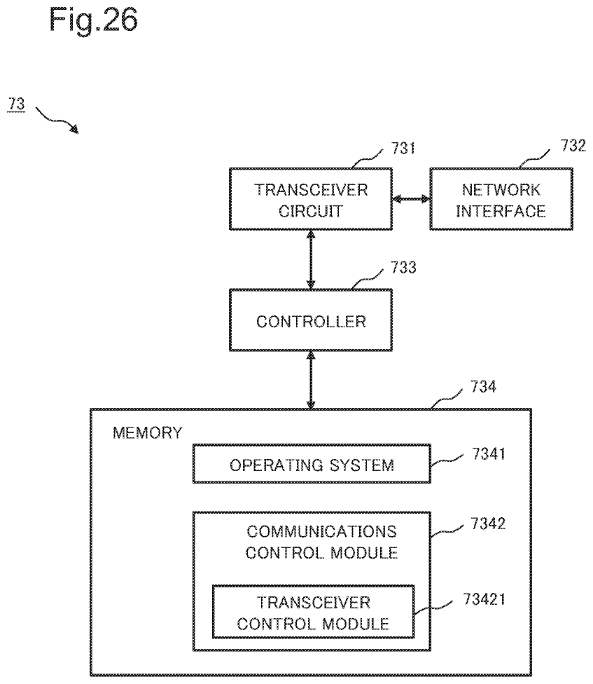

FIG. 26 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### <NEF>

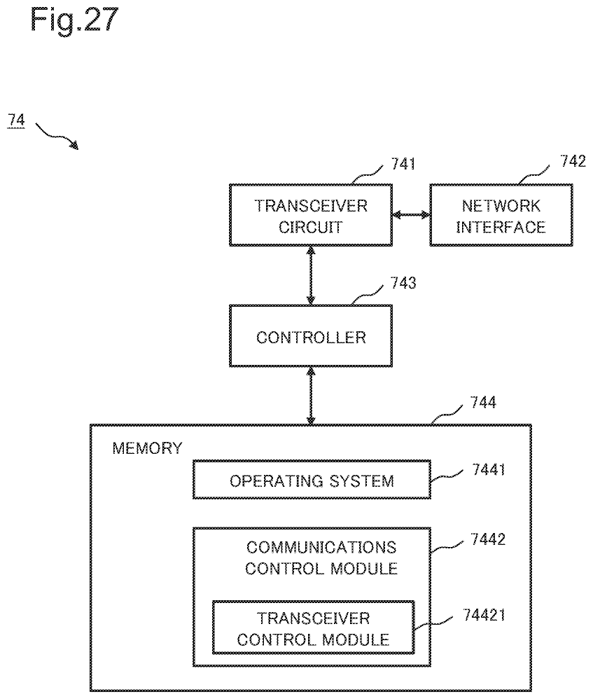

FIG. 27 is a block diagram illustrating the main components of the NEF 74. As shown, the apparatus includes a transceiver circuit 741 which is operable to transmit signals to and to receive signals from other nodes (including the UDM 75) via a network interface 742. A controller 743 controls the operation of the NEF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the NEF 74 and other nodes, such as the UDM 75 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The NEF 74 may support the Non-Public Network (NPN), The NPN may be a Stand-alone Non-Public Network (SNPN) or a Public Network Integrated NPN (PNI-NPN).

### <UDM>

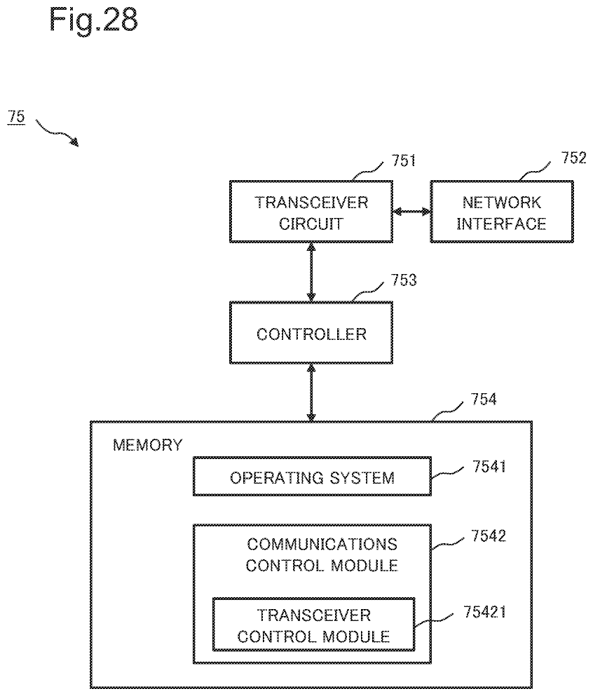

FIG. 28 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (e.g. a removable memory device (RMD)), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NWDAF>

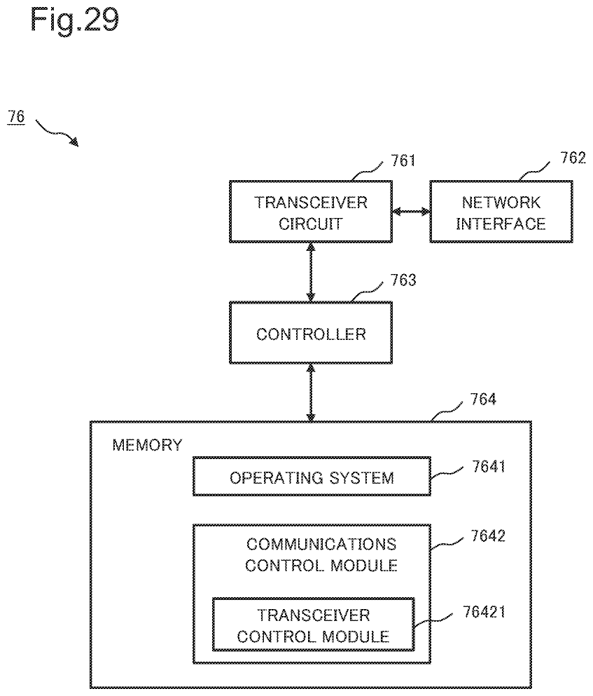

FIG. 29 is a block diagram illustrating the main components of the NWDAF 76. As shown, the apparatus includes a transceiver circuit 761 which is operable to transmit signals to and to receive signals from other nodes (including the AMF 70) via a network interface 762. A controller 763 controls the operation of the NWDAF 76 in accordance with the software stored in a memory 764. The Software may be pre-installed in the memory 764 and/or may be downloaded via the telecommunication network or from a removable data storage device (e.g. a removable memory device (RMD)), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NWDAF 76 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NWDAF 76 may support the Non-Public Network (NPN), The NPN may be a Stand-alone Non-Public Network (SNPN) or a Public Network Integrated NPN (PNI-NPN).

### <UDSF-SI>

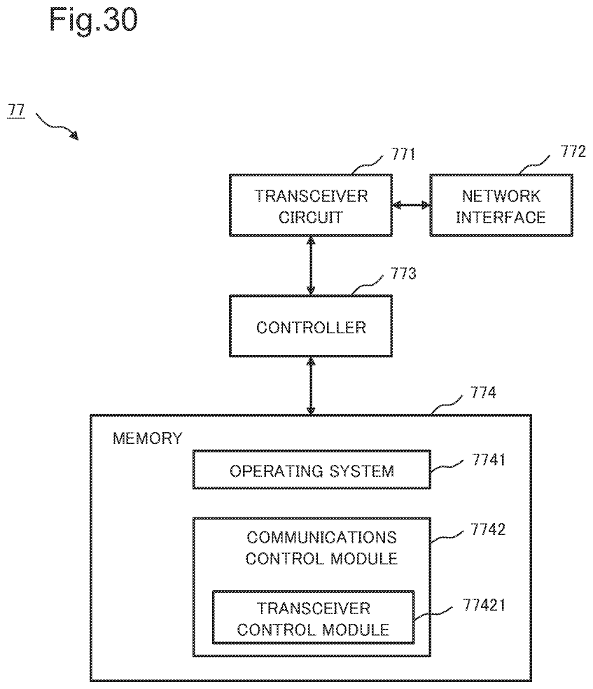

FIG. 30 is a block diagram illustrating the main components of the UDSF-SI 77. As shown, the apparatus includes a transceiver circuit 771 which is operable to transmit signals to and to receive signals from other nodes (including the gNB-CU-CP, the gNB-CU-UP and gNB-DU) via a network interface 772. A controller 773 controls the operation of the UDSF-SI 77 in accordance with software stored in a memory 774. Software may be pre-installed in the memory 774 and/or may be downloaded via the telecommunication network or from a removable data storage device (e.g. a removable memory device (RMD)), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the UDSF-SI 77 and other nodes, such as the gNB-CU-CP, the gNB-CU-UP and gNB-DU, and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The UDSF-SI 77 may support the Non-Public Network (NPN), The NPN may be a Stand-alone Non-Public Network (SNPN) or a Public Network Integrated NPN (PNI-NPN).

The UDSF may have same components to the UDSF-SI 77.

### <NRF>

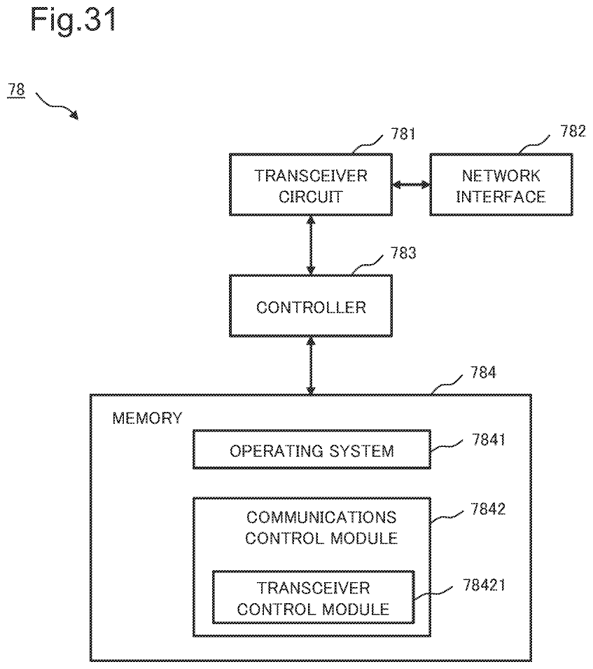

FIG. 31 is a block diagram illustrating the main components of the NRF 78. As shown, the apparatus includes a transceiver circuit 781 which is operable to transmit signals to and to receive signals from other nodes (including the gNB-CU-CP, the gNB-CU-UP and gNB-DU) via a network interface 782. A controller 783 controls the operation of the NRF 78 in accordance with software stored in a memory 784. Software may be pre-installed in the memory 784 and/or may be downloaded via the telecommunication network or from a removable data storage device (e.g. a removable memory device (RMD)), for example. The software includes, among other things, an operating system 7841 and a communications control module 7842 having at least a transceiver control module 78421. The communications control module 7842 (using its transceiver control module 78421 is responsible for handling (generating/sending/receiving) signalling between the NRF 78 and other nodes, such as the gNB-CU-CP, the gNB-CU-UP and gNB-DU, and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The NRF 78 may support the Non-Public Network (NPN), The NPN may be a Stand-alone Non-Public Network (SNPN) or a Public Network Integrated NPN (PNI-NPN).

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

The whole or part of the example Aspects disclosed above can be described as, but not limited to, the following supplementary notes.

supplementary note 1. A method of a gNB-Distributed Unit (gNB-DU) apparatus, the method comprising:
communicating with a User Equipment; and
communicating with a plurality of a gNB-Centralized Unit-Control Plane (gNB-CU-CP) apparatuses.

supplementary note 2. The method according to supplementary note 1, further comprising:
receiving system information from a first gNB-CU-CP apparatus of the plurality of gNB-CU-CP apparatuses; and
receiving the system information from a second gNB-CU-CP apparatus of the plurality of gNB-CU-CP apparatuses.

supplementary note 3. The method according to supplementary note 1, further comprising:
detecting failure of a first gNB-CU-CP apparatus of the plurality of gNB-CU-CP apparatuses; and
communicating with a second gNB-CU-CP apparatus of the plurality of gNB-CU-CP apparatuses in a case of detecting the failure of the first gNB-CU-CP apparatus.

supplementary note 4. A method of a gNB-Centralized Unit-User Plane (gNB-CU-UP) apparatus, the method comprising:
detecting failure of a first gNB-Centralized Unit-Control Plane (gNB-CU-CP) apparatus of a plurality of gNB-CU-CP apparatuses; and
communicating with a second gNB-CU-CP apparatus of the plurality of gNB-CU-CP apparatuses in a case of detecting the failure of the first gNB-CU-CP apparatus.

supplementary note 5. A method of an Access and Mobility management Function (AMF) apparatus, the method comprising:
detecting failure of a first gNB-Centralized Unit-Control Plane (gNB-CU-CP) apparatus of a plurality of gNB-CU-CP apparatuses; and
communicating with a second gNB-CU-CP apparatus of the plurality of gNB-CU-CP apparatuses in a case of detecting the failure of the first gNB-CU-CP apparatus.

supplementary note 6. A method of a first gNB-Centralized Unit-Control Plane (gNB-CU-CP) apparatus, the method comprising:
detecting failure of a second gNB-Centralized Unit-Control Plane (gNB-CU-CP) apparatus of a plurality of gNB-CU-CP apparatuses; and
communicating with a third gNB-CU-CP apparatus of the plurality of gNB-CU-CP apparatuses in a case of detecting the failure of the second gNB-CU-CP apparatus.

supplementary note 7. A gNB-Distributed Unit (gNB-DU) apparatus comprising:
means for communicating with a User Equipment; and
means for communicating with a plurality of a gNB-Centralized Unit-Control Plane (gNB-CU-CP) apparatuses.

supplementary note 8. The gNB-DU according to supplementary note 7, further comprising:
means for receiving system information from a first gNB-CU-CP apparatus of the plurality of gNB-CU-CP apparatuses; and
means for receiving the system information from a second gNB-CU-CP apparatus of the plurality of gNB-CU-CP apparatuses.

supplementary note 9. The gNB-DU according to supplementary note 7, further comprising:
means for detecting failure of a first gNB-CU-CP apparatus of the plurality of gNB-CU-CP apparatuses; and
means for communicating with a second gNB-CU-CP apparatus of the plurality of gNB-CU-CP apparatuses in a case of detecting the failure of the first gNB-CU-CP apparatus.

supplementary note 10. A gNB-Centralized Unit-User Plane (gNB-CU-UP) apparatus comprising:
means for detecting failure of a first gNB-Centralized Unit-Control Plane (gNB-CU-CP) apparatus of a plurality of gNB-CU-CP apparatuses; and
means for communicating with a second gNB-CU-CP apparatus of the plurality of gNB-CU-CP apparatuses in a case of detecting the failure of the first gNB-CU-CP apparatus.

supplementary note 11. An Access and Mobility management Function (AMF) apparatus comprising:
means for detecting failure of a first gNB-Centralized Unit-Control Plane (gNB-CU-CP) apparatus of a plurality of gNB-CU-CP apparatuses; and
means for communicating with a second gNB-CU-CP apparatus of the plurality of gNB-CU-CP apparatuses in a case of detecting the failure of the first gNB-CU-CP apparatus.

supplementary note 12. A first gNB-Centralized Unit-Control Plane (gNB-CU-CP) apparatus comprising:
means for detecting failure of a second gNB-Centralized Unit-Control Plane (gNB-CU-CP) apparatus of a plurality of gNB-CU-CP apparatuses; and
means for communicating with a third gNB-CU-CP apparatus of the plurality of gNB-CU-CP apparatuses in a case of detecting the failure of the second gNB-CU-CP apparatus.

supplementary note 13. A method of a gNB-Distributed Unit (gNB-DU) apparatus, the method comprising:
detecting failure of a gNB-Centralized Unit-User Plane (gNB-CU-UP) apparatus;
sending a UE COTEXT RELEASE REQUEST message to a gNB-Centralized Unit-Control Plane (gNB-CU-CP) apparatus in a case of detecting the failure of the gNB-CU-UP apparatus,
wherein the UE COTEXT RELEASE REQUEST message includes information indicating detection of the failure of the gNB-CU-UP apparatus and information indicating that Radio Resource control (RRC) connection with a User Equipment (UE) needs to be re-established;
receiving a UE CONTEXT RELEASE COMMAND message from the gNB-CU-CP apparatus; and
sending a RRC Release message to the UE.

supplementary note 14. A method of a gNB-Centralized Unit-Control Plane (gNB-CU-CP) apparatus, the method comprising:
receiving a UE COTEXT RELEASE REQUEST message from a gNB-Distributed Unit (gNB-DU) apparatus in a case where a gNB-Centralized Unit-User Plane (gNB-CU-UP) apparatus fails,
wherein the UE COTEXT RELEASE REQUEST message includes first information indicating detection of failure of the gNB-CU-UP apparatus and second information indicating that Radio Resource control (RRC) connection with a User Equipment (UE) needs to be re-established;
sending a UE CONTEXT RELEASE REQUEST message to an Access and Mobility management Function (AMF) apparatus,
wherein the UE CONTEXT RELEASE REQUEST message includes the first information and the second information;
receiving a first UE CONTEXT RELEASE COMMAND message from the AMF apparatus,
wherein the first UE CONTEXT RELEASE COMMAND message includes the first information and the second information; and
sending a second UE CONTEXT RELEASE COMMAND message to the gNB-DU apparatus,
wherein the second UE CONTEXT RELEASE COMMAND message includes the first information and the second information.

supplementary note 15. A method of an Access and Mobility management Function (AMF) apparatus, the method comprising:
receiving a UE CONTEXT RELEASE REQUEST message from a gNB-Centralized Unit-Control Plane (gNB-CU-CP) apparatus in a case where a gNB-Centralized Unit-User Plane (gNB-CU-UP) apparatus fails,
wherein the UE CONTEXT RELEASE REQUEST message includes first information indicating detection of failure of the gNB-CU-UP apparatus and second information indicating that Radio Resource control (RRC) connection with a User Equipment (UE) needs to be re-established; and
sending a UE CONTEXT RELEASE COMMAND message to the gNB-CU-CP apparatus,
wherein the UE CONTEXT RELEASE COMMAND message includes the first information and the second information.

supplementary note 16. A method of a User Equipment (UE), the method comprising:
receiving a RRC Release message from a gNB-Distributed Unit (gNB-DU) apparatus in a case where a gNB-Centralized Unit-User Plane (gNB-CU-UP) apparatus fails,
wherein the RRC Release message includes information indicating detection of failure of the gNB-CU-UP apparatus and information indicating that Radio Resource control (RRC) connection needs to be re-established; and
initiating a procedure to establish a Protocol Data Unit (PDU) session after receiving the RRC Release message.

supplementary note 17. A method of a gNB-Distributed Unit (gNB-DU) apparatus, the method comprising:
detecting failure of a first gNB-Centralized Unit-User Plane (gNB-CU-UP) apparatus;
sending a UE CONTEXT MODIFICATION REQUIRED message to a gNB-Centralized Unit-Control Plane (gNB-CU-CP) apparatus in a case of detecting the failure of the first gNB-CU-UP apparatus,
wherein the UE CONTEXT MODIFICATION REQUIRED message includes first information indicating detection of the failure of the first gNB-CU-UP apparatus and second information indicating Data Radio Bearer (DRB) ID and third information indicating that F1-U connection for the DRB ID needs to be re-established; and
receiving a UE CONTEXT MODIFICATION REQUEST message from the gNB-CU-CP apparatus,
wherein the UE CONTEXT MODIFICATION REQUEST message includes the second information and fourth information, and
wherein the fourth information indicates Tunnel Endpoint Identifier (TEID) and an Internet Protocol (IP) address of second gNB-CU-UP apparatus to which the gNB-DU sends an uplink packet.

supplementary note 18. A method of a gNB-Centralized Unit-Control Plane (gNB-CU-CP) apparatus, the method comprising:
receiving a UE CONTEXT MODIFICATION REQUIRED message from a gNB-Distributed Unit (gNB-DU) apparatus in a case where a first gNB-Centralized Unit-User Plane (gNB-CU-UP) apparatus fails,
wherein the UE CONTEXT MODIFICATION REQUIRED message includes first information indicating detection of failure of the first gNB-CU-UP apparatus and second information indicating Data Radio Bearer (DRB) ID and third information indicating that F1-U connection for the DRB ID needs to be re-established;
sending a BEARER CONTEXT SETUP REQUEST message to a second gNB-CU-UP apparatus,
wherein the BEARER CONTEXT SETUP REQUEST message includes gNB-DU ID and fourth information, and wherein the fourth information indicates Tunnel Endpoint Identifier (TEID) and Internet Protocol (IP) address of the gNB-DU apparatus to which the second gNB-CU-UP apparatus sends a downlink packet;
receiving a BEARER CONTEXT SETUP RESPONSE message from the second gNB-CU-UP apparatus,
wherein the BEARER CONTEXT SETUP RESPONSE message includes fifth information, and
wherein the fifth information indicates TEID and an IP address of the second gNB-CU-UP apparatus to which the gNB-DU apparatus sends an uplink packet; and
sending a UE CONTEXT MODIFICATION REQUEST message to the gNB-DU apparatus,
wherein the UE CONTEXT MODIFICATION REQUEST message includes the second information and the fifth information.

supplementary note 19. A method of a first gNB-Centralized Unit-User Plane (gNB-CU-UP) apparatus, the method comprising;
receiving a BEARER CONTEXT SETUP REQUEST message from a gNB-Centralized Unit-Control Plane (gNB-CU-CP) apparatus in a case where a second gNB-CU-UP apparatus fails,
wherein the BEARER CONTEXT SETUP REQUEST message includes gNB-DU ID and first information, and
wherein the first information indicates Tunnel Endpoint Identifier (TEID) and Internet Protocol (IP) address of a gNB-Distributed Unit (gNB-DU) apparatus to which the first gNB-CU-UP apparatus sends a downlink packet; and
sending a BEARER CONTEXT SETUP RESPONSE message to the gNB-CU-CP apparatus,
wherein the BEARER CONTEXT SETUP RESPONSE message includes second information, and
wherein the second information indicates TEID and an IP address of the first gNB-CU-UP apparatus to which the gNB-DU apparatus sends an uplink packet.

supplementary note 20. A method of an Access and Mobility management Function (AMF) apparatus, the method comprising:
receiving a PDU SESSION RESOURCE MODIFY INDICATION message from a gNB-Centralized Unit-Control Plane (gNB-CU-CP) apparatus in a case where a first gNB-Centralized Unit-User Plane (gNB-CU-UP) apparatus fails,
wherein the PDU SESSION RESOURCE MODIFY INDICATION message includes Protocol Data Unit (PDU) session ID and information, and
wherein the information indicates Tunnel Endpoint Identifier (TEID) and Internet Protocol (IP) address of a second gNB-CU-UP apparatus to which a User Plane Function (UPF) apparatus sends a downlink packet; and
sending a Nsmf_PDUSession_UpdateSMContext request message to Session Management Function (SMF) apparatus,
wherein the Nsmf_PDUSession_UpdateSMContext request message includes the information.

supplementary note 21. A method of a Session Management Function (SMF) apparatus, the method comprising:
receiving a Nsmf_PDUSession_UpdateSMContext request message from an Access and Mobility management Function (AMF) apparatus in a case where a first gNB-Centralized Unit-User Plane (gNB-CU-UP) apparatus fails,
wherein the Nsmf_PDUSession_UpdateSMContext request message includes information, and
wherein the information indicates Tunnel Endpoint Identifier (TEID) and Internet Protocol (IP) address of a second gNB-CU-UP apparatus to which a User Plane Function (UPF) apparatus sends a downlink packet; and
sending a N4 Session Modification Request message to the UPF apparatus,
wherein the N4 Session Modification Request message includes the information.

supplementary note 22. A method of a gNB-Distributed Unit (gNB-DU) apparatus, the method comprising:
detecting failure of a gNB-Centralized Unit-User Plane (gNB-CU-UP) apparatus; and
sending a UE COTEXT RELEASE REQUEST message to a gNB-Centralized Unit-Control Plane (gNB-CU-CP) apparatus in a case of detecting the failure of the gNB-CU-UP apparatus,
wherein the UE COTEXT RELEASE REQUEST message includes information indicating detection of the failure of the gNB-CU-UP apparatus and information indicating that Data Radio Bearer (DRB) connection with a User Equipment (UE) needs to be re-established.

supplementary note 23. A method of a gNB-Centralized Unit-Control Plane (gNB-CU-CP) apparatus, the method comprising:
receiving a UE COTEXT RELEASE REQUEST message from a gNB-Distributed Unit (gNB-DU) apparatus in a case where a gNB-Centralized Unit-User Plane (gNB-CU-UP) apparatus fails,
wherein the UE COTEXT RELEASE REQUEST message includes first information indicating detection of failure of the gNB-CU-UP apparatus and second information indicating that Data Radio Bearer (DRB) connection with a User Equipment (UE) needs to be re-established; and
sending a PDU SESSION RESOURCE NOTIFY message to an Access and Mobility management Function (AMF) apparatus,
wherein the PDU SESSION RESOURCE NOTIFY message includes the first information and third information, and
wherein the third information indicates that a Protocol Data Unit (PDU) session with the UE needs to be re-established.

supplementary note 24. A method of an Access and Mobility management Function (AMF) apparatus, the method comprising:
receiving a PDU SESSION RESOURCE NOTIFY message from a gNB-Centralized Unit-Control Plane (gNB-CU-CP) apparatus in a case where a gNB-Centralized Unit-User Plane (gNB-CU-UP) apparatus fails,
wherein the PDU SESSION RESOURCE NOTIFY message includes first information indicating detection of failure of the gNB-CU-UP apparatus and second information indicating that a Protocol Data Unit (PDU) session with a User Equipment (UE) needs to be re-established; and
sending a Nsmf_PDUSession_ReleaseSMContext request message to a Session Management Function (SMF) apparatus,
wherein the Nsmf_PDUSession_ReleaseSMContext request message includes the first information and the second information; receiving a Nsmf_PDUSession_ReleaseSMContext response message from the SMF apparatus,
wherein the Nsmf_PDUSession_ReleaseSMContext response message includes the second information and third information indicating PDU session ID; and
sending a PDU session release command message to the UE,
wherein the PDU session release command message includes the second information and the third information.

supplementary note 25. A method of a Session Management Function (SMF) apparatus, the method comprising:
receiving a Nsmf_PDUSession_ReleaseSMContext request message from an Access and Mobility management Function (AMF) apparatus in a case where a gNB-Centralized Unit-User Plane (gNB-CU-UP) apparatus fails,
wherein the Nsmf_PDUSession_ReleaseSMContext request message includes first information indicating detection of failure of the gNB-CU-UP apparatus and second information indicating that a Protocol Data Unit (PDU) session with a User Equipment (UE) needs to be re-established;
sending a N4 Session Release Request message to a User Plane Function (UPF) apparatus for releasing N3 tunnel information; and
sending a Nsmf_PDUSession_ReleaseSMContext response message to the AMF apparatus,
wherein the Nsmf_PDUSession_ReleaseSMContext response message includes the second information and a third information indicating PDU session ID.

supplementary note 26. A method of a User Equipment (UE), the method comprising:
receiving a PDU session release command message from an Access and Mobility management Function (AMF) apparatus in a case where a gNB-Centralized Unit-User Plane (gNB-CU-UP) apparatus fails,
wherein the PDU session release command message includes information indicating that a Protocol Data Unit (PDU) session with the UE needs to be re-established and information indicating PDU session ID; and
initiating a procedure to establish the PDU session after receiving the PDU session release command message.

supplementary note 27. A gNB-Distributed Unit (gNB-DU) apparatus comprising:
means for detecting failure of a gNB-Centralized Unit-User Plane (gNB-CU-UP) apparatus;
means for sending a UE COTEXT RELEASE REQUEST message to a gNB-Centralized Unit-Control Plane (gNB-CU-CP) apparatus in a case of detecting the failure of the gNB-CU-UP apparatus,
wherein the UE COTEXT RELEASE REQUEST message includes information indicating detection of the failure of the gNB-CU-UP apparatus and information indicating that Radio Resource control (RRC) connection with a User Equipment (UE) needs to be re-established;
means for receiving a UE CONTEXT RELEASE COMMAND message from the gNB-CU-CP apparatus; and
means for sending a RRC Release message to the UE.

supplementary note 28. A gNB-Centralized Unit-Control Plane (gNB-CU-CP) apparatus comprising:
means for receiving a UE COTEXT RELEASE REQUEST message from a gNB-Distributed Unit (gNB-DU) apparatus in a case where a gNB-Centralized Unit-User Plane (gNB-CU-UP) apparatus fails,
wherein the UE COTEXT RELEASE REQUEST message includes first information indicating detection of failure of the gNB-CU-UP apparatus and second information indicating that Radio Resource control (RRC) connection with a User Equipment (UE) needs to be re-established;
means for sending a UE CONTEXT RELEASE REQUEST message to an Access and Mobility management Function (AMF) apparatus,
wherein the UE CONTEXT RELEASE REQUEST message includes the first information and the second information;
means for receiving a first UE CONTEXT RELEASE COMMAND message from the AMF apparatus,
wherein the first UE CONTEXT RELEASE COMMAND message includes the first information and the second information; and
means for sending a second UE CONTEXT RELEASE COMMAND message to the gNB-DU apparatus,
wherein the second UE CONTEXT RELEASE COMMAND message includes the first information and the second information.

supplementary note 29. An Access and Mobility management Function (AMF) apparatus comprising:
means for receiving a UE CONTEXT RELEASE REQUEST message from a gNB-Centralized Unit-Control Plane (gNB-CU-CP) apparatus in a case where a gNB-Centralized Unit-User Plane (gNB-CU-UP) apparatus fails,
wherein the UE CONTEXT RELEASE REQUEST message includes first information indicating detection of failure of the gNB-CU-UP apparatus and second information indicating that Radio Resource control (RRC) connection with a User Equipment (UE) needs to be re-established; and
means for sending a UE CONTEXT RELEASE COMMAND message to the gNB-CU-CP apparatus,
wherein the UE CONTEXT RELEASE COMMAND message includes the first information and the second information.

supplementary note 30. A User Equipment (UE) comprising:
means for receiving a RRC Release message from a a gNB-Distributed Unit (gNB-DU) apparatus in a case where a gNB-Centralized Unit-User Plane (gNB-CU-UP) apparatus fails,
wherein the RRC Release message includes information indicating detection of failure of the gNB-CU-UP apparatus and information indicating that Radio Resource control (RRC) connection needs to be re-established; and
means for initiating a procedure to establish a Protocol Data Unit (PDU) session after receiving the RRC Release message.

supplementary note 31. A gNB-Distributed Unit (gNB-DU) apparatus comprising:
means for detecting failure of a first gNB-Centralized Unit-User Plane (gNB-CU-UP) apparatus;
means for sending a UE CONTEXT MODIFICATION REQUIRED message to a gNB-Centralized Unit-Control Plane (gNB-CU-CP) apparatus in a case of detecting the failure of the first gNB-CU-UP apparatus,
wherein the UE CONTEXT MODIFICATION REQUIRED message includes first information indicating detection of the failure of the first gNB-CU-UP apparatus and second information indicating Data Radio Bearer (DRB) ID and third information indicating that F1-U connection for the DRB ID needs to be re-established; and
means for receiving a UE CONTEXT MODIFICATION REQUEST message from the gNB-CU-CP apparatus,
wherein the UE CONTEXT MODIFICATION REQUEST message includes the second information and fourth information, and
wherein the fourth information indicates Tunnel Endpoint Identifier (TEID) and an Internet Protocol (IP) address of second gNB-CU-UP apparatus to which the gNB-DU sends an uplink packet.

supplementary note 32. A gNB-Centralized Unit-Control Plane (gNB-CU-CP) apparatus comprising:
means for receiving a UE CONTEXT MODIFICATION REQUIRED message from a gNB-Distributed Unit (gNB-DU) apparatus in a case where a first gNB-Centralized Unit-User Plane (gNB-CU-UP) apparatus fails,
wherein the UE CONTEXT MODIFICATION REQUIRED message includes first information indicating detection of failure of the first gNB-CU-UP apparatus and second information indicating Data Radio Bearer (DRB) ID and third information indicating that F1-U connection for the DRB ID needs to be re-established;
means for sending a BEARER CONTEXT SETUP REQUEST message to a second gNB-CU-UP apparatus,
wherein the BEARER CONTEXT SETUP REQUEST message includes gNB-DU ID and fourth information, and
wherein the fourth information indicates Tunnel Endpoint Identifier (TEID) and Internet Protocol (IP) address of the gNB-DU apparatus to which the second gNB-CU-UP apparatus sends a downlink packet;
means for receiving a BEARER CONTEXT SETUP RESPONSE message from the second gNB-CU-UP apparatus,
wherein the BEARER CONTEXT SETUP RESPONSE message includes fifth information, and
wherein the fifth information indicates TEID and an IP address of the second gNB-CU-UP apparatus to which the gNB-DU apparatus sends an uplink packet; and
means for sending a UE CONTEXT MODIFICATION REQUEST message to the gNB-DU apparatus,
wherein the UE CONTEXT MODIFICATION REQUEST message includes the second information and the fifth information.

supplementary note 33. A first gNB-Centralized Unit-User Plane (gNB-CU-UP) apparatus comprising;
means for receiving a BEARER CONTEXT SETUP REQUEST message from a gNB-Centralized Unit-Control Plane (gNB-CU-CP) apparatus in a case where a second gNB-CU-UP apparatus fails,
wherein the BEARER CONTEXT SETUP REQUEST message includes gNB-DU ID and first information, and
wherein the first information indicates Tunnel Endpoint Identifier (TEID) and Internet Protocol (IP) address of a gNB-Distributed Unit (gNB-DU) apparatus to which the first gNB-CU-UP apparatus sends a downlink packet; and
means for sending a BEARER CONTEXT SETUP RESPONSE message to the gNB-CU-CP apparatus,
wherein the BEARER CONTEXT SETUP RESPONSE message includes second information, and
wherein the second information indicates TEID and an IP address of the first gNB-CU-UP apparatus to which the gNB-DU apparatus sends an uplink packet.

supplementary note 34. An Access and Mobility management Function (AMF) apparatus comprising:
means for receiving a PDU SESSION RESOURCE MODIFY INDICATION message from a gNB-Centralized Unit-Control Plane (gNB-CU-CP) apparatus in a case where a first gNB-Centralized Unit-User Plane (gNB-CU-UP) apparatus fails,
wherein the PDU SESSION RESOURCE MODIFY INDICATION message includes Protocol Data Unit (PDU) session ID and information, and
wherein the information indicates Tunnel Endpoint Identifier (TEID) and Internet Protocol (IP) address of a second gNB-CU-UP apparatus to which a User Plane Function (UPF) apparatus sends a downlink packet; and
means for sending a Nsmf_PDUSession_UpdateSMContext request message to Session Management Function (SMF) apparatus,
wherein the Nsmf_PDUSession_UpdateSMContext request message includes the information.

supplementary note 35. A Session Management Function (SMF) apparatus comprising:
means for receiving a Nsmf_PDUSession_UpdateSMContext request message from an Access and Mobility management Function (AMF) apparatus in a case where a first gNB-Centralized Unit-User Plane (gNB-CU-UP) apparatus fails,
wherein the Nsmf_PDUSession_UpdateSMContext request message includes information, and
wherein the information indicates Tunnel Endpoint Identifier (TEID) and Internet Protocol (IP) address of a second gNB-CU-UP apparatus to which a User Plane Function (UPF) apparatus sends a downlink packet; and
means for sending a N4 Session Modification Request message to the UPF apparatus,
wherein the N4 Session Modification Request message includes the information.

supplementary note 36. A gNB-Distributed Unit (gNB-DU) apparatus comprising:
means for detecting failure of a gNB-Centralized Unit-User Plane (gNB-CU-UP) apparatus; and
means for sending a UE COTEXT RELEASE REQUEST message to a gNB-Centralized Unit-Control Plane (gNB-CU-CP) apparatus in a case of detecting the failure of the gNB-CU-UP apparatus,
wherein the UE COTEXT RELEASE REQUEST message includes information indicating detection of the failure of the gNB-CU-UP apparatus and information indicating that Data Radio Bearer (DRB) connection with a User Equipment (UE) needs to be re-established.

supplementary note 37. A gNB-Centralized Unit-Control Plane (gNB-CU-CP) apparatus comprising:
means for receiving a UE COTEXT RELEASE REQUEST message from a gNB-Distributed Unit (gNB-DU) apparatus in a case where a gNB-Centralized Unit-User Plane (gNB-CU-UP) apparatus fails,
wherein the UE COTEXT RELEASE REQUEST message includes first information indicating detection of failure of the gNB-CU-UP apparatus and second information indicating that Data Radio Bearer (DRB) connection with a User Equipment (UE) needs to be re-established; and
means for sending a PDU SESSION RESOURCE NOTIFY message to an Access and Mobility management Function (AMF) apparatus,
wherein the PDU SESSION RESOURCE NOTIFY message includes the first information and third information, and
wherein the third information indicates that a Protocol Data Unit (PDU) session with the UE needs to be re-established.

supplementary note 38. An Access and Mobility management Function (AMF) apparatus comprising:
means for receiving a PDU SESSION RESOURCE NOTIFY message from a gNB-Centralized Unit-Control Plane (gNB-CU-CP) apparatus in a case where a gNB-Centralized Unit-User Plane (gNB-CU-UP) apparatus fails,
wherein the PDU SESSION RESOURCE NOTIFY message includes first information indicating detection of failure of the gNB-CU-UP apparatus and second information indicating that a Protocol Data Unit (PDU) session with a User Equipment (UE) needs to be re-established; and
means for sending a Nsmf_PDUSession_ReleaseSMContext request message to a Session Management Function (SMF) apparatus,
wherein the Nsmf_PDUSession_ReleaseSMContext request message includes the first information and the second information;
means for receiving a Nsmf_PDUSession_ReleaseSMContext response message from the SMF apparatus,
wherein the Nsmf_PDUSession_ReleaseSMContext response message includes the second information and third information indicating PDU session ID; and
means for sending a PDU session release command message to the UE,
wherein the PDU session release command message includes the second information and the third information.

supplementary note 39. A Session Management Function (SMF) apparatus comprising:
means for receiving a Nsmf_PDUSession_ReleaseSMContext request message from an Access and Mobility management Function (AMF) apparatus in a case where a gNB-Centralized Unit-User Plane (gNB-CU-UP) apparatus fails,
wherein the Nsmf_PDUSession_ReleaseSMContext request message includes first information indicating detection of failure of the gNB-CU-UP apparatus and second information indicating that a Protocol Data Unit (PDU) session with a User Equipment (UE) needs to be re-established;
means for sending a N4 Session Release Request message to a User Plane Function (UPF) apparatus for releasing N3 tunnel information; and
means for sending a Nsmf_PDUSession_ReleaseSMContext response message to the AMF apparatus,
wherein the Nsmf_PDUSession_ReleaseSMContext response message includes the second information and a third information indicating PDU session ID.

supplementary note 40. A User Equipment (UE) comprising:
means for receiving a PDU session release command message from an Access and Mobility management Function (AMF) apparatus in a case where a gNB-Centralized Unit-User Plane (gNB-CU-UP) apparatus fails,
wherein the PDU session release command message includes information indicating that a Protocol Data Unit (PDU) session with the UE needs to be re-established and information indicating PDU session ID; and
means for initiating a procedure to establish the PDU session after receiving the PDU session release command message.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111039051, filed on Aug. 28, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
77 UDSF
78 NRF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
711 transceiver circuit
712 network interface
713 controller
714 memory
721 transceiver circuit
722 network interface
723 controller
724 memory
731 transceiver circuit
732 network interface
733 controller
734 memory
741 transceiver circuit
742 network interface
743 controller
744 memory
751 transceiver circuit
752 network interface
753 controller
754 memory
761 transceiver circuit
762 network interface
763 controller
764 memory
771 transceiver circuit
772 network interface
773 controller
774 memory
781 transceiver circuit
782 network interface
783 controller
784 memory
3621 transceiver control module
5521 transceiver control module
6051 operating system
6052 communications control module
6141 operating system
6142 communications control module
6241 operating system
6242 communications control module
7041 operating system
7042 communications control module
7141 operating system
7142 communications control module
7241 operating system
7242 communications control module
7341 operating system
7342 communications control module
7441 operating system
7442 communications control module
7541 operating system
7542 communications control module
7641 operating system
7642 communications control module
7741 operating system
7742 communications control module
7841 operating system
7842 communications control module
60521 transceiver control module
61421 transceiver control module
62421 transceiver control module
70421 transceiver control module
71421 transceiver control module
72421 transceiver control module
73421 transceiver control module
74421 transceiver control module
75421 transceiver control module
76421 transceiver control module
77421 transceiver control module
78421 transceiver control module

What is claimed is:

1. A method of a gNB Distributed Unit (gNB-DU) apparatus, the method comprising:
detecting failure of a gNB Centralized Unit User Plane (gNB-CU-UP) apparatus;
sending a UE CONTEXT RELEASE REQUEST message to a gNB Centralized Unit Control Plane (gNB-CU-CP) apparatus in a case of detecting the failure of the gNB-CU-UP apparatus,
wherein the UE CONTEXT RELEASE REQUEST message includes information indicating detection of the failure of the gNB-CU-UP apparatus and information indicating that Radio Resource control (RRC) connection with a User Equipment (UE) needs to be re-established;
receiving a UE CONTEXT RELEASE COMMAND message from the gNB-CU-CP apparatus; and
sending a RRC Release message to the UE.

2-3. (canceled)

4. A method of a User Equipment (UE), the method comprising:
receiving a RRC Release message from a gNB Distributed Unit (gNB-DU) apparatus in a case where a gNB Centralized Unit User Plane (gNB-CU-UP) apparatus fails,
wherein the RRC Release message includes information indicating detection of failure of the gNB-CU-UP apparatus and information indicating that Radio Resource control (RRC) connection needs to be re-established; and
initiating a procedure to establish a Protocol Data Unit (PDU) session after receiving the RRC Release message.

5-14. (canceled)

15. A gNB Distributed Unit (gNB-DU) apparatus comprising one or more memories storing instructions and one or more processors configured to execute the instructions to:
detect failure of a gNB Centralized Unit User Plane (gNB-CU-UP) apparatus;
send a UE CONTEXT T RELEASE REQUEST message to a gNB Centralized Unit Control Plane (gNB-CU-CP) apparatus in a case of detecting the failure of the gNB-CU-UP apparatus,
wherein the UE CONTEXT RELEASE REQUEST message includes information indicating detection of the failure of the gNB-CU-UP apparatus and information indicating that Radio Resource control (RRC) connection with a User Equipment (UE) needs to be re-established;
receive a UE CONTEXT RELEASE COMMAND message from the gNB-CU-CP apparatus; and
send a RRC Release message to the UE.

16-28. (canceled)
